(19) United States
(12) Patent Application Publication
(10) Pub. No.: US 2018/0149920 A1
(43) Pub. Date: May 31, 2018

(54) DISPLAY DEVICE, DISPLAY MODULE, AND ELECTRONIC DEVICE

(71) Applicant: Semiconductor Energy Laboratory Co., Ltd., Atsugi-shi (JP)

(72) Inventors: Shunpei YAMAZAKI, Tokyo (JP); Hideaki SHISHIDO, Atsugi (JP); Koji KUSUNOKI, Kawasaki (JP)

(21) Appl. No.: 15/825,417

(22) Filed: Nov. 29, 2017

(30) Foreign Application Priority Data
Nov. 30, 2016 (JP) 2016-233533

(51) Int. Cl. G02F 1/1335; G02F 1/1362; G02F 1/1343; G06F 3/041; G02F 1/1333

(52) U.S. Cl. CPC G02F 1/133602; G02F 1/136286; G06F 2203/04112; G06F 3/0412; G02F 1/13338; G02F 1/1343

(57) ABSTRACT

A liquid crystal display device with a high aperture ratio is provided. A liquid crystal display device with low power consumption is provided. A display device includes a liquid crystal element, a transistor, a scan line, and a signal line. The liquid crystal element includes a pixel electrode, a liquid crystal layer, and a common electrode. The scan line and the signal line are each electrically connected to the transistor. The scan line and the signal line each include a metal layer. The transistor includes a metal oxide layer, a gate, and a gate insulating layer. The metal oxide layer includes a first region and a second region. The first region overlaps with the gate with the gate insulating layer therebetween. The second region includes a first part connected to the pixel electrode. The resistivity of the second region is lower than that of the first region. The pixel electrode, the common electrode, and the first part are configured to transmit visible light. The visible light passes through the first part and the liquid crystal element and is emitted to the outside of the display device.

### TECHNICAL FIELD

One embodiment of the present invention relates to a liquid crystal display device, a display module, and an electronic device.

Note that one embodiment of the present invention is not limited to the above technical field. Examples of the technical field of one embodiment of the present invention include a semiconductor device, a display device, a light-emitting device, a power storage device, a memory device, an electronic device, a lighting device, an input device (such as a touch sensor), an input/output device (such as a touch panel), a method for driving any of them, and a method for manufacturing any of them.

### BACKGROUND ART

Transistors used for most flat panel displays typified by liquid crystal display devices and light-emitting display devices are formed using silicon semiconductors such as amorphous silicon, single crystal silicon, and polycrystalline silicon provided over glass substrates. Furthermore, transistors using such a silicon semiconductor are utilized for integrated circuits (ICs) and the like.

In recent years, techniques in which a metal oxide that exhibits semiconductor characteristics is used instead of a silicon semiconductor in a transistor have attracted attention. Note that in this specification, a metal oxide that exhibits semiconductor characteristics is referred to as an oxide semiconductor. For example, Patent Documents 1 and 2 disclose techniques for the fabrication of a transistor using zinc oxide or an In—Ga—Zn-based oxide as an oxide semiconductor and the use of the transistor as a switching element or the like in a pixel of a display device.

### REFERENCE

### Patent Document

### [Patent Document 1] Japanese Published Patent Application No. 2007-123861

### [Patent Document 2] Japanese Published Patent Application No. 2007-096055

### DISCLOSURE OF INVENTION

An object of one embodiment of the present invention is to provide a liquid crystal display device with a high aperture ratio. Another object of one embodiment of the present invention is to provide a liquid crystal display device with low power consumption. Another object of one embodiment of the present invention is to provide a high-definition liquid crystal display device. Another object of one embodiment of the present invention is to provide a highly reliable liquid crystal display device.

Note that the description of these objects does not exclude the existence of other objects. In one embodiment of the present invention, there is no need to achieve all the objects. Other objects can be derived from the description of the specification, the drawings, the claims, and the like.

One embodiment of the present invention is a display device including a liquid crystal element, a transistor, a scan line, and a signal line. The liquid crystal element includes a pixel electrode, a liquid crystal layer, and a common electrode. The scan line and the signal line are each electrically connected to the transistor. The scan line and the signal line each include a metal layer. The transistor includes a metal oxide layer, a gate, and a gate insulating layer. The metal oxide layer includes a first region and a second region. The first region overlaps with the gate with the gate insulating layer therebetween. The second region includes a first part connected to the pixel electrode. The resistivity of the second region is lower than that of the first region. The pixel electrode, the common electrode, and the first part are configured to transmit visible light. The visible light passes through the first part and the liquid crystal element and is emitted to the outside of the display device.

The display device with the above structure may further include a touch sensor. The touch sensor is positioned closer to a display surface than the liquid crystal element and the transistor are. The touch sensor includes a pair of electrodes. One or both of the pair of electrodes preferably include a second part that transmits visible light. The visible light that has passed through the first part and the liquid crystal element passes through the second part and is emitted to the outside of the display device.

The scan line preferably includes a part that overlaps with the first region.

The visible light may be emitted to the outside of the display device after passing through the first part and the liquid crystal element in order. Alternatively, the visible light may be emitted to the outside of the display device after passing through the liquid crystal element and the first part in order.

The liquid crystal element is preferably a liquid crystal element in a horizontal electric field mode.

The direction in which the scan line extends preferably intersects with the direction in which the signal line extends. A plurality of pixels that exhibit the same color are preferably aligned in a direction that intersects with the direction in which the signal line extends.

One embodiment of the present invention is a display module that includes the display device with any of the above structures, where a connector such as a flexible printed circuit (FPC) board or a tape carrier package (TCP) is connected or an IC is implemented with a method such as a chip on glass (COG) method or a chip on film (COF) method.

One embodiment of the present invention is an electronic device including the aforementioned display module and at least one of an antenna, a battery, a housing, a camera, a speaker, a microphone, and an operation button.

According to one embodiment of the present invention, a liquid crystal display device with a high aperture ratio can be provided. According to another embodiment of the present invention, a liquid crystal display device with low power consumption can be provided. According to another embodiment of the present invention, a high-definition liquid crystal display device can be provided. According to another embodiment of the present invention, a highly reliable liquid crystal display device can be provided.

Note that the description of these effects does not exclude the existence of other effects. In one embodiment of the present invention, there is no need to achieve all the effects. Other effects can be derived from the description of the specification, the drawings, the claims, and the like.

### BRIEF DESCRIPTION OF DRAWINGS

FIG. 1 is a perspective view illustrating an example of a display device.

FIG. 2 is a cross-sectional view illustrating an example of a display device.

FIG. 3 is a cross-sectional view illustrating an example of a display device.

FIGS. 4A and 4B are top views illustrating an example of a subpixel.

FIGS. 5A and 5B are top views illustrating an example of a subpixel.

FIGS. 6A and 6B are top views illustrating an example of a subpixel.

FIGS. 7A and 7B are top views illustrating an example of a subpixel.

FIGS. 8A and 8B are top views illustrating an example of a subpixel.

FIGS. 9A and 9B are top views illustrating an example of a subpixel.

FIG. 10 is a cross-sectional view illustrating an example of a display device.

FIG. 11 is a cross-sectional view illustrating an example of a display device.

FIGS. 12A to 12D are cross-sectional views illustrating examples of a display device.

FIGS. 13A and 13B illustrate arrangement and configuration examples of pixels.

FIGS. 14A and 14B are perspective views illustrating an example of a display device.

FIG. 15 is a cross-sectional view illustrating an example of a display device.

FIGS. 16A and 16B are perspective views illustrating an example of a display device.

FIG. 17 is a cross-sectional view illustrating an example of a display device.

FIG. 18 is a cross-sectional view illustrating an example of a display device.

FIG. 19 is a cross-sectional view illustrating an example of a display device.

FIGS. 20A to 20D are top views illustrating examples of an input device.

FIGS. 21A to 21E are top views illustrating examples of an input device.

FIG. 22 is a cross-sectional view illustrating an example of a display device.

FIGS. 23A and 23B illustrate an example of a sensor element and a pixel.

FIGS. 24A to 24E illustrate an operation example of sensor elements and pixels.

FIGS. 25A to 25C are top views illustrating an example of a sensor element and a pixel.

FIGS. 26A to 26C illustrate examples of an operation mode.

FIGS. 27A and 27B are a block diagram and a timing chart of a touch sensor.

FIGS. 28A and 28B are a block diagram and a timing chart of a display device.

FIGS. 29A to 29D illustrate operation of a display portion and a touch sensor.

FIGS. 30A to 30D illustrate operation of a display portion and a touch sensor.

FIGS. 31A to 31C illustrate examples of electronic devices.

FIGS. 32A to 32C illustrate examples of electronic devices.

FIG. 33 shows the I_{d}-V_{g} characteristics of transistors in Example 1.

FIG. 34 is a photograph showing a display result of a display device in Example 1.

FIGS. 35A and 35B are optical micrographs of pixels in the display device in Example 1.

FIG. 36 is a graph showing the relationship between the pixel density and the aperture ratio increased as the result of application of one embodiment of the present invention.

### BEST MODE FOR CARRYING OUT THE INVENTION

Embodiments will be described in detail with reference to the drawings. Note that the present invention is not limited to the description below, and it is easily understood by those skilled in the art that modes and details can be modified in various ways without departing from the spirit and scope of the present invention. Therefore, the present invention should not be construed as being limited to the description in the following embodiments.

Note that in the structures of the invention described below, the same portions or portions having similar functions are denoted by the same reference numerals in different drawings, and the description of such portions is not repeated. Furthermore, the same hatching pattern is applied to portions having similar functions, and the portions are not especially denoted by reference numerals in some cases.

The position, size, range, or the like of each structure illustrated in drawings is not accurately represented in some cases for easy understanding. Therefore, the disclosed invention is not necessarily limited to the position, size, range, or the like disclosed in the drawings.

Note that the terms “film” and “layer” can be interchanged with each other depending on the case or circumstances. For example, the term “conductive layer” can be changed into the term “conductive film.” Also, the term “insulating film” can be changed into the term “insulating layer.”

In this specification and the like, a metal oxide means an oxide of metal in a broad sense. Metal oxides are classified into an oxide insulator, an oxide conductor (including a transparent oxide conductor), an oxide semiconductor (also simply referred to as an OS), and the like. For example, a metal oxide used in a semiconductor layer of a transistor is called an oxide semiconductor in some cases. In other words, an OS FET is a transistor including a metal oxide or an oxide semiconductor.

In this specification and the like, a metal oxide including nitrogen is also called a metal oxide in some cases. Moreover, a metal oxide including nitrogen may be called a metal oxynitride.

### Embodiment 1

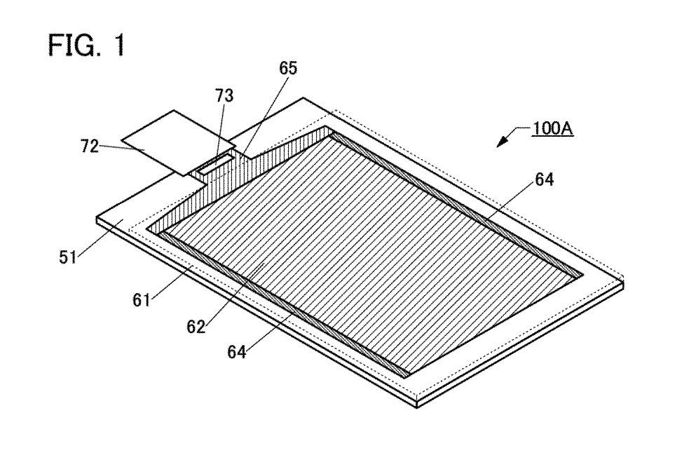

In this embodiment, a display device of one embodiment of the present invention will be described with reference to FIG. 1 to FIG. 25C.

### 1. Structure Example 1 of Display Device

First, a display device in this embodiment will be described with reference to FIG. 1 to FIG. 7B.

The display device in this embodiment includes a liquid crystal element and a transistor. The liquid crystal element includes a pixel electrode, a liquid crystal layer, and a common electrode. The transistor includes a metal oxide layer, a gate, and a gate insulating layer. The metal oxide layer includes a first region and a second region. The first region overlaps with the gate with the gate insulating layer therebetween. The second region includes a first part connected to the pixel electrode. The resistivity of the second region is lower than that of the first region. The pixel electrode, the common electrode, and the first part are configured to transmit visible light. The visible light passes through the first part and the liquid crystal element and is emitted to the outside of the display device.

The display device in this embodiment includes a contact area where the metal oxide layer of the transistor is connected to the pixel electrode. The contact area transmits visible light, and thus can be provided in a display region. This can increase the aperture ratio of a pixel. A higher aperture ratio results in a higher light extraction efficiency. An increase in light extraction efficiency allows reducing of the luminance of a backlight unit. As a result, the power consumption of a display device can be reduced. In addition, a high-definition display device can be achieved.

The display device in this embodiment further includes a scan line and a signal line. Each of the scan line and the signal line is electrically connected to the transistor. The scan line and the signal line each include a metal layer. When the metal layer is used as the scan line and the signal line, the resistances of the scan line and the signal line can be reduced.

The scan line preferably has a part that overlaps with a channel region of the transistor. The characteristics of the transistor might vary due to light irradiation when the channel region of the transistor contains some kinds of materials. The scan line that has a part overlapping with the channel region of the transistor can prevent external light, light from a backlight, or the like from being emitted to the channel region. This results in an improvement in the reliability of the transistor. A conductive film may have the two functions of a scan line and a gate (or a back gate).

In one embodiment of the present invention, the following light-transmitting semiconductor materials and conductive materials can be used for transistors, wirings, capacitors, and the like.

A semiconductor film in the transistor can be formed with a light-transmitting semiconductor material. Examples of the light-transmitting semiconductor material include a metal oxide and an oxide semiconductor. An oxide semiconductor preferably contains at least indium. In particular, indium and zinc are preferably contained. In addition, one or more elements selected from aluminum, gallium, yttrium, tin, copper, vanadium, beryllium, boron, silicon, titanium, iron, nickel, germanium, zirconium, molybdenum, lanthanum, cerium, neodymium, hafnium, tantalum, tungsten, magnesium, and the like may be contained.

A conductive film in the transistor can be formed with a light-transmitting conductive material. The light-transmitting conductive material preferably contains one or more kinds of indium, zinc, and tin. Specifically, an In oxide, an In—Sn oxide (also referred to as an indium tin oxide or ITO), an In—Zn oxide, an In—W oxide, an In—W—Zn oxide, an In—Ti oxide, an In—Sn—Ti oxide, an In—Sn—Si oxide, a Zn oxide, a Ga—Zn oxide, or the like can be used.

The conductive film of the transistor may be an oxide semiconductor that includes an impurity element and has reduced resistance. The oxide semiconductor with the reduced resistance can be regarded as an oxide conductor (OC).

For example, to form an oxide conductor, oxygen vacancies are formed in an oxide semiconductor and then hydrogen is added to the oxygen vacancies, so that a donor level is formed in the vicinity of the conduction band. The oxide semiconductor having the donor level has an increased conductivity and becomes a conductor.

An oxide semiconductor has a large energy gap (e.g., an energy gap of 2.5 eV or larger), and thus has a visible light transmitting property. As mentioned above, the oxide conductor is an oxide semiconductor having a donor level in the vicinity of the conduction band. Hence, the influence of absorption due to the donor level is small in the oxide conductor, and the oxide conductor has a visible light transmitting property almost equivalent to that of the oxide semiconductor.

The oxide conductor preferably includes one or more kinds of metal elements included in the semiconductor film of the transistor. When two or more layers included in the transistor are formed using the oxide semiconductors including the same metal element, the same manufacturing apparatus (e.g., deposition apparatus or processing apparatus) can be used in two or more steps and manufacturing cost can thus be reduced.

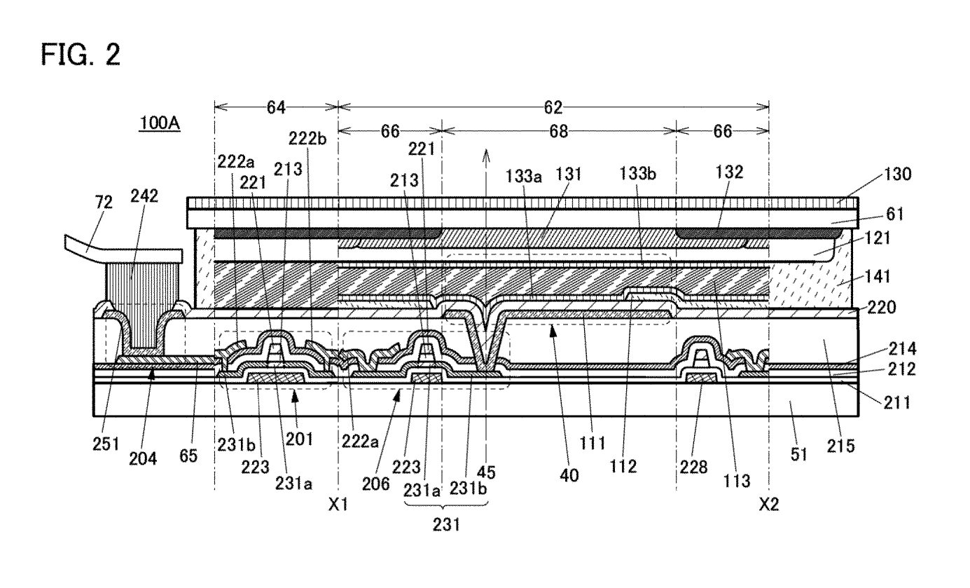

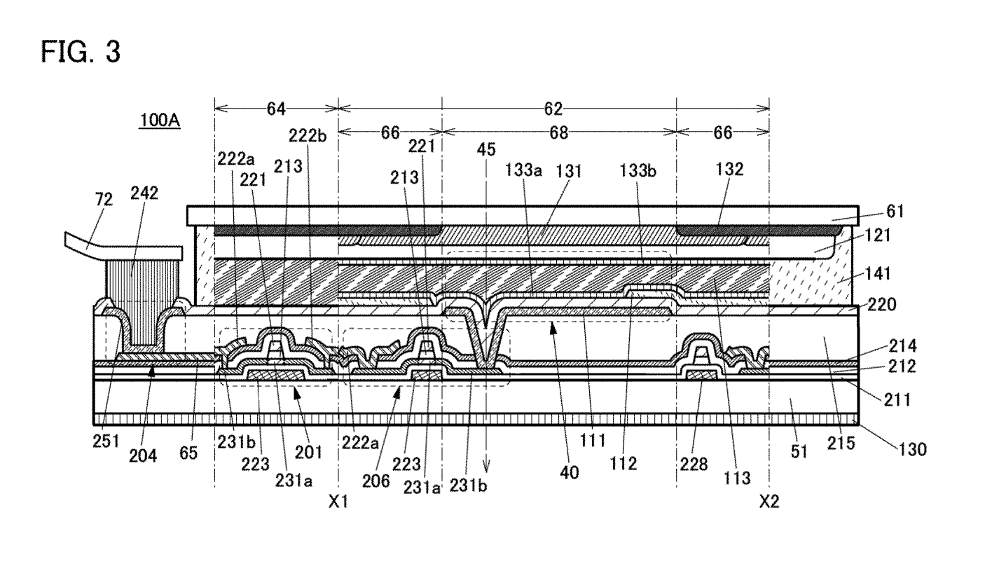

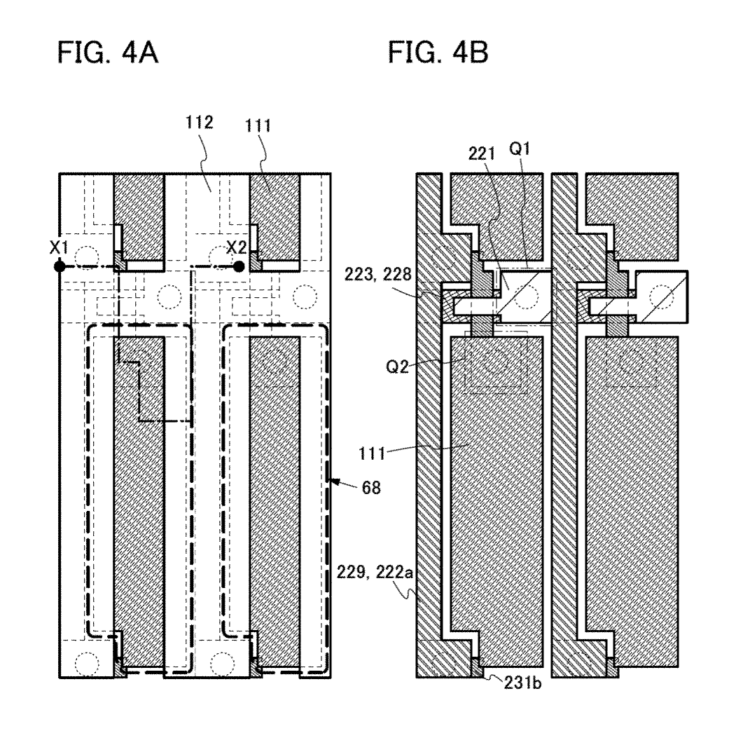

FIG. 1 is a perspective view of a display device 100A. In FIG. 1, some components such as a polarizer 130 are not shown for clarity. A substrate 61 is denoted with a dotted line in FIG. 1. FIG. 2 and FIG. 3 are cross-sectional views of the display device 100A. FIGS. 4A and 4B are top views of subpixels included in the display device 100A.

The display device 100A includes a display portion 62 and a driver circuit portion 64. An FPC 72 and an IC 73 are mounted on the display device 100A.

The display portion 62 includes a plurality of pixels and has a function of displaying images.

A pixel includes a plurality of subpixels. For example, a subpixel exhibiting a red color, a subpixel exhibiting a green color, and a subpixel exhibiting a blue color form one pixel, and thus full-color display can be achieved in the display portion 62. Note that the color exhibited by subpixels is not limited to red, green, and blue. For example, a subpixel exhibiting white, yellow, magenta, cyan, or the like may be used for a pixel. Note that in this specification and the like, a subpixel is simply referred to as a pixel in some cases.

The display device 100A may include one or both of a scan line driver circuit and a signal line driver circuit. The display device 100A may include none of the scan line driver circuit and the signal line driver circuit. When the display device 100A includes a sensor such as a touch sensor, the display device 100A may include a sensor driver circuit. In this embodiment, the driver circuit portion 64 is exemplified as including the scan line driver circuit. The scan line driver circuit has a function of outputting scan signals to the scan lines included in the display portion 62.

In the display device 100A, the IC 73 is mounted on a substrate 51 by a COG method or the like. The IC 73 includes, for example, any one or more of a signal line driver circuit, a scan line driver circuit, and a sensor driver circuit.

The FPC 72 is electrically connected to the display device 100A. The IC 73 and the driver circuit portion 64 are supplied with signals or power from the outside through the FPC 72. Furthermore, signals can be output to the outside from the IC 73 through the FPC 72.

An IC may be mounted on the FPC 72. For example, an IC including any one or more of a signal line driver circuit, a scan line driver circuit, and a sensor driver circuit may be mounted on the FPC 72.

A wiring 65 supplies signals and power to the display portion 62 and the driver circuit portion 64. The signals and power are input to the wiring 65 from the outside through the FPC 72, or from the IC 73.

FIG. 2 and FIG. 3 are cross-sectional views each including the display portion 62, the driver circuit portion 64, and the wiring 65. FIG. 2 and FIG. 3 each include a cross-sectional view along dashed-dotted line X1-X2 in FIG. 4A. In FIG. 2 and the subsequent cross-sectional views of the display device, the display portion 62 includes a display region 68 in a subpixel and a non-display region 66 around the display region 68.

FIG. 4A is a top view seen from a common electrode 112 side and illustrates a layered structure from a gate 223 to the common electrode 112 in the subpixel (see FIG. 2 and FIG. 3). In FIG. 4A, the display region 68 in the subpixel is outlined in a bold dotted line. FIG. 4B illustrates a top view of the layered structure of FIG. 4A except for the common electrode 112.

FIG. 2 shows an example in which the polarizer 130 is positioned on the substrate 61 side and a backlight unit (not illustrated) is positioned on the substrate 51 side. Light 45 from the backlight unit enters the substrate 51 first, passes through a contact area between a transistor 206 and a pixel electrode 111, a liquid crystal element 40, a coloring layer 131, the substrate 61, and the polarizer 130 in order, and then is taken out of the display device 100A.

FIG. 3 shows an example in which the polarizer 130 is positioned on the substrate 51 side and a backlight unit (not illustrated) is positioned on the substrate 61 side. The light 45 from the backlight unit enters the substrate 61 first, passes through the coloring layer 131, the liquid crystal element 40, the contact area between the transistor 206 and the pixel electrode 111, the substrate 51, and the polarizer 130 in order, and then is taken out of the display device 100A.

As shown above, the display surface of the display device in this embodiment can be set on the substrate 51 side or the substrate 61 side without changing the structure between the substrate 51 and the substrate 61. The side provided with the display surface can be determined as appropriate depending on the arrangement of the backlight unit, the polarizer, the touch sensor, and the like.

The following description is made with reference to FIG. 2; the same applies to FIG. 3.

The display device 100A is an example of a transmissive liquid crystal display device that includes a liquid crystal element in a horizontal electric field mode.

As illustrated in FIG. 2, the display device 100A includes the substrate 51, a transistor 201, the transistor 206, the liquid crystal element 40, an alignment film 133a, an alignment film 133b, a connection portion 204, an adhesive layer 141, the coloring layer 131, a light-blocking layer 132, an overcoat 121, the substrate 61, the polarizer 130, and the like.

The transistor 206 is provided in the non-display region 66.

The transistor 206 includes a gate 221, a gate 223, an insulating layer 211, an insulating layer 213, and a semiconductor layer 231 (a channel region 231a and a pair of low-resistance regions 231b).

The gate 221 and the channel region 231a overlap with the insulating layer 213 positioned therebetween. The gate 223 and the channel region 231a overlap with the insulating layer 211 positioned therebetween. The insulating layers 211 and 213 serve as gate insulating layers. Through openings provided in the insulating layers 212 and 214, the conductive layer 222a is connected to one of the low-resistance regions 231b.

The resistivity of the low-resistance region 231b is lower than that of the channel region 231a. That is, the conductivity of the low-resistance region 231b is higher than that of the channel region 231a. The low-resistance region can also be referred to as an oxide conductor (OC). The low-resistance region 231b has a higher carrier concentration or a higher impurity concentration than the channel region 231a.

In this embodiment, the case in which an oxide semiconductor layer is used as the semiconductor layer is described as an example. The oxide semiconductor layer preferably includes indium and is further preferably an oxide film including In, M (M is Al, Ti, Ga, Y, Zr, La, Ce, Nd, Sn, or Hf), and Zn.

The low-resistance region 231b is obtained by imparting n-type conductivity to the semiconductor layer 231. The low-resistance region 231b is a region of the semiconductor layer 231 that is in contact with the insulating layer 212. Here, the insulating layer 212 preferably contains nitrogen or hydrogen, in which case nitrogen or hydrogen in the insulating layer 212 enters the low-resistance region 231bto increase the carrier concentration of the low-resistance region 231b. Alternatively, the low-resistance region 231b may be formed by the addition of an impurity with the gate 221 used as a mask. Examples of the impurity include hydrogen, helium, neon, argon, fluorine, nitrogen, phosphorus, arsenic, antimony, boron, and aluminum. The impurity can be added by an ion implantation method or an ion doping method. Other than the above impurities, for example, indium, which is a constituent element of the semiconductor layer 231, may be added to form the low-resistance region 231b. The concentration of indium in the low-resistance region 231b is higher than that in the channel formation region in some cases by adding indium.

After the addition of the impurity, heat treatment may be performed (typically at higher than or equal to 100° C. and lower than or equal to 400° C., preferably at higher than or equal to 150° C. and lower than or equal to 350° C.).

The addition of the impurity can be applied to a formation method of another oxide conductor (OC) as well as the formation method of the low-resistance region 231b.

The transistor 206 illustrated in FIG. 2 is a transistor including gates above and below the channel.

In a contact area Q1 illustrated in FIG. 4B, the gates 221 and 223 are electrically connected. A transistor with two gates that are electrically connected to each other can have a higher field-effect mobility and thus have higher on-state current than other transistors. Consequently, a circuit capable of high-speed operation can be obtained. Furthermore, the area occupied by a circuit portion can be reduced. The use of the transistor having a high on-state current can reduce signal delay in wirings and can reduce display unevenness even in a display device in which the number of wirings is increased because of an increase in size or resolution. In addition, the use of such a configuration allows the fabrication of a highly reliable transistor.

In a contact area Q2 illustrated in FIG. 4B, the low-resistance region 231b in the semiconductor layer is connected to the pixel electrode 111. The low-resistance region 231b is formed with a visible light transmitting material. Hence, the contact area Q2 can be provided in the display region 68; as a result, the aperture ratio of a subpixel can be increased. In addition, the power consumption of the display device can be reduced.

In other words, in FIGS. 4A and 4B, one conductive layer serves as a scan line 228 and the gate 223. One of the gates 221 and 223 that has the lower resistance of the two is preferably the conductive layer that also serves as the scan line. The conductive layer that serves as the scan line 228 preferably has a sufficiently low resistance. Thus, the conductive layer that serves as the scan line 228 is preferably formed with a metal, an alloy, or the like. Alternatively, a material that has a function of blocking visible light may be used for the conductive layer serving as the scan line 228.

In other words, in FIGS. 4A and 4B, one conductive layer serves as a signal line 229 and the conductive layer 222a. The conductive layer that serves as the signal line 229 preferably has a sufficiently low resistance. Thus, the conductive layer that serves as the signal line 229 is preferably formed with a metal, an alloy, or the like. Alternatively, a material that has a function of blocking visible light may be used for the conductive layer serving as the signal line 229.

Specifically, some conductive materials that transmit visible light have higher resistivity than some conductive materials (e.g., copper and aluminum) that block visible light; hence, in order to prevent signal delay, a bus line such as a scan line or a signal line is preferably formed with a conductive material (a metal material) that has a low resistivity and blocks visible light. Note that a conductive material that transmits visible light can be used for the bus line depending on the size of a pixel, the width of the bus line, the thickness of the bus line, and the like.

The gates 221 and 223 can each include a single layer of one of a metal material and an oxide conductor, or stacked layers of both a metal material and an oxide conductor. For example, an oxide conductor may be used for one of the gates 221 and 223, and a metal material may be used for the other of the gates 221 and 223.

The transistor 206 can be formed to include the oxide semiconductor layer as a semiconductor layer, and include the oxide conductive layer as at least one of the gates 221 and 223. In this case, the oxide semiconductor layer and the oxide conductive layer are preferably formed using an oxide semiconductor.

When the conductive layer that blocks visible light is used for the gate 223, light from the backlight can be prevented from being emitted to the channel region 231a. The overlapping of the channel region 231a and the conductive layer that blocks visible light can reduce variations in the characteristics of the transistor due to light. This results in an improvement in the reliability of the transistor.

The light-blocking layer 132 is provided on the side of the channel region 231a that is closer to the substrate 61, and the gate 223 that blocks visible light is provided on the side of the channel region 231a that is closer to the substrate 51. Accordingly, the channel region 231a can be prevented from being irradiated with external light and light from the backlight.

In one embodiment of the present invention, the conductive layer that blocks visible light may overlap with part of the semiconductor layer and may not overlap with another part of the semiconductor layer. For example, the conductive layer that blocks visible light may overlap with at least the channel region 231a. Specifically, as illustrated in FIG. 2 and the like, the low-resistance region 231b adjacent to the channel region 231a includes a region that does not overlap with the gate 223. Note that the low-resistance region 231b may be rephrased as the aforementioned oxide conductor (OC). Since the oxide conductor (OC) transmits visible light as described above, light can be extracted through the low-resistance region 231b.

In the case where silicon, typically amorphous silicon, low-temperature polysilicon, or the like is used for the semiconductor layer of the transistor, the aforementioned low-resistance region corresponds to a region that includes silicon containing an impurity such as phosphorus or boron. Note that the band gap of silicon is approximately 1.1 eV. Thus, in the case where silicon is used for the semiconductor layer of the transistor, the semiconductor layer absorbs part of visible light, which makes it difficult to extract light through the semiconductor layer. The light-transmitting property might be further reduced when silicon contains an impurity such as phosphorus or boron. Hence, it is sometimes more difficult to extract light through the low-resistance region formed in silicon. In contrast, in one embodiment of the present invention, both the oxide semiconductor (OS) and the oxide conductor (OC) have visible light transmitting properties, leading to an increase in the aperture ratio of a pixel or a subpixel.

As illustrated in FIG. 2, the transistor 206 is covered by the insulating layers 212 and 214 and an insulating layer 215. Note that the insulating layers 212 and 214 can be considered as the component of the transistor 206. The transistor is preferably covered by an insulating layer that reduces the diffusion of an impurity to the semiconductor constituting the transistor. The insulating layer 215 can serve as a planarization layer.

Each of the insulating layers 211 and 213 preferably includes an excess oxygen region. When the gate insulating layer includes the excess oxygen region, excess oxygen can be supplied into the channel region 231a. A highly reliable transistor can be provided since oxygen vacancies that are potentially formed in the channel region 231a can be filled with excess oxygen.

The insulating layer 212 preferably includes nitrogen or hydrogen. When the insulating layer 212 and the low-resistance region 231b are in contact with each other, nitrogen or hydrogen in the insulating layer 212 is added into the low-resistance region 231b. The carrier density of the low-resistance region 231b becomes high when nitrogen or hydrogen is added. Alternatively, when the insulating layer 214 includes nitrogen or hydrogen and the insulating layer 212 transmits the nitrogen or hydrogen, the nitrogen or hydrogen can be added into the low-resistance region 231b.

The liquid crystal element 40 is provided in the display region 68. The liquid crystal element 40 is a liquid crystal element using a fringe field switching (FFS) mode.

The liquid crystal element 40 includes the pixel electrode 111, the common electrode 112, and a liquid crystal layer 113. The alignment of the liquid crystal layer 113 can be controlled with the electrical field generated between the pixel electrode 111 and the common electrode 112. The liquid crystal layer 113 is positioned between the alignment films 133a and 133b.

The common electrode 112 may have a top-surface shape (also referred to as a planar shape) that has a comb-like shape or a top-surface shape that is provided with a slit. FIG. 2, FIG. 3, and FIG. 4A illustrate an example in which one opening is provided in the common electrode 112 in the display region 68 of one subpixel. One opening or a plurality of openings can be provided in the common electrode 112. As the display device has higher definition, the area of the display region 68 in one subpixel becomes smaller. Thus, the number of openings provided in the common electrode 112 is not limited to more than one; one opening can be provided. That is, in a high-definition display device, the area of the pixel (the subpixel) is small; therefore, an adequate electric field for the alignment of liquid crystals over the entire display region of the subpixel can be generated, even when there is only one opening in the common electrode 112.

An insulating layer 220 is provided between the pixel electrode 111 and the common electrode 112. The pixel electrode 111 includes a portion that overlaps with the common electrode 112 with the insulating layer 220 provided therebetween. Furthermore, the common electrode 112 is not placed over the pixel electrode 111 in some areas of a region where the pixel electrode 111 and the coloring layer 131 overlap.

An alignment film is preferably provided in contact with the liquid crystal layer 113. The alignment film can control the alignment of the liquid crystal layer 113. In the display device 100A, the alignment film 133a is positioned between the common electrode 112 (or the insulating layer 220) and the liquid crystal layer 113, and the alignment film 133b is positioned between the overcoat 121 and the liquid crystal layer 113.

The liquid crystal material is classified into a positive liquid crystal material with a positive dielectric anisotropy (Δε) and a negative liquid crystal material with a negative dielectric anisotropy. Both of the materials can be used in one embodiment of the present invention, and an optimal liquid crystal material can be selected according to the employed mode and design.

In one embodiment of the present invention, a negative liquid crystal material is preferably used. The negative liquid crystal is less affected by a flexoelectric effect, and thus the polarity of voltage applied to the liquid crystal layer makes little difference in transmittance. This prevents flickering from being recognized by the user of the display device. The flexoelectric effect is a phenomenon in which polarization is induced by the distortion of orientation, and mainly depends on the shape of a molecule. The negative liquid crystal material is less likely to experience the deformation such as spreading and bending.

Note that the liquid crystal element 40 is an element in an FFS mode here; however, one embodiment of the present invention is not limited thereto, and a liquid crystal element using any of a variety of modes can be used. For example, a liquid crystal element using a vertical alignment (VA) mode, a twisted nematic (TN) mode, an in-plane switching (IPS) mode, an axially symmetric aligned micro-cell (ASM) mode, an optically compensated birefringence (OCB) mode, a ferroelectric liquid crystal (FLC) mode, an antiferroelectric liquid crystal (AFLC) mode, an electrically controlled birefringence (ECB) mode, a VA-IPS mode, a guest-host mode, or the like can be used.

Furthermore, the display device 100A may be a normally black liquid crystal display device, for example, a transmissive liquid crystal display device using a vertical alignment (VA) mode. Examples of the vertical alignment mode include a multi-domain vertical alignment (MVA) mode, a patterned vertical alignment (PVA) mode, and an advanced super view (ASV) mode.

Note that the liquid crystal element is an element that controls transmission and non-transmission of light by optical modulation action of the liquid crystal. The optical modulation action of the liquid crystal is controlled by an electric field applied to the liquid crystal (including a horizontal electric field, a vertical electric field, or an oblique electric field). As the liquid crystal used for the liquid crystal element, a thermotropic liquid crystal, a low-molecular liquid crystal, a high-molecular liquid crystal, a polymer dispersed liquid crystal (PDLC), a ferroelectric liquid crystal, an anti-ferroelectric liquid crystal, or the like can be used. Such a liquid crystal material exhibits a cholesteric phase, a smectic phase, a cubic phase, a chiral nematic phase, an isotropic phase, or the like depending on conditions.

Alternatively, in the case of employing a horizontal electric field mode, a liquid crystal exhibiting a blue phase for which an alignment film is unnecessary may be used. A blue phase is one of liquid crystal phases, which is generated just before a cholesteric phase changes into an isotropic phase while temperature of cholesteric liquid crystal is increased. Since the blue phase appears only in a narrow temperature range, a liquid crystal composition in which 5 wt. % or more of a chiral material is mixed is preferably used for the liquid crystal layer 113 in order to improve the temperature range. The liquid crystal composition which includes a liquid crystal exhibiting a blue phase and a chiral material has a short response time and exhibits optical isotropy, which makes the alignment process unnecessary. In addition, the liquid crystal composition which includes liquid crystal exhibiting a blue phase and a chiral material has a small viewing angle dependence. Furthermore, since an alignment film does not need to be provided and rubbing treatment is unnecessary, electrostatic discharge damage caused by the rubbing treatment can be prevented and defects or damage of the liquid crystal display device in the manufacturing process can be reduced.

As the display device 100A is a transmissive liquid crystal display device, a conductive material that transmits visible light is used for both the pixel electrode 111 and the common electrode 112. A conductive material that transmits visible light is used for one or more of the conductive layers included in the transistor 206. Accordingly, at least part of the transistor 206 can be provided in the display region 68. FIG. 2 shows the case where a semiconductor material that transmits visible light is used for the semiconductor layer 231.

For example, a material containing one or more of indium (In), zinc (Zn), and tin (Sn) is preferably used as the conductive material that transmits visible light. Specifically, indium oxide, indium tin oxide (ITO), indium zinc oxide, indium oxide containing tungsten oxide, indium zinc oxide containing tungsten oxide, indium oxide containing titanium oxide, indium tin oxide containing titanium oxide, indium tin oxide containing silicon oxide (ITSO), zinc oxide, and zinc oxide containing gallium are given, for example. Note that a film including graphene can be used as well. The film including graphene can be formed, for example, by reducing a film including graphene oxide. As a reducing method, a method with application of heat or the like can be employed.

An oxide conductive layer is preferably used for one or both of the pixel electrode 111 and the common electrode 112. The oxide conductive layer preferably includes one or more metal elements that are included in the semiconductor layer 231 of the transistor 206. For example, each of the pixel electrode 111 and the common electrode 112 preferably includes indium and is further preferably an oxide film including In, M, (M is Al, Ti, Ga, Y, Zr, La, Ce, Nd, Sn, or Hf) and Zn.

An oxide semiconductor may be used for one or both of the pixel electrode 111 and the common electrode 112. When two or more layers constituting the display device are formed using oxide semiconductors containing the same metal element, the same manufacturing equipment (e.g., film-formation equipment or processing equipment) can be used in two or more steps; manufacturing cost can thus be reduced.

An oxide semiconductor is a semiconductor material whose resistance can be controlled by oxygen vacancies in the film of the semiconductor material and/or the concentration of impurities such as hydrogen or water in the film of the semiconductor material. Thus, the resistivity of the oxide conductive layer can be controlled by selecting treatment for increasing oxygen vacancies and/or impurity concentration on the oxide semiconductor layer, or treatment for reducing oxygen vacancies and/or impurity concentration on the oxide semiconductor layer.

Note that such an oxide conductive layer formed using an oxide semiconductor layer can be referred to as an oxide semiconductor layer having a high carrier density and a low resistance, an oxide semiconductor layer having conductivity, or an oxide semiconductor layer having high conductivity.

In addition, the manufacturing cost can be reduced by forming the oxide semiconductor layer and the oxide conductive layer using the same metal element. For example, the manufacturing cost can be reduced by using a metal oxide target with the same metal composition. By using the metal oxide target with the same metal composition, an etching gas or an etchant used in the processing of the oxide semiconductor layer can also be used for processing of the oxide conductive layer. Note that even when the oxide semiconductor layer and the oxide conductive layer have the same metal elements, they have different compositions in some cases. For example, a metal element in the film is released during the manufacturing process of the display device, which results in a different metal composition.

For example, when a silicon nitride film containing hydrogen is used for the insulating layer 220 and an oxide semiconductor is used for the pixel electrode 111, the conductivity of the oxide semiconductor can be increased by the hydrogen that is supplied from the insulating layer 220.

In the display device 100A, the coloring layer 131 and the light-blocking layer 132 are provided closer to the substrate 61 than the liquid crystal layer 113 is. The coloring layer 131 is positioned in a region that overlaps with at least the display region 68 of a subpixel. In the non-display region 66 of a pixel (subpixel), the light-blocking layer 132 is provided. The light-blocking layer 132 overlaps with at least a part of the transistor 206.

The overcoat 121 is preferably provided between the coloring layer 131 or the light-blocking layer 132, and the liquid crystal layer 113. The overcoat 121 can reduce the diffusion of an impurity contained in the coloring layer 131 the light-blocking layer 132 and the like into the liquid crystal layer 113.

The substrates 51 and 61 are bonded to each other by the adhesive layer 141. The liquid crystal layer 113 is encapsulated in a region that is surrounded by the substrates 51 and 61, and the adhesive layer 141.

When the display device 100A functions as a transmissive liquid crystal display device, two polarizers are positioned in a way that the display portion 62 is sandwiched between the two polarizers. FIG. 2 illustrates the polarizer 130 on the substrate 61 side. The light 45 from a backlight provided on the outside of the polarizer on the substrate 51 side enters the display device 100A through the polarizer. In this case, the optical modulation of the light can be controlled by controlling the alignment of the liquid crystal layer 113 with a voltage supplied between the pixel electrode 111 and the common electrode 112. That is, the intensity of light ejected through the polarizer 130 can be controlled. Furthermore, the coloring layer 131 absorbs light of wavelengths other than a specific wavelength range from the incident light. As a result, the ejected light is light that exhibits red, blue, or green colors, for example.

In addition to the polarizer, a circular polarizer can be used, for example. An example of a circular polarizer is a stack including a linear polarizer and a quarter-wave retardation plate. The circular polarizer can reduce the viewing angle dependence of the display quality of the display device.

The driver circuit portion 64 includes the transistor 201.

The transistor 201 includes the gate 221, the gate 223, the insulating layer 211, the insulating layer 213, the semiconductor layer 231 (the channel region 231a and a pair of low-resistance regions 231b), the conductive layer 222a, and the conductive layer 222b. One of the conductive layers 222a and 222b serves as a source, and the other serves as a drain. The conductive layer 222a is electrically connected to one of the low-resistance regions 231b and the conductive layer 222b is electrically connected to the other of the low-resistance regions 231b.

The transistor in the driver circuit portion 64 does not need to transmit visible light. Hence, the conductive layers 222a and 222b can be formed in the same process using the same material (preferably, a material with a low resistivity such as a metal).

In the connection portion 204, the wiring 65 and a conductive layer 251 are connected to each other, and the conductive layer 251 and a connector 242 are connected to each other. That is, in the connection portion 204, the wiring 65 is electrically connected to the FPC 72 through the conductive layer 251 and the connector 242. By employing this configuration, signals and power can be supplied from the FPC 72 to the wiring 65.

The wiring 65 can be formed with the same material and the same process as those used in the conductive layers 222a and 222b of the transistor 201, and the conductive layer 222a of the transistor 206. The conductive layer 251 can be formed with the same material and the same process as those used in the pixel electrode 111 of the liquid crystal element 40. Fabricating the conductive layers constituting the connection portion 204 in such a manner, i.e., using the same materials and the same processes as those used in the conductive layers composing the display portion 62 and the driver circuit portion 64, is preferable because the number of process steps is not increased.

The transistors 201 and 206 may or may not have the same structure. That is, the transistors included in the driver circuit portion 64 and the transistors included in the display portion 62 may or may not have the same structure. In addition, the driver circuit portion 64 may have a plurality of transistors with different structures, and the display portion 62 may have a plurality of transistors with different structures. For example, a transistor including two gates that are electrically connected to each other is preferably used for one or more of a shift register circuit, a buffer circuit, and a protection circuit included in a scan line driver circuit.

### [Structure Example of Subpixel]

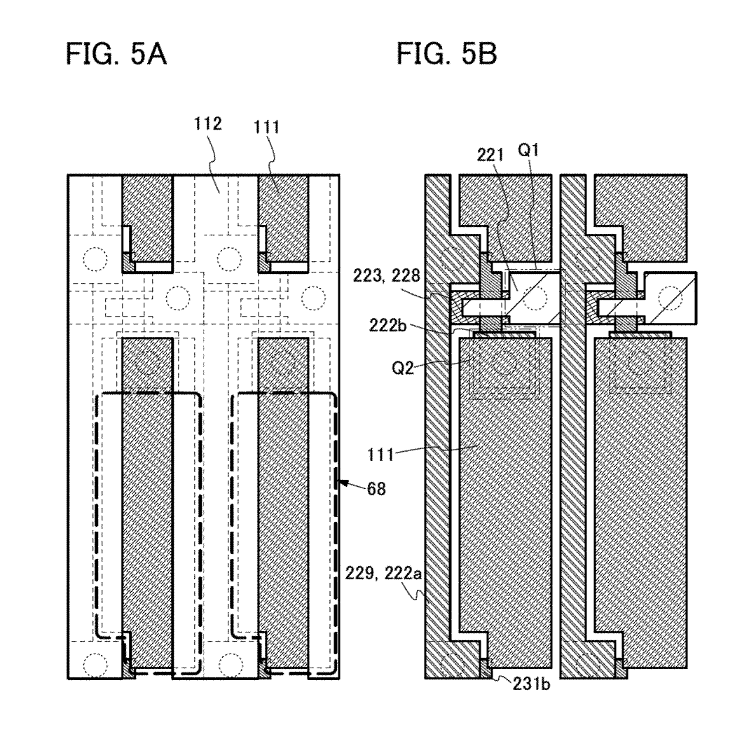

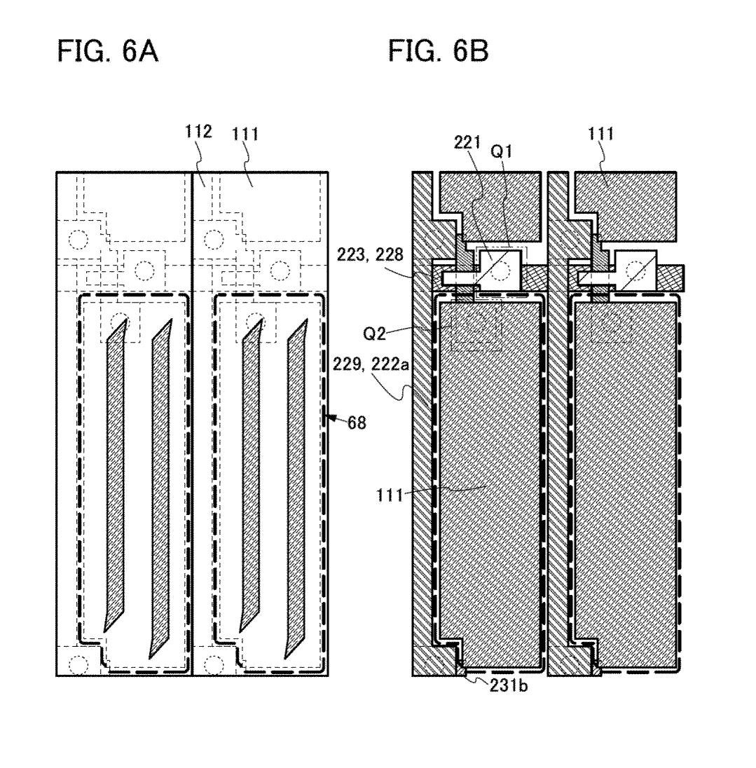

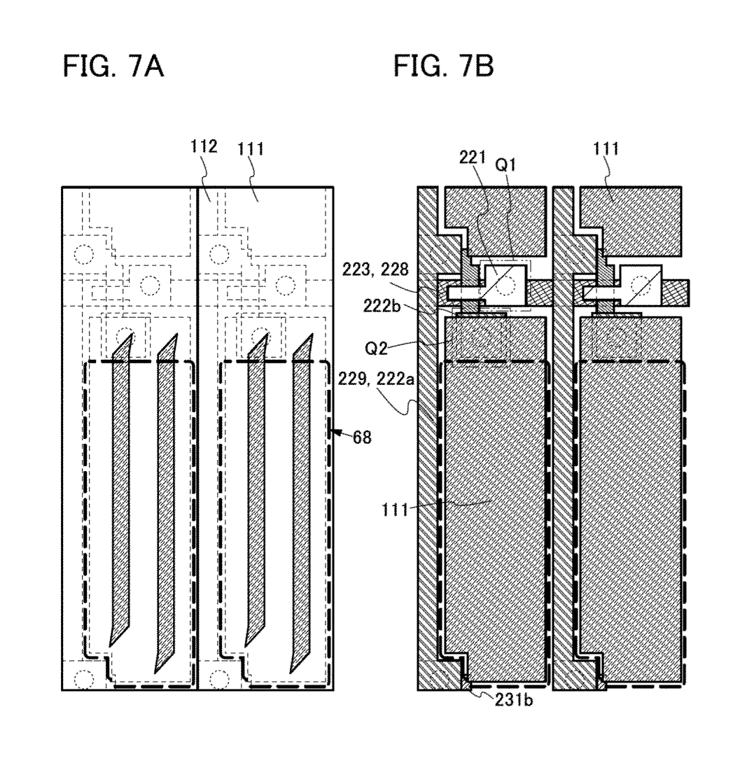

FIGS. 4A and 4B are top views of subpixels included in the display device 100A, as mentioned above. FIGS. 5A and 5B are top views of subpixels compared with those in FIGS. 4A and 4B. FIGS. 6A and 6B are top views of subpixels to which one embodiment of the present invention is applied. FIGS. 7A and 7B are top views of subpixels compared with those in FIGS. 6A and 6B.

First, the features of a pixel (a subpixel) in one embodiment of the present invention will be described, though some of them have been described above.

A pixel includes a transistor, a capacitor, a scan line, a signal line, and the like. These components are usually formed using a metal film with a low resistivity. Since the metal film does not transmit light, an area formed with the metal film is not included in a display region, reducing the aperture ratio of the pixel. A decrease in aperture ratio is particularly remarkable in higher-definition devices. In the case where the aperture ratio decreases in a liquid crystal display device, the amount of light from a backlight needs to increase in order to increase the luminance and contrast, causing an increased power consumption of the backlight.

In view of the above, one embodiment of the present invention employs a structure in which one or more of a transistor, a capacitor, a wiring, and a contact area provided in a pixel transmit visible light. Specifically, any of these components are formed with a material that transmits visible light, such as an oxide semiconductor or an oxide conductor. When the components in the pixel transmit visible light, the aperture ratio can be increased and the power consumption of a backlight can be reduced. Note that a metal material is used for a scan line, a signal line, a power source line, and a peripheral circuit in order to decrease the resistance. The conductive films with different functions are thus preferably formed in different manners.

The use of the material such as an oxide semiconductor or an oxide conductor, which transmits visible light, allows fabricating of transistors with a variety of structures. Unlike silicon, the oxide semiconductor transmits visible light even when doped with an impurity to have lower resistance.

To increase the aperture ratio of a pixel in a transmissive liquid crystal display device, the miniaturization of a transistor in the pixel is important because the area where light from a backlight is blocked can be reduced. In addition, for high-definition displays where each transistor is selected for a shorter time, a top gate self-alignment (TGSA) structure, which enables the overlap capacitance to be reduced compared with a channel-etched structure, is effective to reduce RC delay of a scan line and a signal line. Also in view of the effective transmittance, a pixel including a transistor with the TGSA structure is advantageous to a pixel including a transistor with the channel-etched structure.

In a pixel of a high-definition display device, a metal material is preferably used for a scan line and a signal line in order to reduce RC delay due to sheet resistance. In addition, a channel formation region of a transistor in the pixel preferably overlaps with the scan line so as not to be irradiated with light from a backlight. In the case where a liquid crystal element in an FFS mode is used, a capacitor can be formed with a pixel electrode and a common electrode.

In the contact area Q1 illustrated in FIG. 4B and FIG. 5B, the gates 221 and 223 are electrically connected.

In the contact area Q2 illustrated in FIG. 4B, the low-resistance region 231b in the semiconductor layer is directly connected to the pixel electrode 111. In the contact area Q2 illustrated in FIG. 5B, the conductive layer 222b is connected to the pixel electrode 111.

In the structure illustrated in FIGS. 4A and 4B, the low-resistance region 231b in the semiconductor layer that transmits visible light is directly connected to the pixel electrode 111. Hence, the contact area Q2 can be provided in the display region 68. In contrast, in the structure illustrated in FIGS. 5A and 5B, the pixel electrode 111 and the transistor are electrically connected to each other through the conductive layer 222b that blocks visible light. Accordingly, the aperture ratio of the subpixel in FIGS. 4A and 4B can be increased compared with that in FIGS. 5A and 5B. In addition, the power consumption of the display device can be reduced.

Although the semiconductor layer and the pixel electrode 111 are directly connected to each other in FIGS. 4A and 4B, they may be connected through a conductive layer that transmits visible light. However, when the semiconductor layer is directly connected to the pixel electrode 111, the conductive layer does not need to be formed, which simplifies the fabrication process and reduces the costs.

In one embodiment of the present invention, when the contact area between the pixel electrode 111 and the transistor is provided in the display region 68, the aperture ratio can be increased by 10% or more, or 20% or more. This enables the power consumption of the backlight to be reduced by 10% or more, or 20% or more.

The following is an estimated amount of change in aperture ratio and the power consumption of the backlight at the time of changing the structure in FIGS. 5A and 5B to the structure in FIGS. 4A and 4B.

An ultra-high-definition display is assumed here; the subpixel layouts in FIGS. 4A and 4B and FIGS. 5A and 5B are applied to a liquid crystal display device in an FFS mode that has a pixel density of 1058 ppi, a display area diagonal of 4.2 inches, and a resolution of 4K.

Each subpixel has a size of 8 μm×24 μm. Storage capacitance can be formed between the pixel electrode 111 and the common electrode 112 of the liquid crystal element. The transistor has the TGSA structure.

The aperture ratio of a subpixel in the comparative layout in FIG. 5A is 48.4%. The aperture ratio of a subpixel in the layout of one embodiment of the present invention illustrated in FIG. 4A is 63.6%. With the structure in which the contact area between the transistor and the pixel electrode transmits visible light, the aperture ratio increases 1.31 times, that is, the power consumption of the backlight is estimated to decrease by approximately 24%.

Note that the results of fabrication of a liquid crystal display device employing this layout will be described in Example 1.

FIGS. 6A and 6B and FIGS. 7A and 7B each illustrate a top view of a subpixel including a liquid crystal element that is in the FFS mode like in FIGS. 4A and 4B. In FIGS. 6A and 6B and FIGS. 7A and 7B, the pixel electrode 111 and the common electrode 112 are provided in order from the transistor side.

FIG. 6A and FIG. 7A are each a top view seen from the common electrode 112 side and each illustrate a layered structure from the gate 223 to the common electrode 112 in the subpixel. In FIG. 6A and FIG. 7A, the display region 68 in the subpixel is outlined in a bold dotted line. FIG. 6B and FIG. 7B each illustrate a top view of the layered structure of FIG. 6A or FIG. 7A except for the common electrode 112.

As illustrated in FIG. 6A and FIG. 7A, two or more openings of the common electrode 112 can be provided in the display region 68 in each subpixel.

In the contact area Q1 illustrated in FIG. 6B and FIG. 7B, the gates 221 and 223 are electrically connected.

In the contact area Q2 illustrated in FIG. 6B, the low-resistance region 231b in the semiconductor layer is directly connected to the pixel electrode 111. In the contact area Q2 illustrated in FIG. 7B, the conductive layer 222b is connected to the pixel electrode 111.

In the structure illustrated in FIGS. 6A and 6B, the low-resistance region 231b in the semiconductor layer that transmits visible light is directly connected to the pixel electrode 111. Hence, the contact area Q2 can be provided in the display region 68. In contrast, in the structure illustrated in FIGS. 7A and 7B, the pixel electrode 111 and the transistor are electrically connected to each other through the conductive layer 222b that blocks visible light. Accordingly, the aperture ratio of the subpixel in FIGS. 6A and 6B can be increased compared with that in FIGS. 7A and 7B. In addition, the power consumption of the display device can be reduced.

Although the semiconductor layer and the pixel electrode 111 are directly connected to each other in FIGS. 6A and 6B, they may be connected through a conductive layer that transmits visible light. However, when the semiconductor layer is directly connected to the pixel electrode 111, the conductive layer does not need to be formed, which simplifies the fabrication process and reduces the costs.

The following is an estimated amount of change in aperture ratio and the power consumption of the backlight at the time of changing the structure in FIGS. 7A and 7B to the structure in FIGS. 6A and 6B.

A portable terminal display is assumed here; the subpixel layouts in FIGS. 6A and 6B and FIGS. 7A and 7B are applied to a liquid crystal display device in an FFS mode that has a pixel density of 513 ppi, a display area diagonal of 4.3 inches, and a resolution of FHD.

Each subpixel has a size of 16.5 μm×49.5 μm. Storage capacitance can be formed between the pixel electrode 111 and the common electrode 112 of the liquid crystal element. The transistor has the TGSA structure.

The aperture ratio of a subpixel in the comparative layout in FIG. 7A is 45.0%. The aperture ratio of a subpixel in the layout of one embodiment of the present invention illustrated in FIG. 6A is 51.3%. With the structure in which the contact area between the transistor and the pixel electrode transmits visible light, the aperture ratio increases 1.14 times, that is, the power consumption of the backlight is estimated to decrease by approximately 13%.

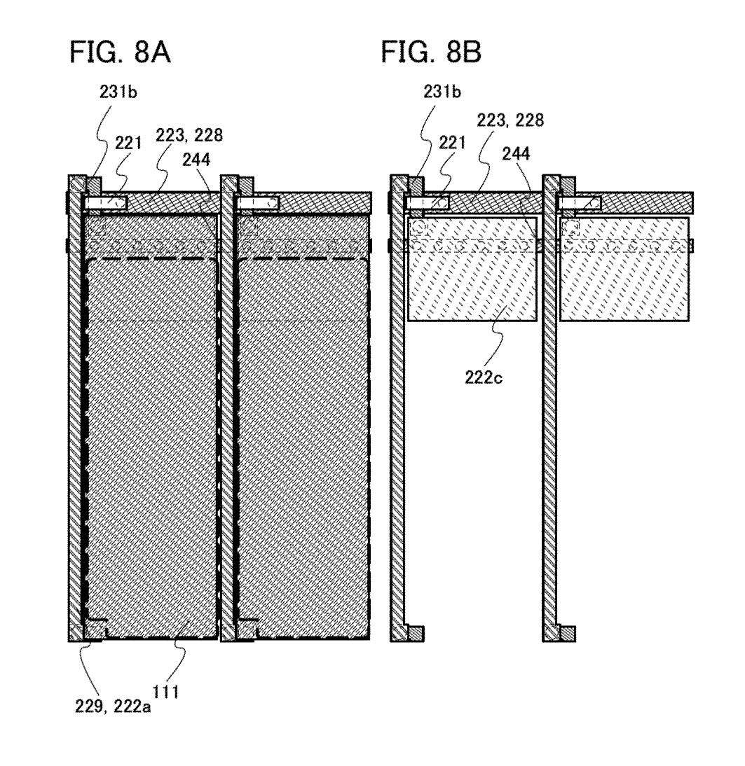

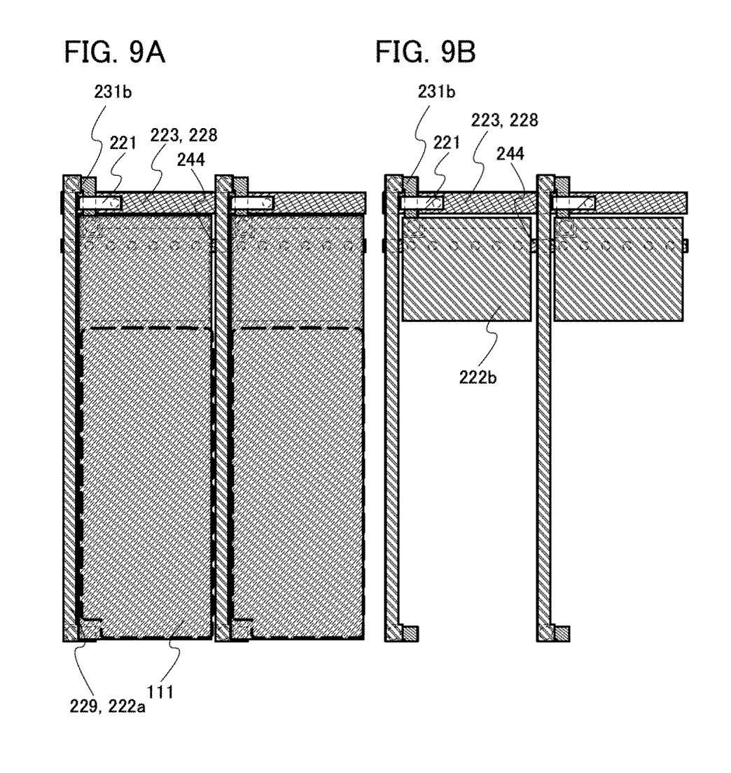

FIGS. 8A and 8B and FIGS. 9A and 9B each illustrate a top view of a subpixel including a liquid crystal element in a vertical electric field mode (e.g., TN mode or VA mode).

FIG. 8A and FIG. 9A are each a top view seen from the pixel electrode 111 side and each illustrate a layered structure from the gate 223 to the pixel electrode 111 in the subpixel. In FIG. 8A and FIG. 9A, the display region 68 in the subpixel is outlined in a bold dotted line. FIG. 8B and FIG. 9B each illustrate a top view of the layered structure of FIG. 8A or FIG. 9A except for the pixel electrode 111.

In the case where a liquid crystal element in a horizontal electric field mode is used, capacitance can be formed between the pixel electrode 111 and the common electrode 112. In contrast, in the case where a liquid crystal element in a vertical electric field mode is used, a capacitor is formed separately.

FIGS. 8A and 8B and FIGS. 9A and 9B each show an example in which a capacitor line 244 is provided in the subpixel. The capacitor line 244 is electrically connected to a conductive layer that is formed with the same material and the same process as those used in the conductive layer (e.g., the gate 221) of the transistor. In FIGS. 8A and 8B, a conductive layer 222c that transmits visible light is provided to overlap with the capacitor line 244. In FIGS. 9A and 9B, the conductive layer 222b that blocks visible light is provided to overlap with the capacitor line 244. In FIGS. 8A and 8B, the conductive layer 222c is connected to the pixel electrode 111. In FIGS. 9A and 9B, the conductive layer 222b is connected to the pixel electrode 111.

In the structure illustrated in FIGS. 8A and 8B, the conductive layer 222c transmits visible light. Hence, at least part of the capacitor, a contact area between the conductive layer 222c and the pixel electrode 111, and the like can be provided in the display region 68. In contrast, the conductive layer 222b illustrated in FIGS. 9A and 9B blocks visible light. Accordingly, the aperture ratio of the subpixel in FIGS. 8A and 8B can be increased compared with that in FIGS. 9A and 9B. In addition, the power consumption of the display device can be reduced.

The following is an estimated amount of change in aperture ratio and the power consumption of the backlight at the time of changing the structure in FIGS. 9A and 9B to the structure in FIGS. 8A and 8B.

A PC monitor display is assumed here; the subpixel layouts in FIGS. 8A and 8B and FIGS. 9A and 9B are applied to a liquid crystal display device in a TN mode that has a pixel density of 166 ppi, a display area diagonal of 13.3 inches, and a resolution of FHD.

Each subpixel has a size of 51 μm×153 μm. A liquid crystal element is in a vertical electric field mode. Storage capacitance can be formed between a conductive layer that is formed with the same material and the same process as those used in a gate and a conductive layer that is formed with the same material and the same process as those used in a source and a drain. The transistor has the TGSA structure.

The aperture ratio of a subpixel in the comparative layout in FIG. 9A is 61.8%. The aperture ratio of a subpixel in the layout of one embodiment of the present invention illustrated in FIG. 8A is 72.1%. With the structure in which the contact area of the transistor and the storage capacitance with the pixel electrode transmits visible light, the aperture ratio increases 1.17 times, that is, the power consumption of the backlight is estimated to decrease by approximately 14%.

### [Materials]

Next, details of the materials that can be used for the components of the display device in this embodiment and the like are described. Note that description on the components already described is omitted in some cases. The materials described below can be used as appropriate in the display device, a touch panel, and the components thereof described later.

### <<Substrates 51 and 61>>

There are no large limitations on the material of the substrate used in the display device of one embodiment of the present invention; a variety of substrates can be used. For example, a glass substrate, a quartz substrate, a sapphire substrate, a semiconductor substrate, a ceramic substrate, a metal substrate, or a plastic substrate can be used.

The weight and thickness of the display device can be reduced by using a thin substrate. Furthermore, a flexible display device can be obtained by using a substrate that is thin enough to have flexibility.

The display device of one embodiment of the present invention is fabricated by forming a transistor and the like over a fabrication substrate, then transferring the transistor and the like on another substrate. The use of the fabrication substrate allows the following: a formation of a transistor with favorable characteristics; a formation of a transistor with low power consumption; a manufacturing of a durable display device, an addition of heat resistance to the display device, a manufacturing of a more lightweight display device, or a manufacturing of a thinner display device. Examples of a substrate to which a transistor is transferred include, in addition to the substrate over which the transistor can be formed, a paper substrate, a cellophane substrate, a stone substrate, a wood substrate, a cloth substrate (including a natural fiber (e.g., silk, cotton, or hemp), a synthetic fiber (e.g., nylon, polyurethane, or polyester), a regenerated fiber (e.g., acetate, cupra, rayon, or regenerated polyester), and the like), a leather substrate, and a rubber substrate.

### <<Transistors 201 and 206>>

A transistor included in the display device of one embodiment of the present invention may have a top-gate structure or a bottom-gate structure. Gate electrodes may be provided above and below a channel. There is no particular limitation on a semiconductor material used for the transistor, and an oxide semiconductor, silicon, or germanium can be used, for example.

There is no particular limitation on the crystallinity of a semiconductor material used for the transistor, and an amorphous semiconductor or a semiconductor having crystallinity (a microcrystalline semiconductor, a polycrystalline semiconductor, a single crystal semiconductor, or a semiconductor partly including crystal regions) may be used. A semiconductor having crystallinity is preferably used, in which case deterioration of the transistor characteristics can be suppressed.

For example, a Group 14 element, a compound semiconductor, or an oxide semiconductor can be used for the semiconductor layer. Typically, a semiconductor including silicon, a semiconductor including gallium arsenide, or an oxide semiconductor including indium can be used for the semiconductor layer.

An oxide semiconductor is preferably used as a semiconductor in which a channel of the transistor is formed. In particular, an oxide semiconductor having a wider band gap than silicon is preferably used. The use of a semiconductor material with a larger bandgap than silicon and a small carrier density is preferable because the current during the off state (off-state current) of the transistor can be reduced.

For the oxide semiconductor, the above description and Embodiment 4 can be referred to, for example.

The use of such an oxide semiconductor achieves a highly reliable transistor with little change in the electrical characteristics.

Charge accumulated in the capacitor through the transistor can be retained for a long time because of low off-state current of the transistor. The use of such a transistor in pixels allows a driver circuit to stop while the gray level of a displayed image is maintained. As a result, a display device with extremely low power consumption is obtained.

The transistors 201 and 206 preferably include an oxide semiconductor layer that is highly purified to reduce the formation of oxygen vacancies. Accordingly, the off-state current of the transistors can be made small. Accordingly, an electrical signal such as an image signal can be held for a longer period, and a writing interval can be set longer in an on state. Accordingly, the frequency of refresh operation can be reduced, which leads to an effect of suppressing power consumption.

In the transistors 201 and 206, relatively high field-effect mobility can be obtained, whereby high-speed operation is possible. The use of such transistors that are capable of high-speed operation in the display device enables the transistor in the display portion and the transistor in the driver circuit portion to be formed over the same substrate. This means that a semiconductor device separately formed with a silicon wafer or the like does not need to be used as the driver circuit, which results in a reduction of the number of components in the display device. In addition, the transistor that can operate at high speed can be used also in the display portion, whereby a high-quality image can be provided.

### <<Insulating Layer>>

An organic insulating material or an inorganic insulating material can be used as an insulating material that can be used for the insulating layer, the overcoat, the spacer, or the like included in the display device. Examples of an organic insulating material include an acrylic resin, an epoxy resin, a polyimide resin, a polyamide resin, a polyamide-imide resin, a siloxane resin, a benzocyclobutene-based resin, and a phenol resin. Examples of an inorganic insulating layer include a silicon oxide film, a silicon oxynitride film, a silicon nitride oxide film, a silicon nitride film, an aluminum oxide film, a hafnium oxide film, an yttrium oxide film, a zirconium oxide film, a gallium oxide film, a tantalum oxide film, a magnesium oxide film, a lanthanum oxide film, a cerium oxide film, and a neodymium oxide film.

### <<Conductive Layer>>

For the conductive layer such as the gate, the source, and the drain of the transistor and the wiring and the electrode of the display device, a single-layer structure or a layered structure using any of metals such as aluminum, titanium, chromium, nickel, copper, yttrium, zirconium, molybdenum, silver, tantalum, and tungsten, or an alloy containing any of these metals as its main component can be used. For example, a two-layer structure in which a titanium film is stacked over an aluminum film; a two-layer structure in which a titanium film is stacked over a tungsten film; a two-layer structure in which a copper film is stacked over a molybdenum film; a two-layer structure in which a copper film is stacked over an alloy film containing molybdenum and tungsten; a two-layer structure in which a copper film is stacked over an alloy film containing copper, magnesium, and aluminum; a three-layer structure in which a titanium film or a titanium nitride film, an aluminum film or a copper film, and a titanium film or a titanium nitride film are stacked in this order; or a three-layer structure in which a molybdenum film or a molybdenum nitride film, an aluminum film or a copper film, and a molybdenum film or a molybdenum nitride film are stacked in this order can be employed. For example, in the case where the conductive layer has a three-layer structure, it is preferable that each of the first and third layers be a film formed of titanium, titanium nitride, molybdenum, tungsten, an alloy containing molybdenum and tungsten, an alloy containing molybdenum and zirconium, or molybdenum nitride, and that the second layer be a film formed of a low-resistance material such as copper, aluminum, gold, silver, or an alloy containing copper and manganese. Note that light-transmitting conductive materials such as ITO, indium oxide containing tungsten oxide, indium zinc oxide containing tungsten oxide, indium oxide containing titanium oxide, indium tin oxide containing titanium oxide, indium zinc oxide, or ITSO may be used.

An oxide conductive layer may be formed by controlling the resistivity of the oxide semiconductor.

### <<Adhesive Layer 141>>

A curable resin such as a heat-curable resin, a photocurable resin, or a two-component type curable resin can be used for the adhesive layer 141. For example, an acrylic resin, a urethane resin, an epoxy resin, or a siloxane resin can be used.

### <<Connector 242>>

As the connector 242, for example, an anisotropic conductive film (ACF) or an anisotropic conductive paste (ACP) can be used.

<<Coloring layer 131>>

The coloring layer 131 is a colored layer that transmits light in a specific wavelength range. Examples of materials that can be used for the coloring layer 131 include a metal material, a resin material, and a resin material containing a pigment or dye.

### <<Light-Blocking Layer 132>>

The light-blocking layer 132 is provided, for example, between adjacent coloring layers 131 for different colors. A black matrix formed with, for example, a metal material or a resin material containing a pigment or dye can be used as the light-blocking layer 132. Note that it is preferable to provide the light-blocking layer 132 also in a region other than the display portion 62, such as the driver circuit portion 64, in which case leakage of guided light or the like can be inhibited.

The thin films constituting the display device (i.e., the insulating film, the semiconductor film, and the conductive film) can be formed by a sputtering method, a chemical vapor deposition (CVD) method, a vacuum evaporation method, a pulsed laser deposition (PLD) method, an atomic layer deposition (ALD) method, and the like. As examples of a CVD method, a plasma-enhanced CVD (PECVD) method or a thermal CVD method can be given. As an example of the thermal CVD method, metal organic CVD (MOCVD) method can be given.

Alternatively, the thin films constituting the display device (i.e., the insulating film, the semiconductor film, and the conductive film) can be formed by a method such as spin coating, dipping, spray coating, inkjet printing, dispensing, screen printing, or offset printing, or with a doctor knife, a slit coater, a roll coater, a curtain coater, or a knife coater.

The thin films constituting the display device can be processed using a photolithography method or the like. Alternatively, island-shaped thin films may be formed by a film formation method using a blocking mask. Alternatively, the thin films may be processed by a nano-imprinting method, a sandblasting method, a lift-off method, or the like. As the photolithography method, there are a method in which a resist mask is formed over a thin film to be processed, the thin film is processed by etching or the like, and the resist mask is removed and a method in which a photosensitive thin film is formed, and the photosensitive thin film is exposed to light and developed to be processed in a desirable shape.

As light used in exposure in a photolithography method, light with an i-line (with a wavelength of 365 nm), light with a g-line (with a wavelength of 436 nm), light with an h-line (with a wavelength of 405 nm), and light in which the i-line, the g-line, and the h-line are mixed can be given. Alternatively, ultraviolet light, KrF laser light, ArF laser light, or the like can be used. Exposure may be performed by liquid immersion exposure technique. As light used in exposure, extreme ultra-violet light (EUV), X-rays, or the like can be given. Instead of the light for the exposure, an electron beam can be used. It is preferable to use extreme ultra-violet light, X-rays, or an electron beam because extremely minute processing can be performed. Note that in the case of performing exposure by scanning of a beam such as an electron beam, a photomask is not needed.

For etching of the thin films, dry etching, wet etching, a sandblast method, or the like can be used.

### 2. Structure Example 2 of Display Device

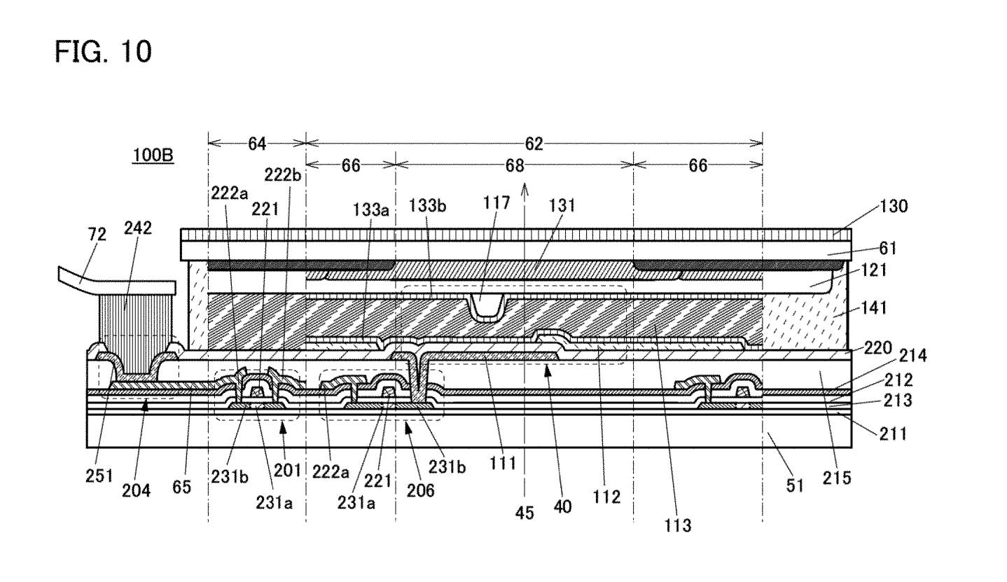

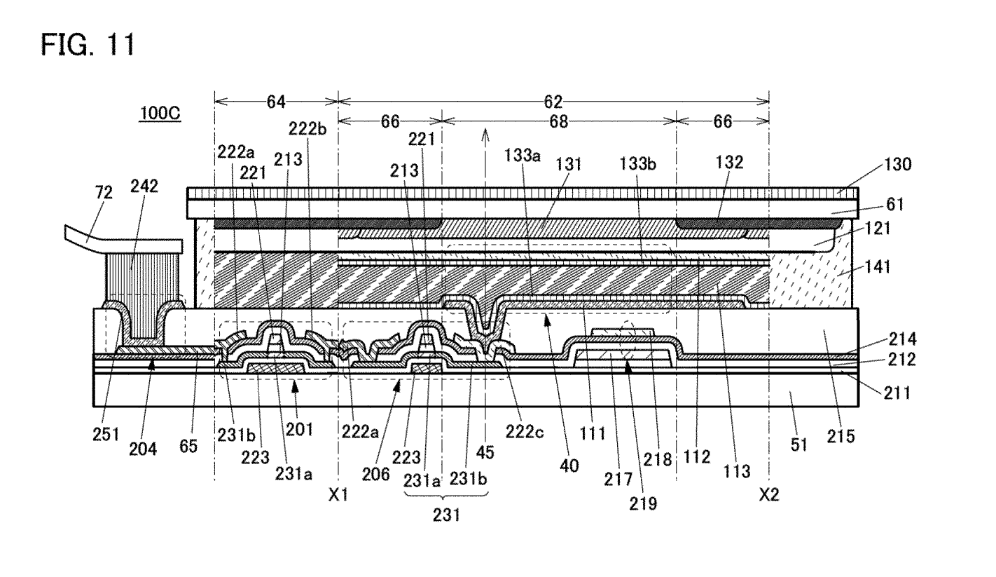

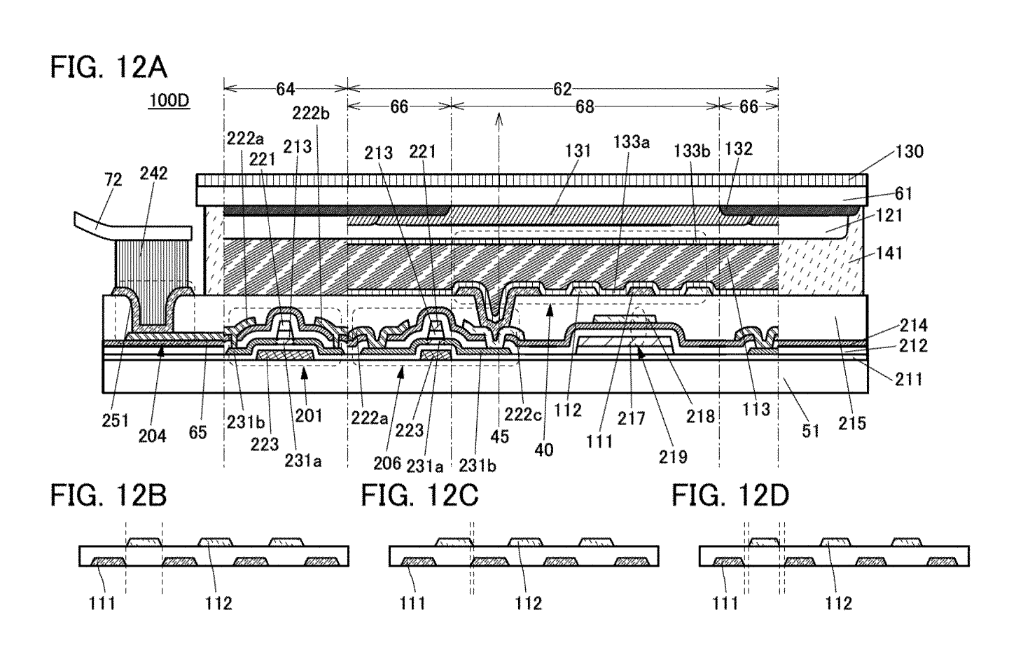

FIG. 10, FIG. 11, and FIGS. 12A to 12D show examples of the display device. FIG. 10 is a cross-sectional view of a display device 100B. FIG. 11 is a cross-sectional view of a display device 100C. FIG. 12A is a cross-sectional view of a display device 100D. Note that the perspective views of the display devices 100B, 100C, and 100D are not drawn here, as they are similar to the perspective view of the display device 100A, which is illustrated in FIG. 1.

The display device 100B illustrated in FIG. 10 is different from the display device 100A in the structure of the transistors.

Specifically, the transistors 201 and 206 in the display device 100A each include two gates; in contrast, the transistors 201 and 206 in the display device 100B each have a single gate structure with only the gate 221. In one embodiment of the present invention, one or both of the transistors 201 and 206 can have a single gate structure.

In addition, the display device 100B includes a spacer 117.

The spacer 117 has a function of keeping the distance between the substrate 51 and the substrate 61 greater than or equal to a certain distance.

In the example shown in FIG. 10, the bottom surface of the spacer 117 is in contact with the overcoat 121; however, one embodiment of the present invention is not limited thereto. The spacer 117 may be provided on the substrate 51 side or the substrate 61 side.

In the example shown in FIG. 10, the alignment films 133a and 133b are not in contact with each other in a region where the alignment films 133a and 133b overlap with the spacer 117; however, the alignment films 133a and 133b may be in contact with each other. Furthermore, the spacer 117 provided over one substrate may be, but is not necessarily, in contact with a structure provided over the other substrate. For example, the liquid crystal layer 113 may be positioned between the spacer 117 and the structure.

A particulate spacer may be used as the spacer 117. As the particulate spacer, materials such as silica can be used. Spacer is preferably made of a material with elasticity, such as a resin or rubber. In this case, the particulate spacer may take a shape that is vertically crushed.

Other components are similar to those in the display device 100A; thus, the detailed description thereof is omitted.

The display device 100C illustrated in FIG. 11 is an example of a transmissive liquid crystal display device that includes a liquid crystal element in a vertical electric field mode.

As illustrated in FIG. 11, the display device 100C includes the substrate 51, the transistor 201, the transistor 206, the liquid crystal element 40, a capacitor 219, the alignment film 133a, the alignment film 133b, the connection portion 204, the adhesive layer 141, the coloring layer 131, the light-blocking layer 132, the overcoat 121, the substrate 61, the polarizer 130, and the like.

The display portion 62 includes the transistor 206, the liquid crystal element 40, and the capacitor 219.

The transistor 206 includes the gate 221, the insulating layer 213, and the semiconductor layer 231 (the channel region 231a and the low-resistance region 231b).

The conductive layer 222a is connected to the low-resistance region 231b through an opening provided in the insulating layers 214 and 215.

The liquid crystal element 40 is a liquid crystal element in a VA mode. The liquid crystal element 40 includes the pixel electrode 111, the common electrode 112, and the liquid crystal layer 113. The liquid crystal layer 113 is positioned between the pixel electrode 111 and the common electrode 112.

The pixel electrode 111 is electrically connected to the low-resistance region 231b in the semiconductor layer of the transistor 206 with the conductive layer 222c positioned therebetween.

The capacitor 219 includes a conductive layer 217 and a conductive layer 218. The conductive layer 217 and the conductive layer 218 overlap with each other with the insulating layers 212 and 214 positioned therebetween.

The semiconductor layer 231 (the channel region 231a and the low-resistance region 231b), the gate 221, the conductive layer 222c, the conductive layer 217, and the conductive layer 218 are formed using a conductive material that transmits visible light. The conductive layer 217 and the gate 221 can be formed using the same process and the same material. The conductive layer 218 and the conductive layer 222c can be formed using the same process and the same material. Hence, the contact area between the pixel electrode 111 and the transistor 206 and the capacitor 219 can be provided in the display region 68. Accordingly, the aperture ratio can be increased.

When the overcoat 121 has a planarization function, the common electrode 112 can be provided flatly. This allows a thickness variation of the liquid crystal layer 113 to be reduced.

Examples of materials and formation methods of layers in the transistor 206 illustrated in FIG. 11 are described.

First, a metal film is formed as the gate 223, which is a bottom gate electrode (a back gate electrode). This metal film also serves as a scan line. With use of this metal film, a gate wiring of a transistor in a peripheral circuit can also be formed in the same process. Then, a stack of a silicon nitride film and a silicon oxynitride film is formed as the insulating layer 211. Next, a cloud-aligned composite oxide semiconductor (CAC-OS) film is formed as the semiconductor layer 231 by a sputtering method. Subsequently, a silicon oxynitride film is formed as the insulating layer 213 (a gate insulating layer) with a PECVD apparatus. Then, a conductive film that transmits visible light is formed as the gate 221 (a top gate electrode). With use of this conductive film that transmits visible light, one electrode (the conductive layer 217) of the capacitor 219 can also be formed in the same process. The gate 221 and the insulating layer 213 are sequentially etched with the top gate pattern used as a mask, whereby part of the semiconductor layer 231 (that is to be the low-resistance region 231b) can be exposed. Next, a silicon nitride film and a silicon oxynitride film are stacked as the insulating layer 212 and the insulating layer 214, respectively, which are interlayer insulating films. Note that when part of the semiconductor layer 231 (that is to be the low-resistance region 231b) is in contact with the silicon nitride film, the part of the semiconductor layer 231 can have a low resistance. Then, an opening (a contact hole) is formed in the insulating layers 212 and 214. Subsequently, a conductive film that transmits visible light is formed as the conductive layer 222c serving as the source or drain wiring. With use of this conductive film that transmits visible light, one electrode (the conductive layer 218) of the capacitor 219 can also be formed in the same process. A metal film is formed as the conductive layer 222a serving as a signal line. With use of this metal film, a source wiring and a drain wiring of the transistor in the peripheral circuit can also be formed in the same process. After that, an acrylic resin is applied as the insulating layer 215 having a planarization function, and an opening (a contact hole) is formed. Then, an ITO film is formed as the pixel electrode 111.

A metal film such as a Cu film, which is formed as a scan line, is preferably used for the back gate of the transistor in the pixel. This prevents the channel formation region from being irradiated with the light 45 from the backlight. In FIG. 11, the contact area between the transistor and the pixel electrode, and the capacitor can transmit visible light.

The display device 100D illustrated in FIG. 12A is different from the display device 100C in the arrangement and shapes of the pixel electrode 111 and the common electrode 112.

Both of the pixel electrode 111 and the common electrode 112 may have a top-surface shape (also referred to as a planar shape) that has a comb-like shape or a top-surface shape that is provided with a slit.

In the display device 100D illustrated in FIG. 12A, the pixel electrode 111 and the common electrode 112 are provided on the same plane.

Alternatively, the electrodes may have a shape in which an edge of a slit in one electrode is aligned with an edge of a slit in the other electrode, when seen from above. The cross-sectional view of this case is shown in FIG. 12B.

Alternatively, the pixel electrode 111 and the common electrode 112 may have a portion overlapping with each other, when seen from above. The cross-sectional view of this case is shown in FIG. 12C.

Alternatively, the display portion 62 may have a portion where neither the pixel electrode 111 nor the common electrode 112 is provided, when seen from above. The cross-sectional view of this case is shown in FIG. 12D.

As described above, the display device of one embodiment of the present invention can include transistors and liquid crystal elements with various shapes.

### 3. Pixel Arrangement Example

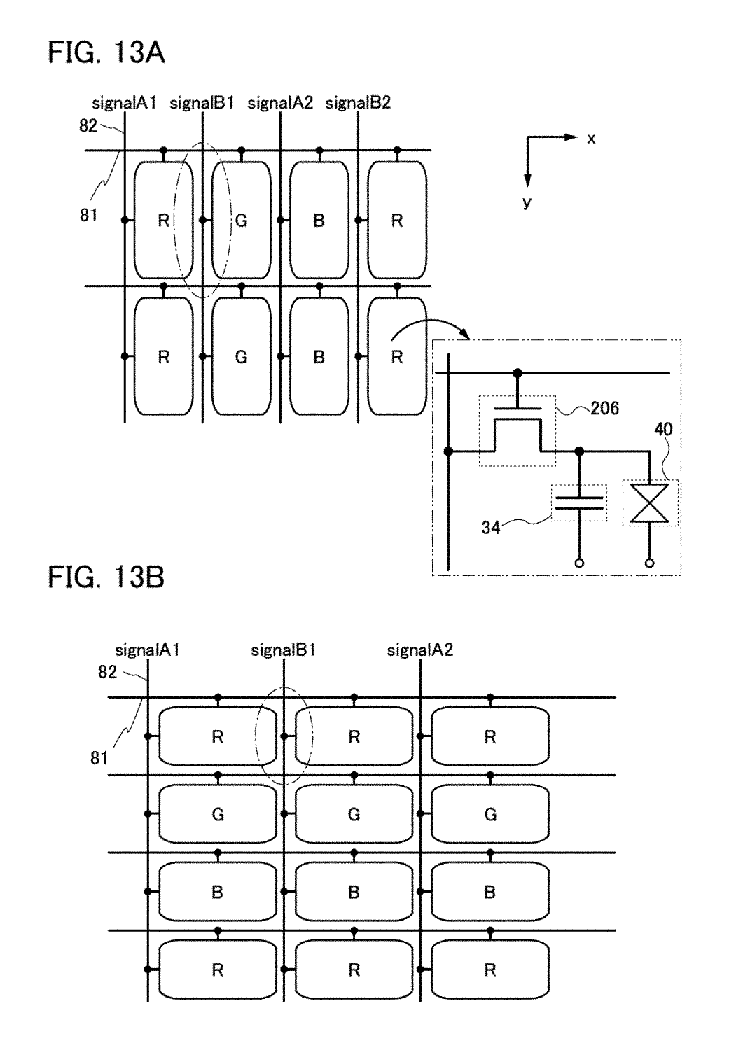

The pixel arrangement examples are shown in FIGS. 13A and 13B. FIGS. 13A and 13B show examples in which one pixel is composed of a red subpixel R, a green subpixel G, and a blue subpixel B. In FIGS. 13A and 13B, a plurality of scan lines 81 extend in the x direction, and a plurality of signal lines 82 extend in the y direction. The scan lines 81 and the signal lines 82 intersect with each other.

As shown by the dashed-two-dotted line in FIG. 13A, a subpixel includes the transistor 206, a capacitor 34, and the liquid crystal element 40. A gate of the transistor 206 is electrically connected to the scan line 81. One of a source and a drain of the transistor 206 is electrically connected to the signal line 82, and the other is electrically connected to one electrode of the capacitor 34 and one electrode of the liquid crystal element 40. The other electrode of the capacitor 34 and the other electrode of the liquid crystal element 40 are each supplied with a constant potential.

FIGS. 13A and 13B show examples where source-line inversion driving is adopted. Signals A1 and A2 are signals with the same polarity. Signals B1 and B2 are signals with the same polarity. Signals A1 and B1 are signals with different polarities. Signals A2 and B2 are signals with different polarities.

As the definition of the display device becomes higher, the distance between subpixels becomes shorter. Thus, as shown in the frame outlined in a dashed-dotted line in FIG. 13A, in the subpixel where the signal A1 is input, the liquid crystal is easily affected by potentials in both the signal A1 and the signal B1, in the vicinities of the signal line 82 where the signal B1 is input. This can make the liquid crystal more prone to alignment defects.

In FIG. 13A, the direction in which a plurality of subpixels exhibiting the same color are aligned is the y direction, and is substantially parallel to the direction where the signal lines 82 extend. As shown in the frame outlined in the dashed-dotted line in FIG. 13A, subpixels exhibiting different colors are adjacent to each other, with the longer sides of the subpixels facing each other.

In FIG. 13B, the direction in which a plurality of subpixels exhibiting the same color are aligned is the x direction, and intersects with the direction where the signal lines 82 extend. As shown in the frame outlined in a dashed-dotted line in FIG. 13B, subpixels exhibiting the same color are adjacent to each other, with the shorter sides of the subpixels facing each other.

When the side of the subpixel that is substantially parallel to the direction in which the signal lines 82 extend is the shorter side of the subpixel as illustrated in FIG. 13B, the region where the liquid crystal is more prone to alignment defects can be made narrower, compared with the case (illustrated in FIG. 13A) where the longer side of the subpixel is substantially parallel to the direction in which the signal lines 82 extend. When the region where the liquid crystal is more prone to alignment defects is positioned between subpixels exhibiting the same color as illustrated in FIG. 13B, display defects are less easily recognized by a user of the display device when compared with the case (see FIG. 13A) where the region is positioned between subpixels exhibiting different colors. In one embodiment of the present invention, the direction in which the plurality of subpixels exhibiting the same color are arranged preferably intersects with the direction in which the signal lines 82 extend.

### 4. Structure Example 3 of Display Device

One embodiment of the present invention can be applied to a display device in which a touch sensor is implemented; such a display device is also referred to as an input/output device or a touch panel. Any of the structures of the display device described above can be applied to the touch panel. In this embodiment, the description focuses on an example in which the touch sensor is implemented in the display device 100A.

There is no limitation on the sensing element (also referred to as a sensor element) included in the touch panel of one embodiment of the present invention. A variety of sensors capable of sensing an approach or a contact of an object such as a finger or a stylus can be used as the sensor element.

For example, a variety of types such as a capacitive type, a resistive type, a surface acoustic wave type, an infrared type, an optical type, and a pressure-sensitive type can be used for the sensor.

In this embodiment, a touch panel including a capacitive sensor element is described as an example.

Examples of the capacitive touch sensor element include a surface capacitive touch sensor element and a projected capacitive touch sensor element. Examples of the projected capacitive sensor element include a self-capacitive sensor element and a mutual capacitive sensor element. The use of a mutual capacitive sensor element is preferable because multiple points can be sensed simultaneously.

The touch panel of one embodiment of the present invention can have any of a variety of structures, including a structure in which a display device and a sensor element that are separately formed are attached to each other and a structure in which an electrode and the like included in a sensor element are provided on one or both of a substrate supporting a display element and a counter substrate.

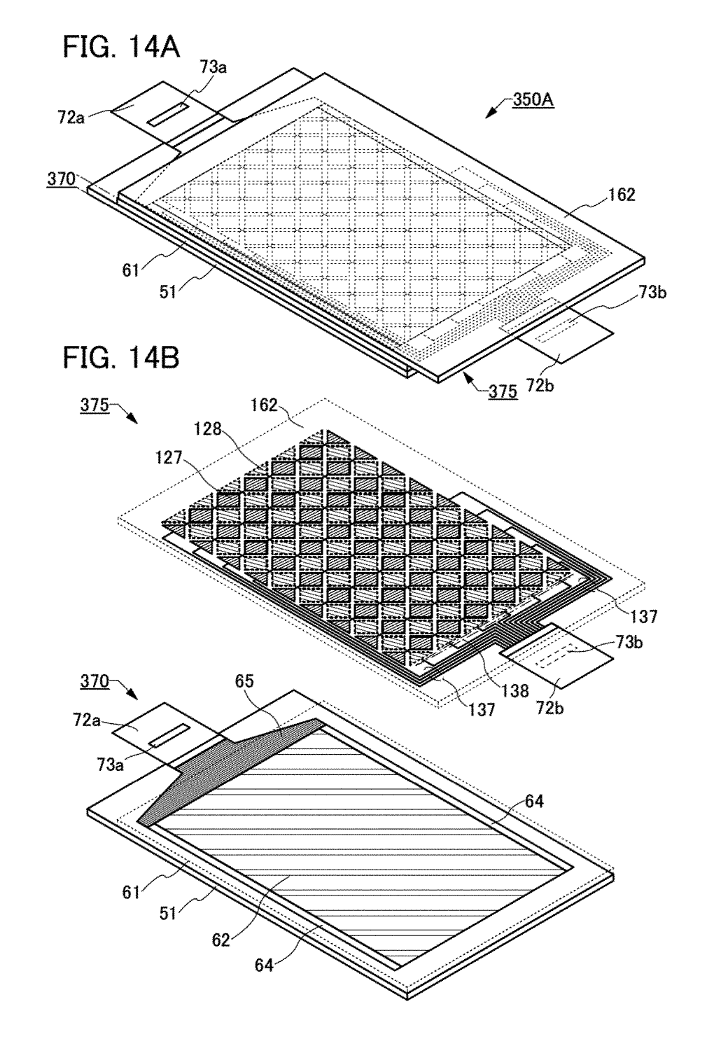

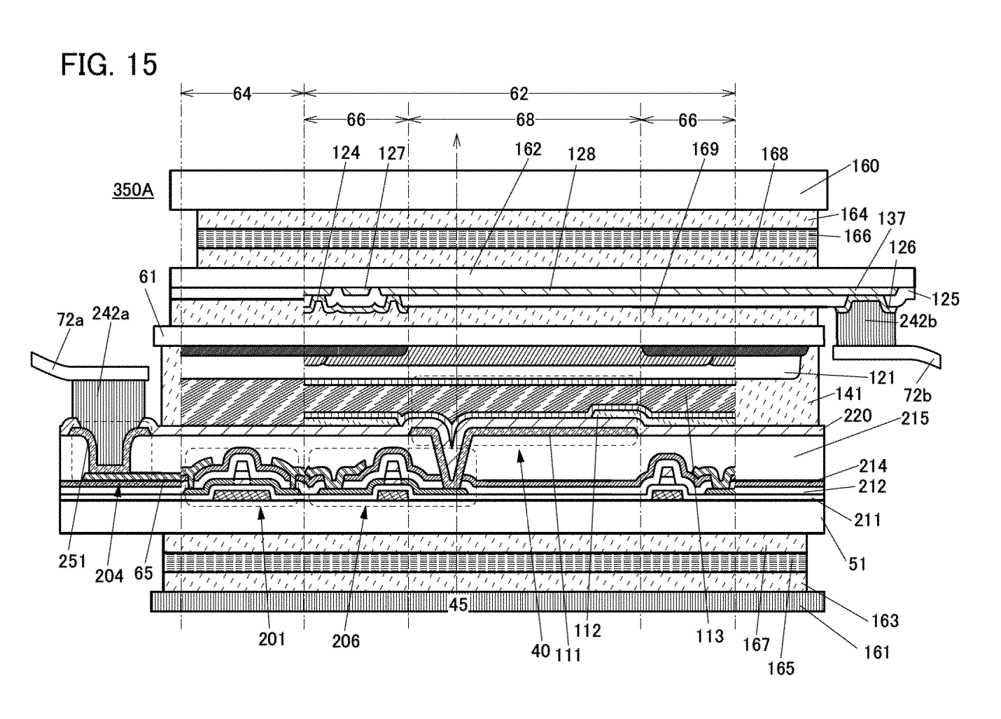

FIGS. 14A and 14B and FIG. 15 illustrate an example of the touch panel. FIG. 14A is a perspective view of a touch panel 350A. FIG. 14B is a developed view of the schematic perspective view of FIG. 14A. Note that for simplicity, FIGS. 14A and 14B illustrate only the major components. In FIG. 14B, the outlines of the substrate 61 and a substrate 162 are illustrated only in dashed lines. FIG. 15 is a cross-sectional view of the touch panel 350A.

The touch panel 350A has a structure in which a display device and a sensor element that are fabricated separately are bonded together.

The touch panel 350A includes an input device 375 and a display device 370 that are provided to overlap with each other.

The input device 375 includes the substrate 162, an electrode 127, an electrode 128, a plurality of wirings 137, and a plurality of wirings 138. An FPC 72b is electrically connected to each of the plurality of wirings 137 and the plurality of wirings 138. An IC 73b is provided on the FPC 72b.

The display device 370 includes the substrate 51 and the substrate 61 which are provided to face each other. The display device 370 includes the display portion 62 and the driver circuit portion 64. The wiring 65 and the like are provided over the substrate 51. An FPC 72a is electrically connected to the wiring 65. An IC 73a is provided on the FPC 72a.

The wiring 65 supplies signals and power to the display portion 62 and the driver circuit portion 64. The signals and power are input to the wiring 65 from the outside or the IC 73a, through the FPC 72a.

FIG. 15 is a cross-sectional view of the display portion 62, the driver circuit portion 64, a region that includes the FPC 72a, a region that includes the FPC 72b, and the like.

The substrates 51 and 61 are bonded to each other by the adhesive layer 141. The substrates 61 and 162 are bonded to each other by an adhesive layer 169. Here, the layers from the substrate 51 to the substrate 61 correspond to the display device 370. The layers from the substrate 162 to an electrode 124 correspond to the input device 375. That is, the adhesive layer 169 bonds the display device 370 and the input device 375 together.

The structure of the display device 370 illustrated in FIG. 15 is similar to that of the display device 100A illustrated in FIG. 2; detailed description is omitted here.

A polarizer 165 is bonded to the substrate 51 with an adhesive layer 167. A backlight 161 is bonded to the polarizer 165 with an adhesive layer 163.

Examples of a type of backlight that can be used as the backlight 161 include a direct-below backlight and an edge-light backlight. The use of the direct-below backlight with light-emitting diodes (LEDs) is preferable as it enables complex local dimming and an increase in contrast. The edge-light type backlight is preferably used because the thickness of a module including the backlight can be reduced.

A polarizer 166 is bonded to the substrate 162 with an adhesive layer 168. A protection substrate 160 is bonded to the polarizer 166 with an adhesive layer 164. The protection substrate 160 may be used as the substrate that objects such as a finger or a stylus directly contact, when the touch panel 350A is incorporated into an electronic device. A substrate that can be used as the substrates 51 and 61 or the like can be used as the protection substrate 160. A structure where a protective layer is formed on the surface of the substrate that can be used as the substrates 51 and 61 or the like is preferably used for the protection substrate 160. Alternatively, a reinforced glass or the like is preferably used as the protection substrate 160. The protective layer can be formed with a ceramic coating. The protective layer can be formed using an inorganic insulating material such as silicon oxide, aluminum oxide, yttrium oxide, or yttria-stabilized zirconia (YSZ).

The polarizer 166 may be provided between the input device 375 and the display device 370. In that case, the protection substrate 160, the adhesive layer 164, and the adhesive layer 168 that are illustrated in FIG. 15 are not necessarily provided. In other words, the substrate 162 can be positioned on the outermost surface of the touch panel 350A. The above-described material that can be used for the protection substrate 160 is preferably used for the substrate 162.

The electrodes 127 and 128 are provided on the side of the substrate 162 that faces the substrate 61. The electrodes 127 and 128 are formed on the same plane. An insulating layer 125 is provided to cover the electrodes 127 and 128. The electrode 124 is electrically connected to two of the electrodes 128 that are provided on both sides of the electrode 127, through an opening provided in the insulating layer 125.

In the conductive layers included in the input device 375, the conductive layers (e.g., the electrodes 127 and 128) that overlap with the display region 68 are formed using a material that transmits visible light.

The wiring 137 that is obtained by processing the same conductive layer as the electrodes 127 and 128 is connected to a conductive layer 126 that is obtained by processing the same conductive layer as the electrode 124. The conductive layer 126 is electrically connected to the FPC 72b through a connector 242b.

### 5. Structure Example 4 of Display Device

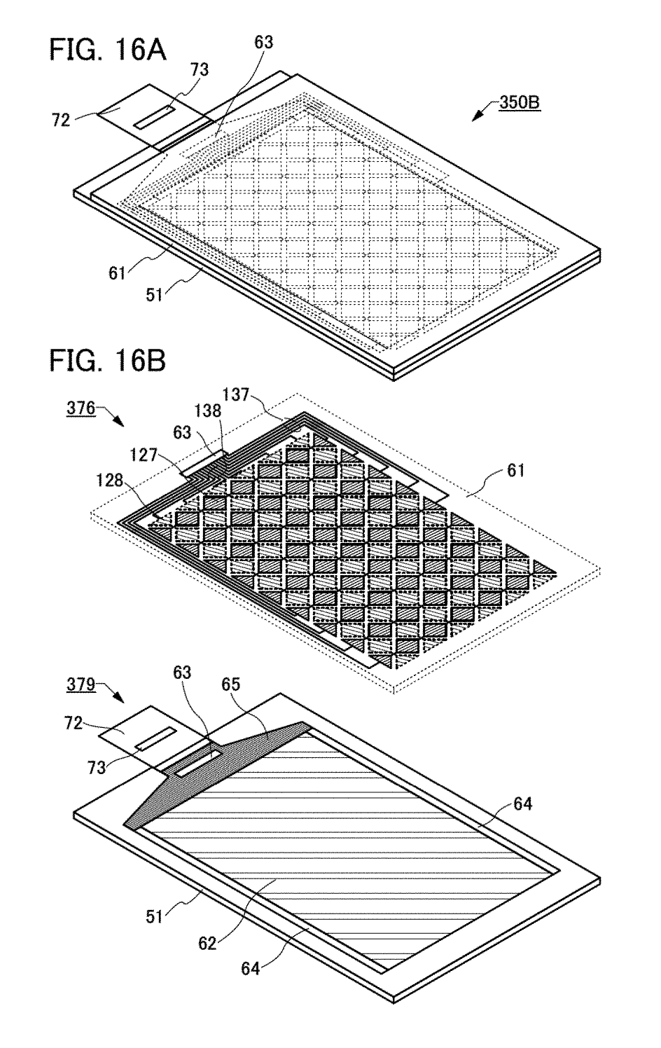

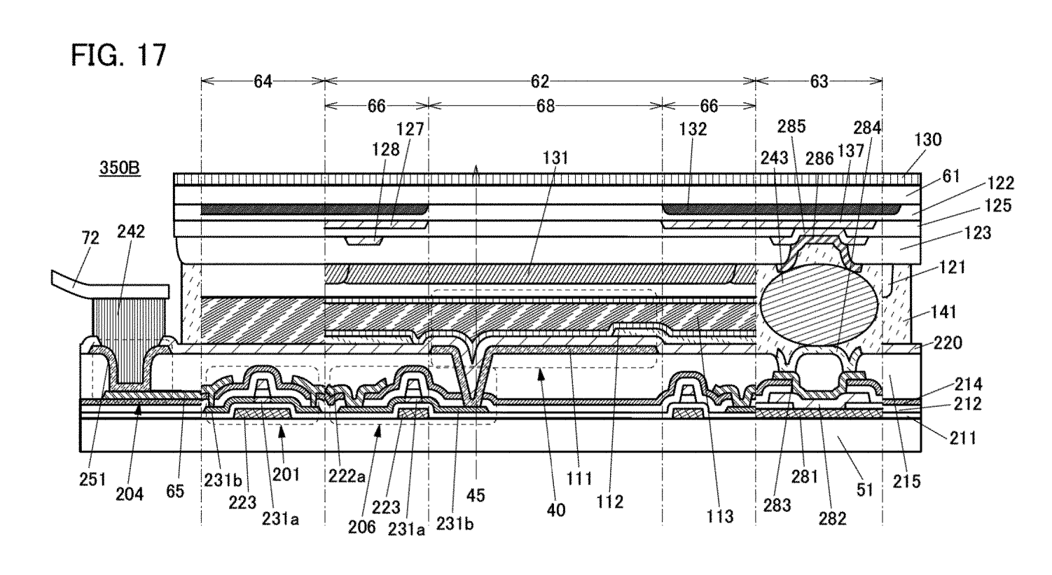

FIGS. 16A and 16B and FIG. 17 illustrate an example of the touch panel. FIG. 16A is a perspective view of a touch panel 350B. FIG. 16B is a developed view of the schematic perspective view of FIG. 16A. Note that for simplicity, FIGS. 16A and 16B illustrate only the major components. In FIG. 16B, the outline of the substrate 61 is illustrated only in a dashed line. FIG. 17 is a cross-sectional view of the touch panel 350B.

The touch panel 350B is an in-cell touch panel that has a function of displaying an image and serves as a touch sensor.

The touch panel 350B has a structure in which electrodes constituting a sensor element and the like are provided only on the counter substrate. Such a structure can make the touch panel thinner and more lightweight or reduce the number of components within the touch panel, compared with a structure in which the display device and the sensor element are fabricated separately and then are bonded together.

In FIGS. 16A and 16B, an input device 376 is provided on the substrate 61. The wirings 137 and 138 and the like of the input device 376 are electrically connected to the FPC 72 included in a display device 379.

With the above structure, the FPCs connected to the touch panel 350B can be provided only on one substrate side (on the substrate 51 side in this embodiment). Although two or more FPCs may be attached to the touch panel 350B, it is preferable that the touch panel 350B be provided with one FPC 72 which has a function of supplying signals to both the display device 379 and the input device 376 as illustrated in FIGS. 16A and 16B, for the simplicity of the structure. The touch panel 350B can easily be incorporated into an electronic device and allows a reduction in the number of components compared with the case where FPCs are connected to both the substrate 51 and the substrate 61.

The IC 73 may include a function of driving the input device 376. Another IC that drives the input device 376 may be provided over the FPC 72. Alternatively, an IC that drives the input device 376 may be mounted on the substrate 51.

FIG. 17 is a cross-sectional view including a region that includes the FPC 72, a connection portion 63, the driver circuit portion 64, and the display portion 62, each of which is illustrated in FIG. 16A.

In the connection portion 63, one of the wirings 137 (or the wirings 138) and one of the conductive layers provided on the substrate 51 side are electrically connected through the connector 243.

As the connector 243, a conductive particle can be used, for example. A particle of an organic resin, silica, or the like coated with a metal material can be used as the conductive particle. Nickel or gold is preferably used as the metal material because contact resistance can be decreased. A use of a particle coated with layers of two or more kinds of metal materials, such as a particle coated with nickel and further with gold, is also preferable. A material capable of elastic deformation or plastic deformation is preferably used as the connector 243. As illustrated in FIG. 17 and the like, the conductive particle has a shape that is vertically crushed in some cases. With the crushed shape, the contact area between the connector 243 and a conductive layer electrically connected to the connector 243 can be increased, thereby reducing contact resistance and reducing issues such as disconnection.

The connector 243 is preferably provided so as to be covered with the adhesive layer 141. For example, the connector 243 may be dispersed within the adhesive layer 141 before the curing thereof.

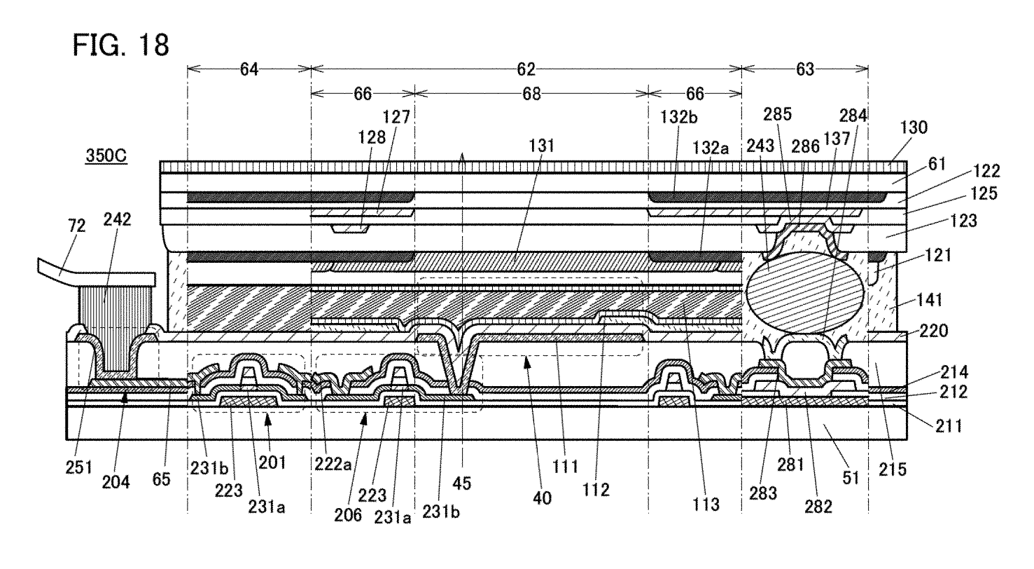

The light-blocking layer 132 is provided in contact with the substrate 61, thereby preventing the conductive layers used in the touch sensor from being seen by a user. The light-blocking layer 132 is covered by an insulating layer 122. The electrode 127 is provided between the insulating layer 122 and the insulating layer 125. The electrode 128 is provided between the insulating layer 125 and the insulating layer 123. The electrodes 127 and 128 can be formed using a metal or an alloy. The coloring layer 131 is provided in contact with the insulating layer 123. Note that as in a touch panel 350C illustrated in FIG. 18, a light-blocking layer 132a may be provided in contact with the insulating layer 123 in addition to a light-blocking layer 132b that is in contact with the substrate 61.

The wiring 137 that is obtained by processing the same conductive layer as the electrode 127 is connected to a conductive layer 285 that is obtained by processing the same conductive layer as the electrode 128. The conductive layer 285 is connected to the conductive layer 286. The conductive layer 286 is electrically connected to the conductive layer 284 through the connector 243. Note that the conductive layer 286 does not need to be provided; in that case, the conductive layer 285 is connected to the connector 243.

The touch panel 350B is supplied with a signal for driving a pixel and a signal for driving a sensor element from one FPC. Thus, the touch panel 350B can easily be incorporated into an electronic device and allows a reduction in the number of components.

### 6. Structure Example 5 of Display Device

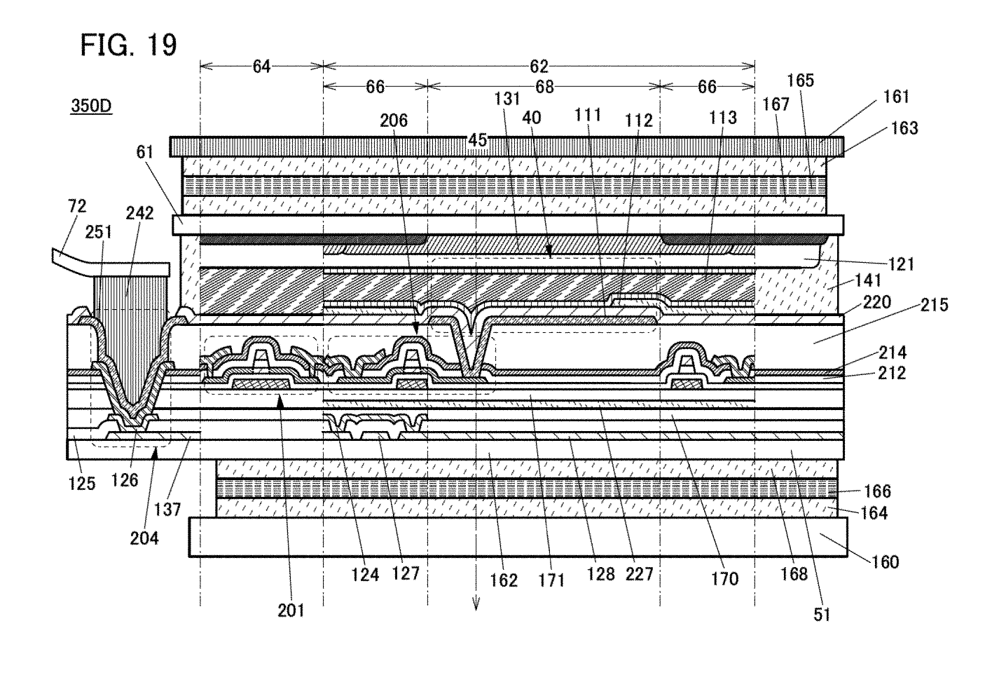

FIG. 19 is a cross-sectional view of a touch panel 350D. In the touch panel 350D, an input device is provided over the substrate 51.

The touch panel 350D has a structure in which electrodes constituting a sensor element and the like are provided only on a substrate on which transistors and the like are formed. Such a structure can make the touch panel thinner and more lightweight or reduce the number of components within the touch panel, compared with a structure in which the display device and the sensor element are fabricated separately and then are bonded together. In addition, the number of components provided on the substrate 61 side can be reduced.

A signal for driving the liquid crystal element 40 and a signal for driving the sensor element can both be supplied through one or more FPCs connected to the substrate 51 side.

First, components formed over the substrate 51 will be described.

The electrode 127, the electrode 128, and the wiring 137 are provided over the substrate 51. The insulating layer 125 is provided over the electrode 127, the electrode 128, and the wiring 137. The electrode 124 and the conductive layer 126 are provided over the insulating layer 125. The electrode 124 is electrically connected to two of the electrodes 128 that are provided on both sides of the electrode 127, through an opening provided in the insulating layer 125. The conductive layer 126 is electrically connected to the wiring 137 through an opening provided in the insulating layer 125. An insulating layer 170 is provided over the electrode 124 and the conductive layer 126. A conductive layer 227 is provided over the insulating layer 170. The conductive layer 227 is preferably provided in the entire display portion 62. A constant potential is supplied to the conductive layer 227. The conductive layer 227 can serve as a shield that blocks noise; as a result, the transistor and the sensor element can operate stably. An insulating layer 171 is provided over the conductive layer 227.

In the conductive layers included in the input device, the conductive layers (e.g., the electrodes 127 and 128) that overlap with the display region 68 are formed using a material that transmits visible light. Note that the conductive layers in the input device may be arranged only in the non-display region 66 as in FIG. 17, FIG. 18, and the like. When the conductive layer in the input device does not overlap with the display region 68, the conductive layer does not need to be formed with a material that transmits visible light. A material with a low resistivity such as a metal can be used for the conductive layer included in the input device. For example, the wiring and the electrode of the touch sensor are preferably formed with a metal mesh, thereby having a lower resistance. In that case, the touch sensor is suitably used in a large-sized display device. Note that a metal, which is generally a material having a high reflectivity, can be darkened by being subjected to oxidation treatment or the like. Thus, even when the display device is seen from the display surface side, a decrease in visibility due to the reflection of external light can be suppressed.

The wiring and the electrode can be formed with a stack of a metal layer and a layer with a low reflectivity (the layer is also referred to as a dark-colored layer). Examples of the dark-colored layer include a layer containing copper oxide, and a layer containing copper chloride or tellurium chloride. Alternatively, the dark-colored layer may be formed with a metal particle such as an Ag particle, an Ag fiber, or a Cu particle, a carbon nanoparticle such as a carbon nanotube (CNT) or graphene, a conductive high molecule such as PEDOT, polyaniline, or polypyrrole, or the like.

The conductive layer 126 is electrically connected to the FPC 72 through a plurality of conductive layers and the connector 242. The plurality of conductive layers include the conductive layer 251, a conductive layer that is formed with the same material and the same process as those used in the conductive layer in the transistor, and the like.

The components provided over the insulating layer 171 are similar to the components provided over the substrate 51 in the display device 100A illustrated in FIG. 3.

The touch panel 350D is manufactured in the following manner, for example. A manufacturing method of the touch panel 350D includes a step of forming a touch sensor over the substrate 51, a step of forming the transistor 206, a first conductive layer, a second conductive layer, and the like over the touch sensor, and a step of forming the liquid crystal element 40 electrically connected to the transistor 206.

The touch sensor is formed in the following manner: first, the electrode 127, the electrode 128, and the wiring 137 are formed over the substrate 51; the insulating layer 125 is formed over the electrode 127, the electrode 128, and the wiring 137, an opening that reaches the electrode 128 and an opening that reaches the wiring 137 are formed in the insulating layer 125; and the electrode 124, which is in contact with the electrode 128 through the opening provided in the insulating layer 125, and the conductive layer 126, which is in contact with the wiring 137 through the opening provided in the insulating layer 125, are formed. The first conductive layer is formed so as to be electrically connected to the touch sensor. Specifically, the first conductive layer is electrically connected to the electrode 127 or the electrode 128 through the wiring 137 and the conductive layer 126. The second conductive layer is formed so as to be electrically connected to the transistor 206. Each of the first conductive layer and the second conductive layer is formed with the same material and the same process as those used in one or more of the conductive layers included in the transistor 206.

The polarizer 165 is bonded to the substrate 61 with the adhesive layer 167. The backlight 161 is bonded to the polarizer 165 with the adhesive layer 163.

The polarizer 166 is bonded to the substrate 51 with the adhesive layer 168. The protection substrate 160 is bonded to the polarizer 166 with the adhesive layer 164.

Light from the backlight 161 passes through the substrate 61, the coloring layer 131, and the liquid crystal element 40, and then enters a contact area between the transistor and the pixel electrode. In one embodiment of the present invention, the contact area between the transistor and the pixel electrode transmits visible light; hence, the contact area can be provided in the display region 68. The light that has passed through the contact area passes through the substrate 51 and the like, and is emitted to the outside of the touch panel 350D.

### 7. Structure Example of Touch Sensor

A structure example of the input device (touch sensor) will be described below. The input device can be applied to each of the touch panels exemplified in this embodiment.

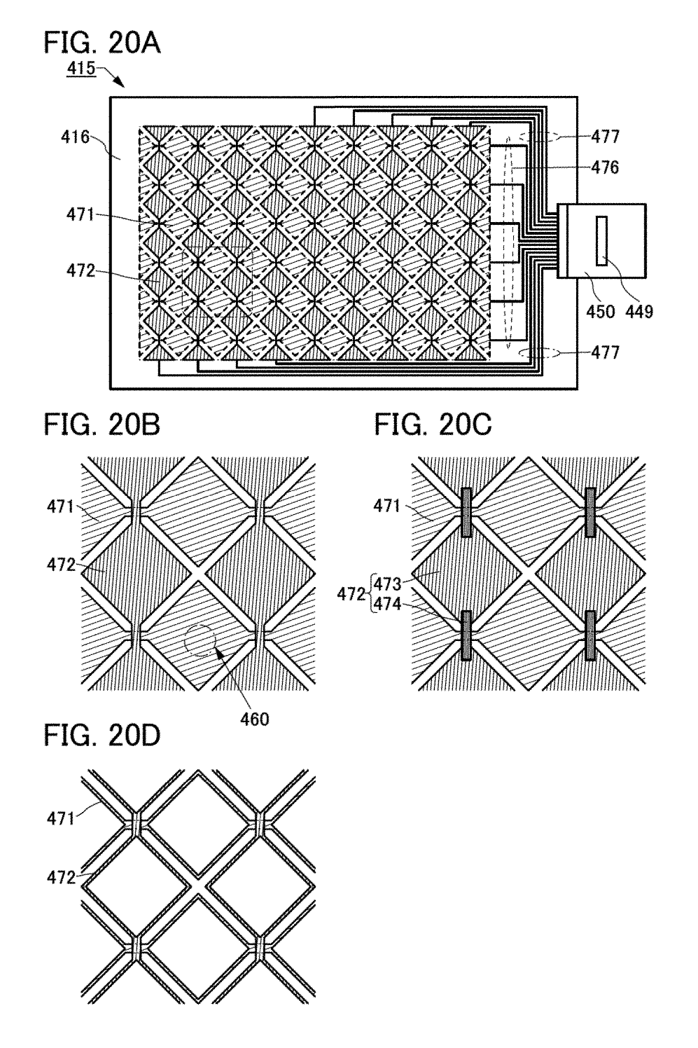

FIG. 20A is a top view of an input device 415. The input device 415 includes a plurality of electrodes 471, a plurality of electrodes 472, a plurality of wirings 476, and a plurality of wirings 477 over a substrate 416. The substrate 416 is provided with an FPC 450 that is electrically connected to each of a plurality of wirings 476 and a plurality of wirings 477. FIG. 20A illustrates an example in which an IC 449 is provided on the FPC 450.

FIG. 20B is an enlarged view of a region surrounded by a dashed-dotted line in FIG. 20A. The electrodes 471 are in the form of a row of rhombic electrode patterns arranged in a lateral direction. The row of rhombic electrode patterns are electrically connected to each other. The electrodes 472 are also in the form of a row of rhombic electrode patterns arranged in a longitudinal direction, and the row of rhombic electrode patterns are electrically connected to each other. Part of the electrodes 471 and part of the electrodes 472 overlap and intersect with each other. At this intersection portion, an insulator is sandwiched between the electrodes 471 and the electrodes 472 in order to avoid an electrical short-circuit therebetween.

As illustrated in FIG. 20C, the electrodes 472 may include a plurality of island-shaped rhombic electrodes 473 and bridge electrodes 474. The island-shaped rhombic electrodes 473 are arranged in the longitudinal direction, and two adjacent electrodes 473 are electrically connected to each other by the bridge electrode 474. With such a structure, the electrodes 473 and the electrodes 471 can be formed at the same time by processing the same conductive film. This can prevent variations in the thickness of these electrodes, and can prevent the resistance value and the light transmittance of each electrode from varying from place to place. Note that although the electrodes 472 include the bridge electrodes 474 here, the electrodes 471 may have such a structure.

As illustrated in FIG. 20D, a design in which rhombic electrode patterns of the electrodes 471 and 472 illustrated in FIG. 20B are hollowed out and only edge portions are left may be used. In that case, when the electrodes 471 and 472 are narrow enough to be invisible to the users, the electrodes 471 and 472 can be formed using a light-blocking material such as a metal or an alloy, as will be described later. In addition, either the electrodes 471 or the electrodes 472 illustrated in FIG. 20D may include the above bridge electrodes 474.

One of the electrodes 471 is electrically connected to one of the wirings 476. One of the electrodes 472 is electrically connected to one of the wirings 477. Here, either one of the electrodes 471 and 472 corresponds to a row wiring, and the other corresponds to a column wiring.

The IC 449 has a function of driving the touch sensor. A signal output from the IC 449 is supplied to either of the electrodes 471 and 472 through the wirings 476 or 477. A current (or a potential) flowing to either of the electrodes 471 and 472 is input to the IC 449 through the wirings 476 or 477. The IC 449 is mounted on the FPC 450 in this example; alternatively, the IC 449 may be mounted on the substrate 416.

When the input device 415 overlaps with a display screen of the display panel, a light-transmitting conductive material is preferably used for the electrodes 471 and 472. In the case where a light-transmitting conductive material is used for the electrodes 471 and 472 and light from the display panel is extracted through the electrodes 471 or 472, it is preferable that a conductive film containing the same conductive material be arranged between the electrodes 471 and 472 as a dummy pattern. Part of a space between the electrodes 471 and 472 is filled with the dummy pattern, which can reduce variations in light transmittance. As a result, unevenness in luminance of light passing through the input device 415 can be reduced.

As the light-transmitting conductive material, a conductive oxide such as indium oxide, indium tin oxide, indium zinc oxide, zinc oxide, or zinc oxide containing gallium can be used. Note that a film containing graphene may be used as well.

Alternatively, a metal film or an alloy film that is thin enough to have a light-transmitting property can be used. For example, a metal such as gold, silver, platinum, magnesium, nickel, tungsten, chromium, molybdenum, iron, cobalt, copper, palladium, or titanium, or an alloy containing any of these metals can be used. Alternatively, a nitride of the metal or the alloy (e.g., titanium nitride) or the like may be used. Alternatively, a layered film in which two or more of conductive films containing the above materials are stacked may be used.

For the electrodes 471 and 472, a conductive film that is processed to be thin enough to be invisible to the users may be used. Such a conductive film is processed into a lattice shape (a mesh shape), for example, which makes it possible to achieve both high conductivity and high visibility of the display device. It is preferable that the conductive film have a portion with a width greater than or equal to 30 nm and less than or equal to 100 μm, preferably greater than or equal to 50 nm and less than or equal to 50 μm, and further preferably greater than or equal to 50 nm and less than or equal to 20 μm. In particular, the conductive film preferably has a pattern width of 10 μm or less, which is hardly visible to the users.

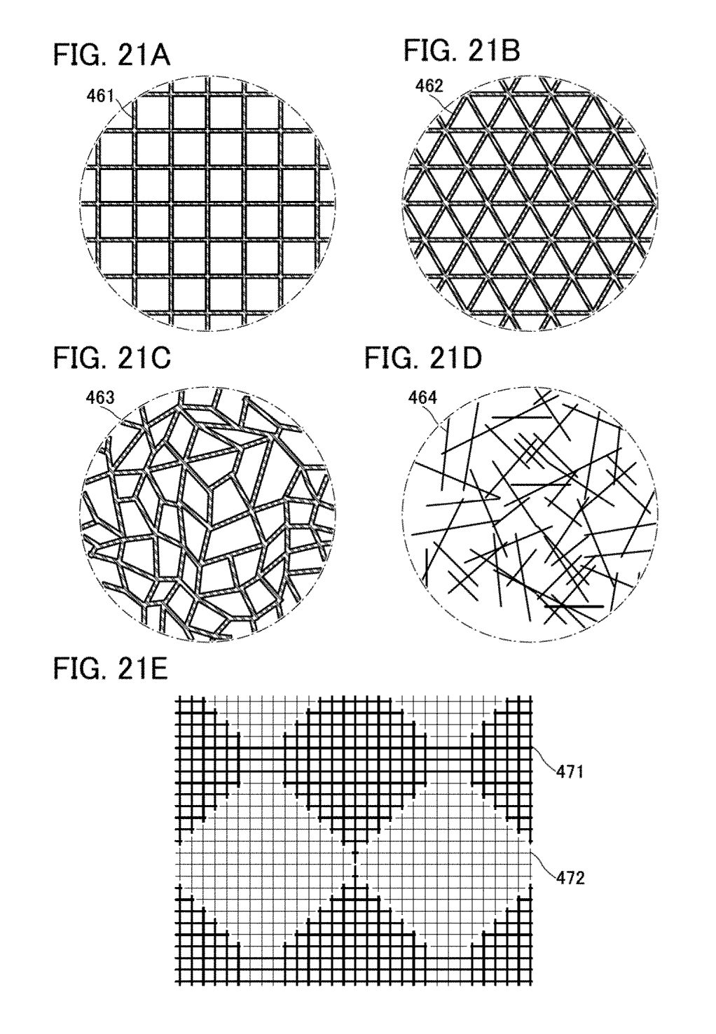

As examples, enlarged schematic views of a region 460 in FIG. 20B are illustrated in FIGS. 21A to 21D.

FIG. 21A illustrates an example where a lattice-shape conductive film 461 is used. The conductive film 461 is preferably placed so as not to overlap with the display element included in the display device because light from the display element is not blocked. In that case, it is preferable that the direction of the lattice be the same as the direction of the display element arrangement and that the pitch of the lattice be an integer multiple of the pitch of the display element arrangement.

FIG. 21B illustrates an example of a lattice-shape conductive film 462, which is processed so as to be provided with triangle openings. Such a structure makes it possible to further reduce the resistance compared with the structure illustrated in FIG. 21A.

Alternatively, a conductive film 463, which has an irregular pattern shape, may be used as illustrated in FIG. 21C. Such a structure can prevent generation of moire when overlapping with the display portion of the display device.

Conductive nanowires may be used for the electrodes 471 and 472. FIG. 21D illustrates an example of using nanowires 464. The nanowires 464 are dispersed at appropriate density so as to be in contact with the adjacent nanowires, which can form a two-dimensional network; the nanowires 464 can function as a conductive film with an extremely high light-transmitting property. For example, nanowires that have a mean diameter of greater than or equal to 1 nm and less than or equal to 100 nm, preferably greater than or equal to 5 nm and less than or equal to 50 nm, and further preferably greater than or equal to 5 nm and less than or equal to 25 nm, can be used. As the nanowire 464, a metal nanowire such as an Ag nanowire, a Cu nanowire, or an Al nanowire, a carbon nanotube, or the like can be used. In the case of using an Ag nanowire, a light transmittance of 89% or more and a sheet resistance of 40 ohms per square or more and 100 ohms per square or less can be achieved.

FIG. 21E illustrates a more specific structure example of the electrodes 471 and 472 in FIG. 20B. FIG. 21E shows an example in which a lattice-shape conductive film is used for each of the electrodes 471 and 472.

Although examples in which a plurality of rhombuses are aligned in one direction are shown in FIG. 20A and the like as top-surface shapes of the electrodes 471 and 472, the shapes of the electrodes 471 and 472 are not limited thereto and can have various top-surface shapes such as a belt shape (a rectangular shape), a belt shape having a curve, and a zigzag shape. In addition, although the electrodes 471 and 472 are arranged to be perpendicular to each other in the above, they are not necessarily arranged to be perpendicular and the angle formed by two of the electrodes may be less than 90°.

### 8. Structure Example 6 of Display Device

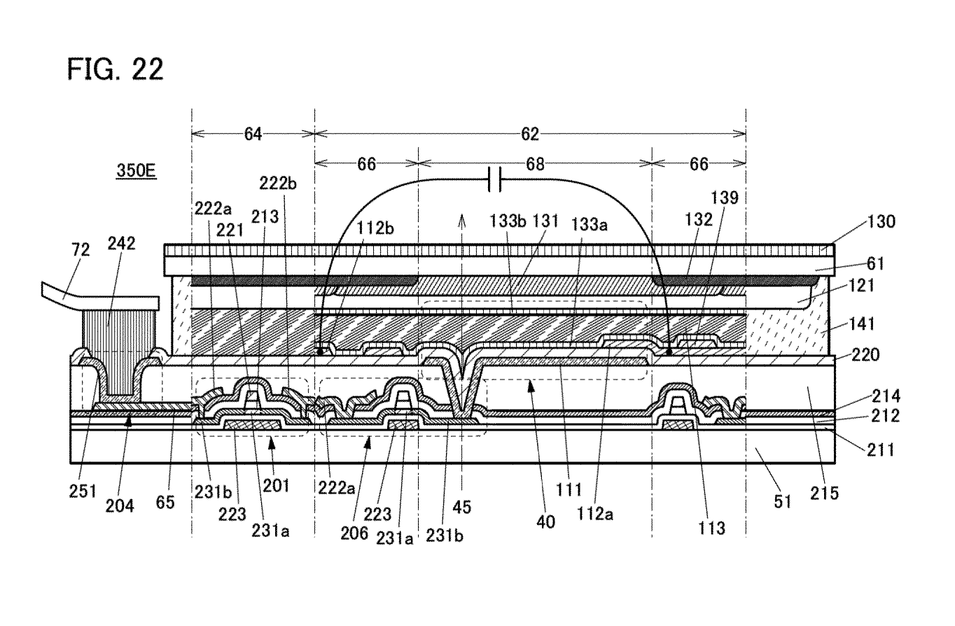

FIG. 22 illustrates an example of the touch panel. FIG. 22 is a cross-sectional view of a touch panel 350E.

The touch panel 350E is an in-cell touch panel that has a function of displaying an image and serves as a touch sensor.

The touch panel 350E has a structure in which electrodes constituting a sensor element and the like are provided only on a substrate that supports a display element. Such a structure can make the touch panel thinner and more lightweight or reduce the number of components within the touch panel, compared with a structure in which the display device and the sensor element are fabricated separately and then are bonded together, or a structure in which the sensor element is fabricated on a counter substrate side.

The touch panel 350E illustrated in FIG. 22 is different from the display device 100A described above in the layout of the common electrode and in including an auxiliary wiring 139.

A plurality of auxiliary wirings 139 are electrically connected to a common electrode 112a or a common electrode 112b.

The resistivity of the auxiliary wiring 139 is preferably lower than that of the common electrodes 112a and 112b. By providing an auxiliary wiring that is electrically connected to the common electrode, a drop in voltage due to the resistance of the common electrode can be inhibited. In addition, when a layered structure of a conductive layer including a metal oxide and a conductive layer including a metal is used, these conductive layers are formed preferably by a patterning technique using a half tone mask, thereby simplifying the fabrication process.

The auxiliary wiring 139 is a film with lower resistance than the common electrodes 112a and 112b. For example, the auxiliary wiring 139 can be formed to have a single-layer structure or a layered structure using any of metal materials such as molybdenum, titanium, chromium, tantalum, tungsten, aluminum, copper, silver, neodymium, and scandium, and an alloy material containing any of these elements.

The auxiliary wiring 139 is preferably provided in a position that overlaps with the light-blocking layer 132 and the like, so that the auxiliary wiring 139 is not seen by the user of the display device.

The touch panel 350E illustrated in FIG. 22 is capable of sensing an approach, a contact, or the like of an object utilizing the capacitance formed between the common electrode 112a and the common electrode 112b. That is, in the touch panel 350E, the common electrodes 112a and 112b serve as both the common electrode of the liquid crystal element and the electrode of the sensor element.

As described above, an electrode of the liquid crystal element also serves as an electrode of the sensor element in the touch panel of one embodiment of the present invention; thus, the manufacturing process can be simplified and the manufacturing cost can be reduced. Furthermore, the touch panel can be made thin and lightweight.

The common electrode is electrically connected to the auxiliary wiring 139. By providing the auxiliary wiring 139, the resistance of the electrodes of the sensor element can be reduced. As the resistance of the electrodes of the sensor element is reduced, the time constant of the electrode of the sensor element can be made small. When the time constant of the electrode of the sensor element is smaller, the detection sensitivity can be increased, which enables an increase in detection accuracy.

For example, the time constant of the electrode of the sensor element is greater than 0 seconds and less than or equal to 1×10⁻⁴ seconds, preferably greater than 0 seconds and less than or equal to 5×10⁻⁶ seconds, further preferably greater than 0 seconds and less than or equal to 5×10⁻⁶ seconds, further preferably greater than 0 seconds and less than or equal to 5×10⁻⁷ seconds, and further preferably greater than 0 seconds and less than or equal to 2×10⁻⁷ seconds. In particular, when the time constant is smaller than or equal to 1×10⁻⁶ seconds, high detection sensitivity can be achieved while the influence of noise is reduced.

The signal for driving a pixel and the signal for driving a sensor element are supplied to the touch panel 350E by one FPC. Thus, the touch panel 350E can easily be incorporated into an electronic device and allows a reduction in the number of components.

An example of the operation method of the touch panel 350E and the like will be described below.

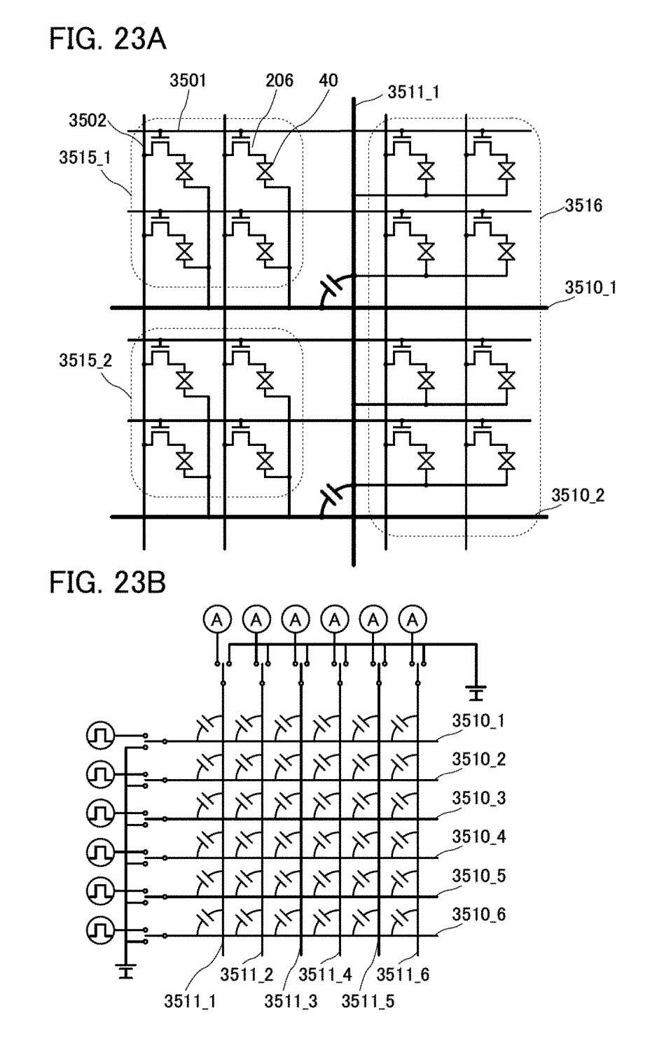

FIG. 23A is an equivalent circuit diagram of part of a pixel circuit provided in the display portion 62 of the touch panel 350E.

Each pixel (subpixel) includes at least the transistor 206 and the liquid crystal element 40. The gate of the transistor 206 is electrically connected to a wiring 3501. One of the source and the drain of the transistor 206 is electrically connected to a wiring 3502.

The pixel circuit includes a plurality of wirings extending in the X direction (e.g., a wiring 3510_1 and a wiring 3510_2) and a plurality of wirings extending in the Y direction (e.g., a wiring 3511_1). They are provided to intersect with each other, and capacitance is formed therebetween.

Among the pixels provided in the pixel circuit, electrodes of the liquid crystal elements in some pixels adjacent to each other are electrically connected to each other to form one block. The block is classified into two types: an island-shaped block (e.g., a block 3515_1 or a block 3515_2), and a linear block extending in the X direction or the Y direction (e.g., a block 3516 extending in the Y direction). Note that only part of the pixel circuit is illustrated in FIG. 23A, and in reality, these two types of blocks are repeatedly arranged in the X direction and the Y direction. An electrode on one side of the liquid crystal element is, for example, a common electrode. An electrode on the other side of the liquid crystal element is, for example, a pixel electrode.

The wiring 3510_1 (or the wiring 3510_2) extending in the X direction is electrically connected to the island-shaped block 3515_1 (or the block 3515_2). Although not illustrated, the wiring 3510_1 extending in the X direction is electrically connected to a plurality of island-shaped blocks 3515_1 which are provided discontinuously along the X direction with the linear blocks therebetween. Furthermore, the wiring 3511_1 extending in the Y direction is electrically connected to the linear block 3516.

FIG. 23B is an equivalent circuit diagram illustrating the connection relation between a plurality of wirings extending in the X direction (the wirings 3510_1 to 3510_6, which are collectively called a wiring 3510 in some cases) and a plurality of wirings extending in the Y direction (wirings 3511_1 to 3511_6, which are collectively called a wiring 3511 in some cases). A common potential can be input to each of the wirings 3510 extending in the X direction and each of the wirings 3511 extending in the Y direction. A pulse voltage can be input to each of the wirings 3510 extending in the X direction from a pulse voltage output circuit. Furthermore, each of the wirings 3511 extending in the Y direction can be electrically connected to a detection circuit. Note that the wiring 3510 and the wiring 3511 can be interchanged with each other.

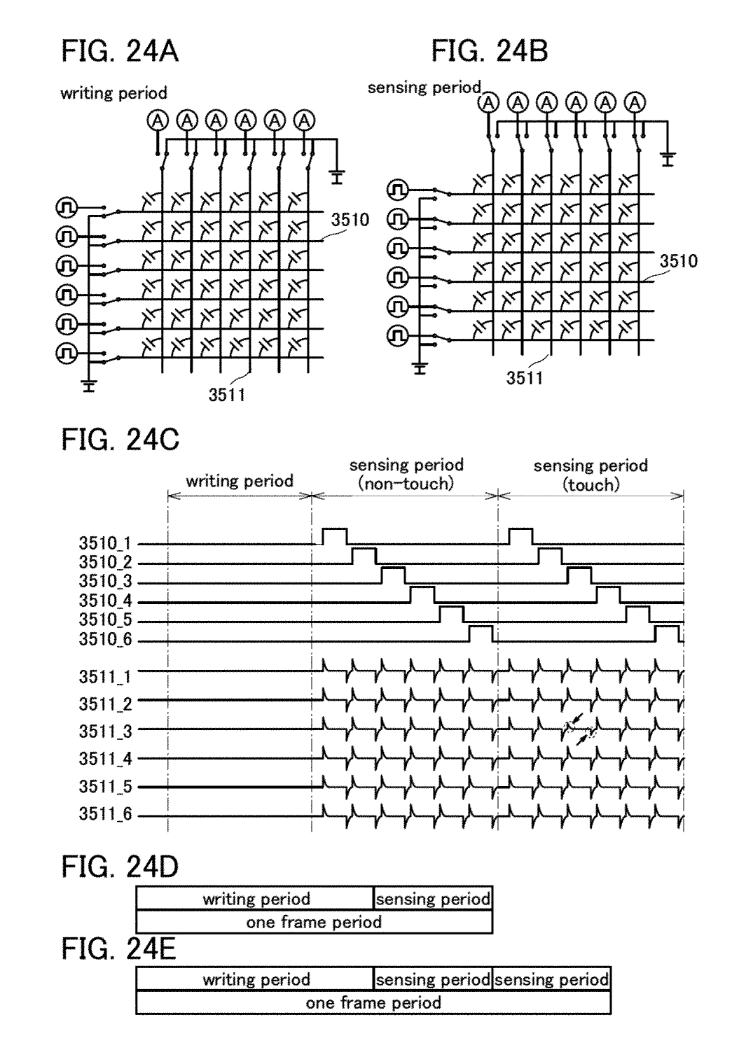

An example of an operation method of the touch panel 350E is described with reference to FIGS. 24A and 24B.

Here, one frame period is divided into a writing period and a sensing period. The writing period is a period in which image data is written to a pixel, and the wirings 3501 (also referred to as gate lines or scan lines) are sequentially selected. The sensing period is a period in which sensing is performed by the sensor element.

FIG. 24A is an equivalent circuit diagram in the writing period. In the wiring period, a common potential is input to both the wiring 3510 extending in the X direction and the wiring 3511 extending in the Y direction.

FIG. 24B is an equivalent circuit diagram in the sensing period. In the sensing period, each of the wirings 3511 extending in the Y direction is electrically connected to the detection circuit. Furthermore, a pulse voltage is input to the wirings 3510 extending in the X direction from a pulse voltage output circuit.

FIG. 24C illustrates an example of a timing chart of the input and output waveforms of a mutual capacitive sensor element.

In FIG. 24C, sensing of an object is performed in all rows and columns in one frame period. FIG. 24C shows two cases in the sensing period: a case in which an object is not sensed (not touched) and a case in which an object is sensed (touched).

A pulse voltage is supplied to the wirings 3510_1 to 3510_6 from the pulse voltage output circuit. When the pulse voltage is applied to the wirings 3510_1 to 3510_6, an electric field is generated between a pair of electrodes forming a capacitor, and current flows in the capacitor. The electric field generated between the electrodes is changed by being blocked by the touch of a finger or a stylus, for example. That is, the capacitance value of the capacitor is changed by touch or the like. By utilizing this, an approach or a contact of an object can be sensed.

The wirings 3511_1 to 3511_6 are connected to the detection circuit for detecting the change in current in the wirings 3511_1 to 3511_6 caused by the change in the capacitance value of the capacitor. The current value detected in the wirings 3511_1 to 3511_6 is not changed when there is no approach or contact of an object, and is decreased when the capacitance value is decreased because of the approach or contact of an object. In order to detect a change in current, the total amount of current may be detected. In that case, an integrator circuit or the like may be used to detect the total amount of current. Alternatively, the peak current value may be detected. In that case, current may be converted into voltage, and the peak voltage value may be detected.

Note that in FIG. 24C, the waveforms of the wirings 3511_1 to 3511_6 show voltage values corresponding to the detected current values. As illustrated in FIG. 24C, the timing of the display operation is preferably in synchronization with the timing of the sensing operation.

The waveforms of the wirings 3511_1 to 3511_6 change in accordance with pulse voltages applied to the wirings 3510_1 to 3510_6. When there is no approach or contact of an object, the waveforms of the wirings 3511_1 to 3511_6 uniformly change in accordance with changes in the voltages of the wirings 3510_1 to 3510_6. On the other hand, the current value decreases at the point of approach or contact of an object and accordingly the waveform of the voltage value changes.

By detecting a change in capacitance in this manner, the approach or contact of an object can be detected. Even when an object such as a finger or a stylus does not touch but only approaches a touch panel, a signal may be detected in some cases.

Note that FIG. 24C illustrates an example in which a common potential supplied in the writing period is equal to a low potential supplied in the sensing period in the wiring 3510; however, one embodiment of the present invention is not limited thereto. The common potential may be different from the low potential.

It is preferable that, as an example, the pulse voltage output circuit and the detection circuit be formed in one IC. For example, the IC is preferably mounted on a touch panel or a substrate in a housing of an electronic device. In the case where the touch panel has flexibility, parasitic capacitance can potentially be increased in a bent portion of the touch panel, and the influence of noise can potentially be increased. In view of this, an IC with a driving method less influenced by noise is preferably used. For example, it is preferable to use an IC to which a driving method capable of increasing a signal-noise ratio (S/N ratio) is applied.

It is preferable that a period in which an image is written and a period in which sensing is performed by a sensor element be separately provided as described above. Thus, a decrease in the sensitivity of the sensor element caused by noise generated when an image is written can be prevented.

In one embodiment of the present invention, as illustrated in FIG. 24D, one frame period includes one writing period and one sensing period. Alternatively, as shown in FIG. 24E, two sensing periods may be included in one frame period. When a plurality of detection periods are included in one frame period, the detection sensitivity can be further increased. For example, two to four sensing periods may be included in one frame period.

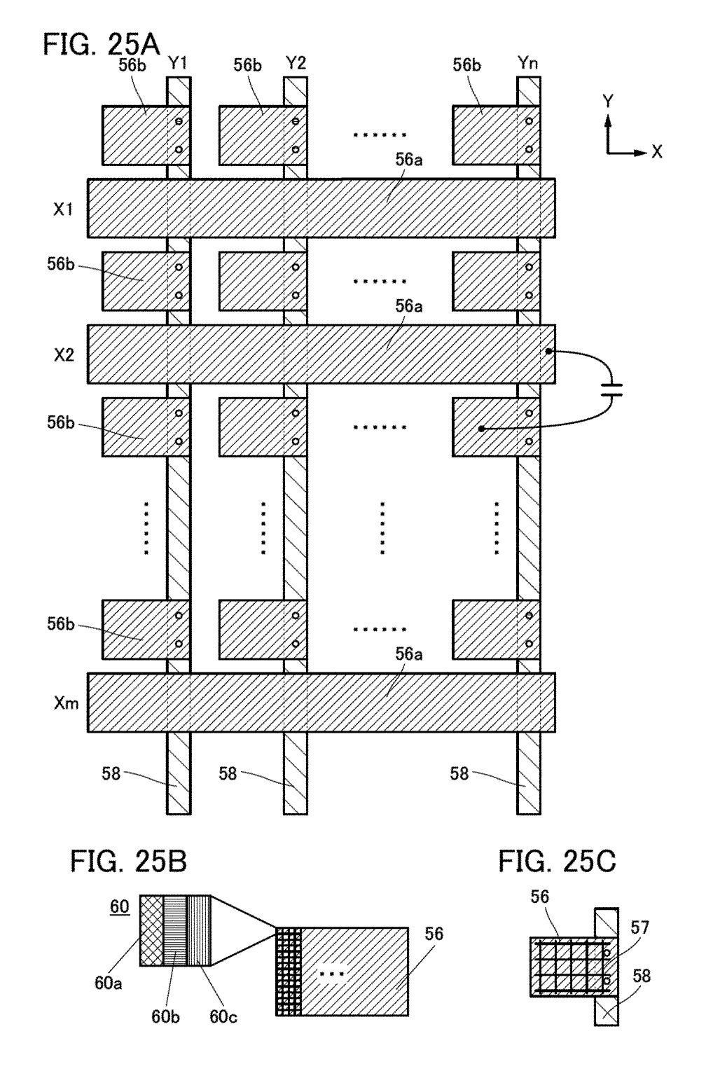

Next, a structure example of the top surface of the sensor element included in the touch panel 350E will be described with reference to FIGS. 25A to 25C.

FIG. 25A shows a top view of the sensor element. The sensor element includes a conductive layer 56a and a conductive layer 56b. The conductive layer 56a serves as one electrode of the sensor element, and the conductive layer 56b serves as the other electrode of the sensor element. The sensor element can sense an approach, a contact, or the like of an object utilizing the capacitance that is formed between the conductive layers 56a and 56b. Although not illustrated, the conductive layers 56a and 56b may have a top-surface shape that has a comb-like shape or that is provided with a slit.

In one embodiment of the present invention, the conductive layers 56a and 56b also serve as the common electrode of the liquid crystal element.

A plurality of conductive layers 56a are provided in the Y direction and extend in the X direction. A plurality of conductive layers 56b provided in the Y direction are electrically connected to each other via a conductive layer 58 extending in the Y direction. FIG. 25A illustrates an example in which m conductive layers 56a and n conductive layers 58 are provided.

Note that the plurality of conductive layers 56a may be provided in the X direction and in that case, may extend in the Y direction. The plurality of conductive layers 56b provided in the X direction may be electrically connected to each other via the conductive layer 58 extending in the X direction.

As illustrated in FIG. 25B, a conductive layer 56 serving as an electrode of the sensor element is provided over a plurality of pixels 60. The conductive layer 56 corresponds to each of the conductive layers 56a and 56b in FIG. 25A. The pixel 60 is formed of a plurality of subpixels exhibiting different colors. FIG. 25B shows an example in which the pixel 60 is formed of three subpixels 60a, 60b, and 60c.

A pair of electrodes of the sensor element is preferably electrically connected to respective auxiliary wirings. The conductive layer 56 may be electrically connected to an auxiliary wiring 57 as illustrated in FIG. 25C. Note that FIG. 25C illustrates an example in which the auxiliary wirings are stacked over the conductive layers; however, the conductive layers may be stacked over the auxiliary wirings. The plurality of conductive layers 56 provided in the X direction may be electrically connected to the conductive layer 58 through the auxiliary wiring 57.

The resistivity of the conductive layer that transmits visible light is relatively high in some cases. Thus, the resistance of the pair of electrodes of the sensor element is preferably lowered by electrically connecting the pair of electrodes of the sensor element to the auxiliary wiring.

When the resistance of the pair of electrodes of the sensor element is lowered, the time constant of the pair of electrodes can be small. Accordingly, the detection sensitivity of the sensor element can be increased; furthermore, the detection accuracy of the sensor element can be increased.

The display device in this embodiment includes the region where the transistor transmits visible light, allowing an increase in the aperture ratio of the pixel. Thus, the power consumption of the display device can be reduced.

This embodiment can be combined with any of the other embodiments as appropriate. In the case where a plurality of structure examples are described in one embodiment in this specification, some of the structure examples can be combined as appropriate.

### Embodiment 2

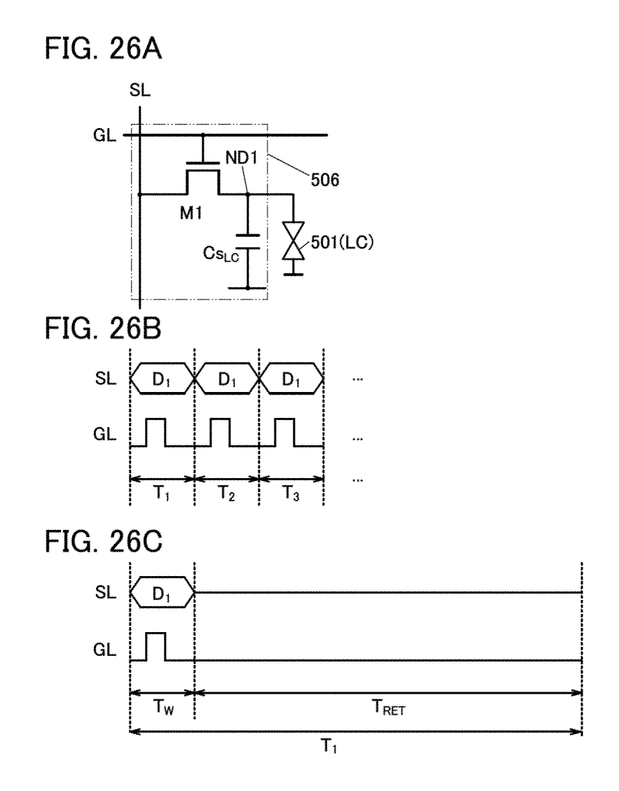

In this embodiment, an operation mode that can be employed in the display device of one embodiment of the present invention will be described with reference to FIGS. 26A to 26C.

A normal driving mode (Normal mode) with a normal frame frequency (typically, higher than or equal to 60 Hz and lower than or equal to 240 Hz) and an idling stop (IDS) driving mode with a low frame frequency are described below.

Note that the IDS driving mode refers to a driving method in which after image data is written, rewriting of image data is stopped. This increases the interval between writing of image data and subsequent writing of image data, thereby reducing the power that would be consumed by writing of image data in that interval. The IDS driving mode can be performed at a frame frequency which is 1/100 to 1/10 of the normal driving mode, for example. A still image is displayed by the same video signals in consecutive frames. Thus, the IDS driving mode is particularly effective when displaying a still image. When an image is displayed using IDS driving, power consumption is reduced, image flickering (flicker) is suppressed, and eyestrain can be reduced.

FIG. 26A is a pixel circuit diagram, and FIGS. 26B and 26C are timing charts showing a normal driving mode and an IDS driving mode. Note that in FIG. 26A, the first display element 501 (here, a reflective liquid crystal element) and a pixel circuit 506 electrically connected to the first display element 501 are illustrated. In the pixel circuit 506 illustrated in FIG. 26A, a signal line SL, a gate line GL, a transistor M1 connected to the signal line SL and the gate line GL, and a capacitor C_{SLC} connected to the transistor M1 are illustrated.

The transistor M1 may become a leakage path of data D₁. Accordingly, the off-state current of the transistor M1 is preferably as low as possible. A transistor including a metal oxide in a semiconductor layer in which a channel is formed is preferably used as the transistor M1. A metal oxide having at least one of an amplification function, a rectification function, and a switching function can be referred to as a metal oxide semiconductor or an oxide semiconductor (abbreviated to an OS). As a typical example of a transistor, a transistor including an oxide semiconductor in a semiconductor layer in which a channel is formed (an OS transistor) is described. The OS transistor has a feature of an extremely low leakage current (off-state current) in an off state compared with a transistor including polycrystalline silicon or the like. When the OS transistor is used as the transistor M1, electric charges supplied to a node ND1 can be held for a long period.

In the circuit diagram illustrated in FIG. 26A, the liquid crystal element LC becomes a leakage path of data D₁. Therefore, to perform IDS driving appropriately, the resistivity of the liquid crystal element LC is preferably higher than or equal to 1.0×10¹⁴ Ω·cm.

Note that for example, an oxide containing In, Ga, and Zn, an oxide containing In and Zn, or the like can be suitably used for a channel region of the above OS transistor. The oxide containing In, Ga, and Zn can typically have an atomic ratio of In:Ga:Zn=4:2:4.1 or a neighborhood thereof.

FIG. 26B is a timing chart showing the waveforms of signals supplied to the signal line SL and the gate line GL in the normal driving mode. In the normal driving mode, a normal frame frequency (e.g., 60 Hz) is used for operation. FIG. 26B shows periods T₁ to T₃. A scanning signal is supplied to the gate line GL in each frame period and data D₁ is written from the signal line SL to the node ND1. This operation is performed both to write the same data D₁ in the periods T₁ to T₃ and to write different data in the periods T₁ to T₃.

FIG. 26C is a timing chart showing the waveforms of signals supplied to the signal line SL and the gate line GL in the IDS driving mode. In the IDS driving, a low frame frequency (e.g., 1 Hz) is used for operation. One frame period is denoted by a period T₁ and includes a data writing period T_{W} and a data retention period T_{RET}. In the IDS driving mode, a scanning signal is supplied to the gate line GL and the Data D₁ of the signal line SL is written in the period T_{W}, the gate line GL is fixed to a low-level voltage in the period T_{RET}, and the transistor M1 is turned off so that the written Data D₁ is retained. Note that the low frame frequency may be higher than or equal to 0.1 Hz and lower than 60 Hz, for example.

This embodiment can be combined with any of the other embodiments as appropriate.

### Embodiment 3

In this embodiment, a driving method of a touch sensor will be described with reference to drawings.

### <Example of Sensing Method of Sensor>

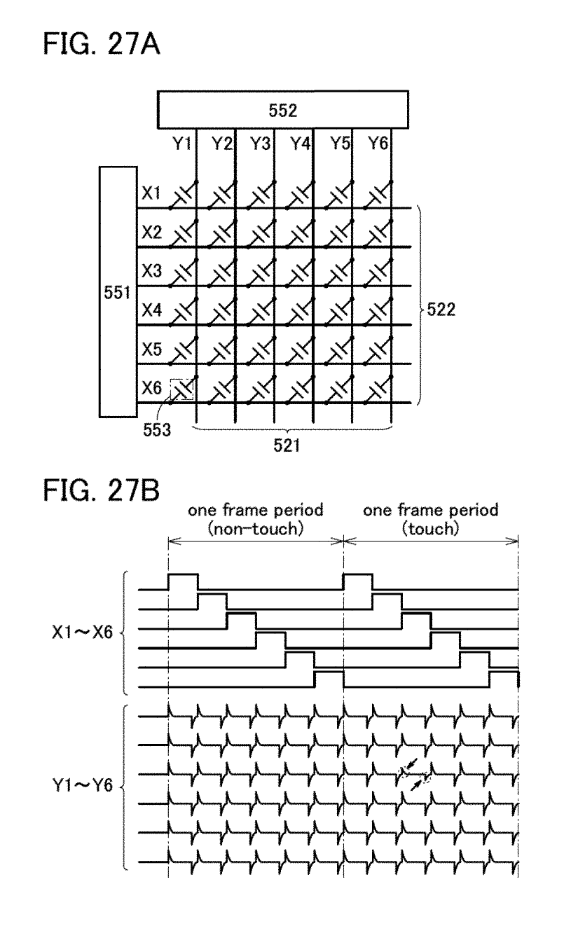

FIG. 27A is a block diagram illustrating the structure of a mutual capacitive touch sensor. FIG. 27A illustrates a pulse voltage output circuit 551 and a current sensing circuit 552. Note that in FIG. 27A, six wirings X1 to X6 represent electrodes 521 to which a pulse voltage is applied, and six wirings Y1 to Y6 represent electrodes 522 that sense changes in current. FIG. 27A also illustrates a capacitor 553 that is formed where the electrodes 521 and 522 overlap with each other. Note that functional replacement between the electrodes 521 and 522 is possible.

The pulse voltage output circuit 551 is a circuit for sequentially applying a pulse voltage to the wirings X1 to X6. By application of a pulse voltage to the wirings X1 to X6, an electric field is generated between the electrodes 521 and 522 of the capacitors 553. When the electric field between the electrodes is shielded, for example, a change occurs in the capacitor 553 (mutual capacitance). The approach or contact of a sensing target can be sensed by utilizing this change.

The current sensing circuit 552 is a circuit for detecting changes in current flowing through the wirings Y1 to Y6 that are caused by the change in mutual capacitance in the capacitor 553. No change in current value is detected in the wirings Y1 to Y6 when there is no approach or contact of a sensing target, whereas a decrease in current value is detected when mutual capacitance is decreased owing to the approach or contact of a sensing target. Note that an integrator circuit or the like is used for sensing of current.

Note that one or both of the pulse voltage output circuit 551 and the current sensing circuit 552 may be formed over the substrate 51 or the substrate 61 that is shown in FIG. 1 or the like. For example, it is preferable to form the display portion 62, the driver circuit portion 64, and the like at the same time because the process can be simplified and the number of components used for driving the touch sensor can be reduced. One or both of the pulse voltage output circuit 551 and the current sensing circuit 552 may be mounted on the IC 73.

In particular, in the case of using crystalline silicon such as polycrystalline silicon or single crystal silicon for the semiconductor layer where a channel is formed in the transistor over the substrate 51, the driving characteristics of the pulse voltage output circuit 551, the current sensing circuit 552, or the like are increased and the sensitivity of the touch sensor can be thus increased.

FIG. 27B is a timing chart showing input and output waveforms in the mutual capacitive touch sensor illustrated in FIG. 27A. In FIG. 27B, sensing of a sensing target is performed in all the rows and columns in one frame period. FIG. 27B shows a period when a sensing target is not sensed (not touched) and a period when a sensing target is sensed (touched). Sensed current values of the wirings Y1 to Y6 are shown as the waveforms of voltage values.

A pulse voltage is sequentially applied to the wirings X1 to X6, and the waveforms of the wirings Y1 to Y6 change in accordance with the pulse voltage. When there is no approach or contact of a sensing target, the waveforms of the wirings Y1 to Y6 change uniformly in accordance with changes in the voltages of the wirings X1 to X6. The current value is decreased at the point of approach or contact of a sensing target and accordingly the waveform of the voltage value changes.

By sensing a change in mutual capacitance in this manner, the approach or contact of a sensing target can be sensed.

### <Example of Driving Method of Display Device>

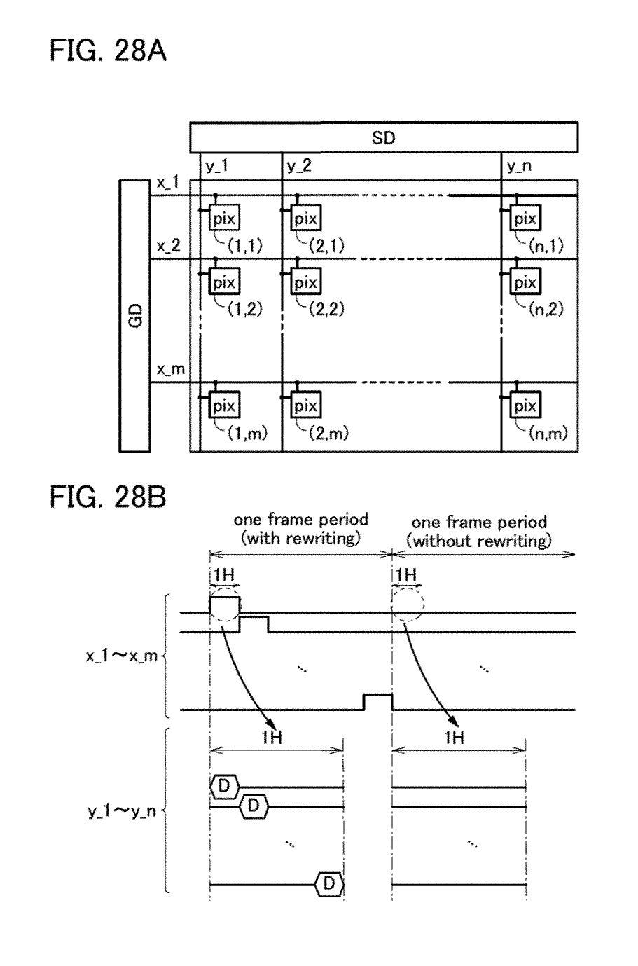

FIG. 28A is a block diagram illustrating a configuration example of a display device. FIG. 28A illustrates a gate driver circuit GD (a scan line driver circuit), a source driver circuit SD (a signal line driver circuit), and a display portion including a plurality of pixels pix. In FIG. 28A, gate lines x_1 to x_m (m is a natural number) electrically connected to the gate driver circuit GD and source lines y_1 to y_n (n is a natural number) electrically connected to the source driver circuit SD are shown. Corresponding to these lines, the pixels pix are denoted by (1, 1) to (n, m).

FIG. 28B is a timing chart of signals supplied to the gate lines and the source lines in the display device shown in FIG. 28A. The periods in FIG. 28B show the case where data signals are rewritten every frame period and the case where data signals are not rewritten. Note that periods such as a retrace period are not taken into consideration in FIG. 28B.

In the case where data signals are rewritten every frame period, scan signals are sequentially supplied to the gate lines x_1 to x_m. In a horizontal scanning period 1H, during which the scan signal is at an H level, data signals D are supplied to the source lines y_1 to y_n in the columns.

In the case where data signals are not rewritten every frame period, supply of scan signals to the gate lines x_1 to x_m is stopped. In the horizontal scanning period 1H, supply of data signals to the source lines y_1 to y_n in the columns is stopped.

A driving method in which data signals are not rewritten every frame period is effective particularly when an oxide semiconductor is used for the semiconductor layer where a channel is formed in the transistor included in the pixel pix. A transistor including an oxide semiconductor can have much lower off-state current than a transistor including a semiconductor such as silicon. Thus, a data signal written in the previous period can be held without rewriting data signals every frame period, and grayscale of pixels can be held for 1 second or longer, preferably 5 seconds or longer, for example.

In the case where polycrystalline silicon or the like is used for a semiconductor layer where a channel of a transistor included in the pixel pix is formed, the storage capacitance of the pixel is preferably increased in advance. The larger the storage capacitance is, the longer the grayscale of the pixel can be held. The storage capacitance may be determined depending on leakage current of a transistor or a display element which is electrically connected to the storage capacitor. For example, the storage capacitance per pixel is set to 5 fF to 5 pF inclusive, preferably 10 fF to 5 pF inclusive, and further preferably 20 fF to 1 pF inclusive, so that a data signal written in the previous period can be held without rewriting data signals every frame period. For example, grayscale of a pixel can be held for several frame periods or several tens of frame periods.

### <Example of Driving Method of Display Portion and Touch Sensor>

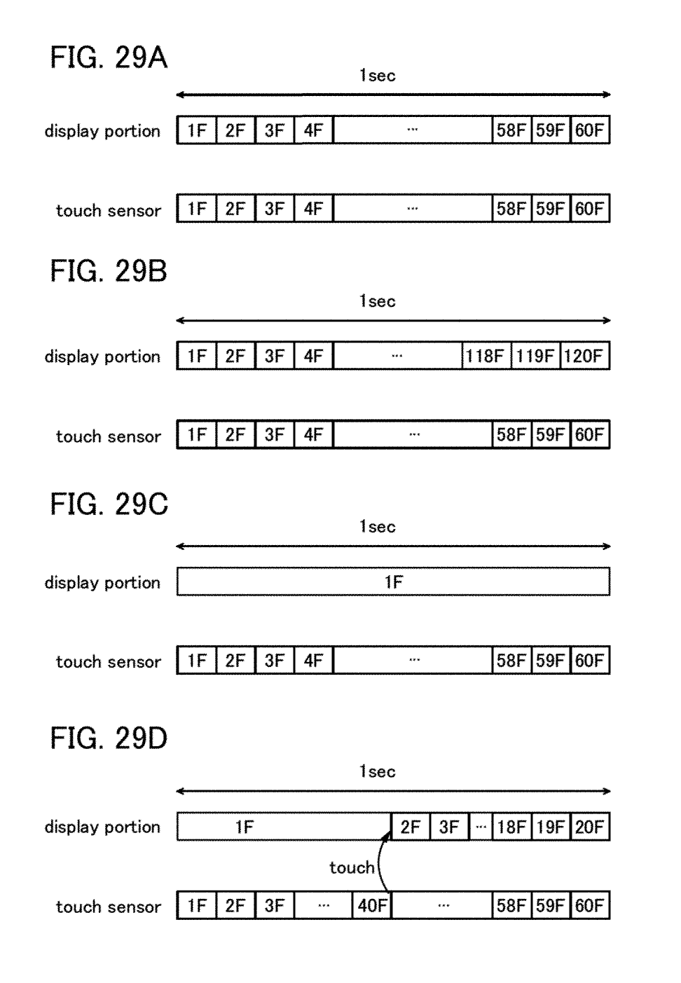

FIGS. 29A to 29D show examples of the operations in successive frame periods of the touch sensor described with reference to FIGS. 27A and 27B and the display portion described with reference to FIGS. 28A and 28B that are driven for 1 sec (one second). In FIG. 29A, one frame period for the display portion is 16.7 ms (frame frequency: 60 Hz), and one frame period for the touch sensor is 16.7 ms (frame frequency: 60 Hz).

In the display device of one embodiment of the present invention, the display portion and the touch sensor operate independently of each other, and the display device can have a touch sensing period concurrent with a display period. That is why one frame period for the display portion and one frame period for the touch sensor can both be 16.7 ms (frame frequency: 60 Hz) as shown in FIG. 29A. The frame frequency for the touch sensor may differ from that of the display portion. For example, as shown in FIG. 29B, one frame period for the display portion may be 8.3 ms (frame frequency: 120 Hz) and one frame period for the touch sensor may be 16.7 ms (frame frequency: 60 Hz). The frame frequency for the display portion may be 33.3 ms (frame frequency: 30 Hz) (not shown).

The frame frequency for the display portion may be changeable, i.e., the frame frequency in displaying moving images may be increased (e.g., 60 Hz or more, or 120 Hz or more), whereas the frame frequency in displaying still images may be decreased (e.g., 60 Hz or less, 30 Hz or less, or 1 Hz or less). With this structure, the power consumption of the display device can be reduced. The frame frequency for the touch sensor may be changeable, and the frame frequency in waiting may differ from the frame frequency in sensing a touch.

Moreover, in the display device of one embodiment of the present invention, the following operation is possible: data signals are not rewritten in the display portion and a data signal written in the previous period is held. In that case, one frame period of the display portion can be longer than 16.7 ms. Thus, as shown in FIG. 29C, the operation can be switched so that one frame period for the display portion is 1 sec (frame frequency: 1 Hz) and one frame period for the touch sensor is 16.7 ms (frame frequency: 60 Hz).

Note that for the operation in which data signals are not rewritten in the display portion and a data signal written in the previous period is held, the above-described IDS driving mode can be referred to. As the IDS driving mode, a partial IDS driving mode may be employed in which data signals are rewritten only in a specific region of the display portion. The partial IDS driving mode is a mode in which data signals are rewritten only in a specific region of the display portion and a data signal written in the previous period is held in the other region.

Furthermore, by the driving method of a touch sensor that is disclosed in this embodiment, the touch sensor can be continuously driven in the case of FIG. 29C. Thus, data signals in the display portion can also be rewritten when the approach or contact of a sensing target is sensed by the touch sensor, as shown in FIG. 29D.

If rewriting of data signals in a display portion is performed during a sensing period of a touch sensor, noise caused by rewriting of the data signals travels through the touch sensor and the sensitivity of the touch sensor might decrease. For this reason, rewriting of data signals in a display portion and sensing by a touch sensor are preferably performed in different periods.

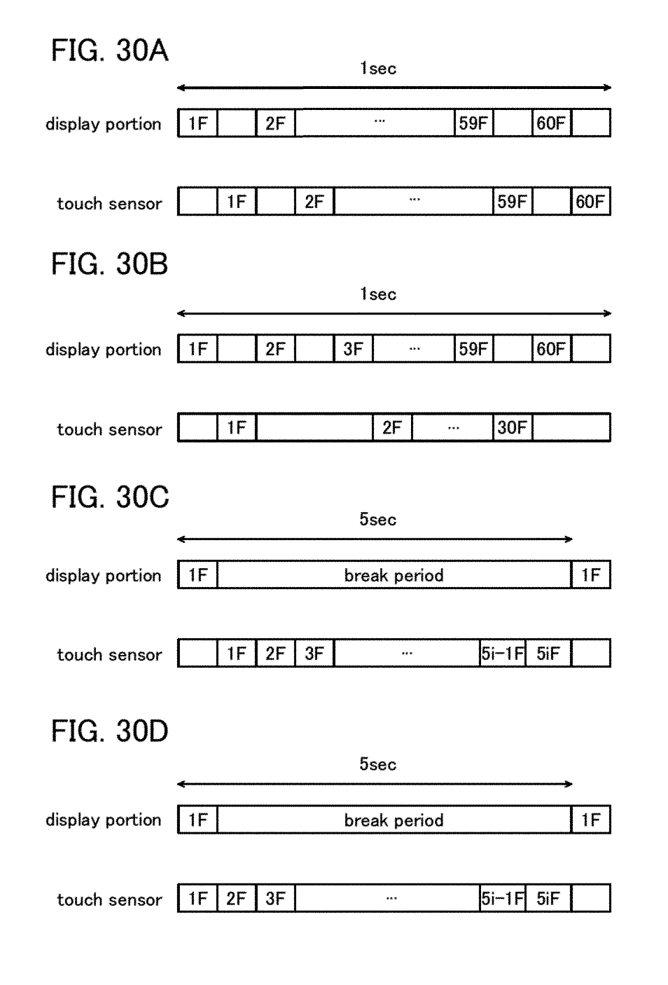

FIG. 30A shows an example in which rewriting of data signals in a display portion and sensing by a touch sensor are performed alternately. FIG. 30B shows an example in which sensing by a touch sensor is performed one time every two rewritings of data signals in a display portion. Note that sensing by a touch sensor may be performed once every three or more rewritings.

In the case where an oxide semiconductor is used in a semiconductor layer (where a channel is formed) of a transistor used in the pixel pix, the off-state current can be significantly reduced and the frequency of rewriting data signal can be sufficiently reduced. Specifically, a sufficiently long break period can be set between rewritings of data signals. The break period can be 0.5 seconds or longer, 1 second or longer, or 5 seconds or longer, for example. The upper limit of the break period depends on the leakage current of a capacitor or a display element connected to the transistor; for example, 1 minute or shorter, 10 minutes or shorter, 1 hour or shorter, or 1 day or shorter.

FIG. 30C shows an example in which rewriting of data signals in a display portion is performed once every 5 seconds. A break period for stopping the rewriting operation of a display portion is set in FIG. 30C between rewriting of data signals and next rewriting. In the break period, a touch sensor can be operated at a frame frequency of i Hz (i is more than or equal to the frame frequency of a display device; here, 0.2 Hz or more). Preferably, sensing by a touch sensor is performed in a break period and is not performed in a rewriting period of data signals in a display portion as shown in FIG. 30C, so that the sensitivity of a touch sensor can be increased. When rewriting of data signals in a display portion and sensing by a touch sensor are performed at the same time as shown in FIG. 30D, operation signals can be simplified.

In a break period during which rewriting of data signals in a display portion is not performed, not only the supply of data signals to the display portion, but also the operation of one or both of the gate driver circuit GD and the source driver circuit SD may be stopped. The supply of power to one or both of the gate driver circuit GD and the source driver circuit SD may also be stopped. Thus, noise is further reduced, and the sensitivity of the touch sensor can be further increased. Moreover, the power consumption of the display device can be further reduced.

The display device of one embodiment of the present invention includes a display portion and a touch sensor between two substrates. With this structure, the distance between the display portion and the touch sensor can be reduced. At this time, noise is easily transmitted to the touch sensor in driving the display portion, which might reduce the sensitivity of the touch sensor. When the driving method in this embodiment is employed, a display device including a touch sensor, which has both reduced thickness and high sensitivity, can be obtained.

This embodiment can be combined with any of the other embodiments as appropriate.

### Embodiment 4

Described in this embodiment is a metal oxide that can be used in a semiconductor layer of a transistor disclosed in one embodiment of the present invention. Note that in the case where a metal oxide is used in a semiconductor layer of a transistor, the metal oxide can be rephrased as an oxide semiconductor.

An oxide semiconductor is classified into a single crystal oxide semiconductor and a non-single-crystal oxide semiconductor. Examples of the non-single-crystal oxide semiconductor include a c-axis aligned crystalline oxide semiconductor (CAAC-OS), a polycrystalline oxide semiconductor, a nanocrystalline oxide semiconductor (nc-OS), an amorphous-like oxide semiconductor (a-like OS), and an amorphous oxide semiconductor.

A cloud-aligned composite OS (CAC-OS) may be used in a semiconductor layer of a transistor disclosed in one embodiment of the present invention.

The aforementioned non-single-crystal oxide semiconductor or CAC-OS can be suitably used in a semiconductor layer of a transistor disclosed in one embodiment of the present invention. As the non-single-crystal oxide semiconductor, an nc-OS or a CAAC-OS can be suitably used.

In one embodiment of the present invention, a CAC-OS is preferably used in a semiconductor layer of a transistor. The use of the CAC-OS allows the transistor to have high electrical characteristics or high reliability.

The CAC-OS will be described in detail below.

A CAC-OS or a CAC metal oxide has a conducting function in a part of the material and has an insulating function in another part of the material; as a whole, the CAC-OS or the CAC metal oxide has a function of a semiconductor. In the case where the CAC-OS or the CAC metal oxide is used in a channel formation region of a transistor, the conducting function is to allow electrons (or holes) serving as carriers to flow, and the insulating function is to not allow electrons serving as carriers to flow. By the complementary action of the conducting function and the insulating function, the CAC-OS or the CAC metal oxide can have a switching function (on/off function). In the CAC-OS or the CAC metal oxide, separation of the functions can maximize each function.

The CAC-OS or the CAC metal oxide includes conductive regions and insulating regions. The conductive regions have the aforementioned conducting function and the insulating regions have the aforementioned insulating function. In some cases, the conductive regions and the insulating regions in the material are separated at the nanoparticle level. In some cases, the conductive regions and the insulating regions are unevenly distributed in the material. The conductive regions are sometimes observed to be coupled in a cloud-like manner with their boundaries blurred.

In the CAC-OS or the CAC metal oxide, the conductive regions and the insulating regions each have a size greater than or equal to 0.5 nm and less than or equal to 10 nm, preferably greater than or equal to 0.5 nm and less than or equal to 3 nm and are dispersed in the material, in some cases.

The CAC-OS or the CAC metal oxide includes components having different bandgaps. For example, the CAC-OS or the CAC metal oxide includes a component having a wide gap due to the insulating region and a component having a narrow gap due to the conductive region. In the case of such a composition, carriers mainly flow in the component having a narrow gap. The component having a narrow gap complements the component having a wide gap, and carriers also flow in the component having a wide gap in conjunction with the component having a narrow gap. Therefore, in the case where the above-described CAC-OS or CAC metal oxide is used in a channel formation region of a transistor, high current drive capability in the on state of the transistor, that is, high on-state current and high field-effect mobility, can be obtained.

In other words, the CAC-OS or the CAC-metal oxide can be referred to as a matrix composite or a metal matrix composite.

The CAC-OS has, for example, a composition in which elements included in a metal oxide are unevenly distributed. The unevenly distributed elements each have a size greater than or equal to 0.5 nm and less than or equal to 10 nm, preferably greater than or equal to 1 nm and less than or equal to 2 nm, or a similar size. Note that in the following description of a metal oxide, a state in which one or more metal elements are unevenly distributed and regions including the metal element(s) are mixed is referred to as a mosaic pattern or a patch-like pattern. The regions each have a size greater than or equal to 0.5 nm and less than or equal to 10 nm, preferably greater than or equal to 1 nm and less than or equal to 2 nm, or a similar size.

Note that a metal oxide preferably contains at least indium. In particular, indium and zinc are preferably contained. In addition, one or more elements selected from aluminum, gallium, yttrium, copper, vanadium, beryllium, boron, silicon, titanium, iron, nickel, germanium, zirconium, molybdenum, lanthanum, cerium, neodymium, hafnium, tantalum, tungsten, magnesium, and the like may be contained.

For example, of the CAC-OS, an In—Ga—Zn oxide with the CAC composition (such an In—Ga—Zn oxide may be particularly referred to as CAC-IGZO) has a composition in which materials are separated into indium oxide (InO_{X1}, where X1 is a real number greater than 0) or indium zinc oxide (In_{X2}Zn_{Y2}O_{Z2}, where X2, Y2, and Z2 are real numbers greater than 0), and gallium oxide (GaO_{X3}, where X3 is a real number greater than 0) or gallium zinc oxide (Ga_{X4}Zn_{Y4}O_{Z4}, where X4, Y4, and Z4 are real numbers greater than 0), and a mosaic pattern is formed. Then, InO_{X1} or In_{X2}Zn_{Y2}O_{Z2} forming the mosaic pattern is evenly distributed in the film. This composition is also referred to as a cloud-like composition.

That is, the CAC-OS is a composite metal oxide with a composition in which a region including GaO_{X3} as a main component and a region including In_{X2}Zn_{Y2}O_{Z2} or InO_{X1} as a main component are mixed. Note that in this specification, for example, when the atomic ratio of In to an element M in a first region is greater than the atomic ratio of In to an element M in a second region, the first region has higher In concentration than the second region.

Note that a compound including In, Ga, Zn, and O is also known as IGZO. Typical examples of IGZO include a crystalline compound represented by InGaO₃(ZnO)ₘ₁ (m1 is a natural number) and a crystalline compound represented by In₍₁₊ₓ₀₎Ga₍₁₋ₓ₀₎O₃(ZnO)ₘ₀ (−1≤x0≤1; m0 is a given number).

The above crystalline compounds have a single crystal structure, a polycrystalline structure, or a c-axis-aligned crystalline (CAAC) structure. Note that the CAAC structure is a crystal structure in which a plurality of IGZO nanocrystals have c-axis alignment and are connected in the a-b plane direction without alignment.

On the other hand, the CAC-OS relates to the material composition of a metal oxide. In a material composition of a CAC-OS including In, Ga, Zn, and O, nanoparticle regions including Ga as a main component are observed in part of the CAC-OS and nanoparticle regions including In as a main component are observed in part thereof. These nanoparticle regions are randomly dispersed to form a mosaic pattern. Therefore, the crystal structure is a secondary element for the CAC-OS.

Note that in the CAC-OS, a stacked-layer structure including two or more films with different atomic ratios is not included. For example, a two-layer structure of a film including In as a main component and a film including Ga as a main component is not included.

A boundary between the region including GaO_{X3} as a main component and the region including In_{X2}Zn_{Y2}O_{Z2} or InO_{X1} as a main component is not clearly observed in some cases.

In the case where one or more of aluminum, yttrium, copper, vanadium, beryllium, boron, silicon, titanium, iron, nickel, germanium, zirconium, molybdenum, lanthanum, cerium, neodymium, hafnium, tantalum, tungsten, magnesium, and the like are contained instead of gallium in a CAC-OS, nanoparticle regions including the selected metal element(s) as a main component(s) are observed in part of the CAC-OS and nanoparticle regions including In as a main component are observed in part thereof, and these nanoparticle regions are randomly dispersed to form a mosaic pattern in the CAC-OS.

The CAC-OS can be formed by a sputtering method under conditions where a substrate is not heated intentionally, for example. In the case of forming the CAC-OS by a sputtering method, one or more selected from an inert gas (typically, argon), an oxygen gas, and a nitrogen gas may be used as a deposition gas. The ratio of the flow rate of an oxygen gas to the total flow rate of the deposition gas at the time of deposition is preferably as low as possible, and for example, the flow ratio of an oxygen gas is preferably higher than or equal to 0% and less than 30%, further preferably higher than or equal to 0% and less than or equal to 10%.

The CAC-OS is characterized in that no clear peak is observed in measurement using θ/2θ scan by an out-of-plane method, which is an X-ray diffraction (XRD) measurement method. That is, X-ray diffraction shows no alignment in the a-b plane direction and the c-axis direction in a measured region.

In an electron diffraction pattern of the CAC-OS which is obtained by irradiation with an electron beam with a probe diameter of 1 nm (also referred to as a nanometer-sized electron beam), a ring-like region with high luminance and a plurality of bright spots in the ring-like region are observed. Therefore, the electron diffraction pattern indicates that the crystal structure of the CAC-OS includes a nanocrystal (nc) structure with no alignment in plan-view and cross-sectional directions.

For example, an energy dispersive X-ray spectroscopy (EDX) mapping image confirms that an In—Ga—Zn oxide with the CAC composition has a structure in which a region including GaO_{X3} as a main component and a region including In_{X2}Zn_{Y2}O_{Z2} or InO_{X1} as a main component are unevenly distributed and mixed.

The CAC-OS has a structure different from that of an IGZO compound in which metal elements are evenly distributed, and has characteristics different from those of the IGZO compound. That is, in the CAC-OS, regions including GaO_{X3} or the like as a main component and regions including In_{X2}Zn_{Y2}O_{Z2} or InO_{X1} as a main component are separated to form a mosaic pattern.

The conductivity of a region including In_{X2}Zn_{Y2}O_{Z2} or InO_{X1} as a main component is higher than that of a region including GaO_{X3} or the like as a main component. In other words, when carriers flow through regions including In_{X2}Zn_{Y2}O_{Z2} or InO_{X1} as a main component, the conductivity of an oxide semiconductor is exhibited. Accordingly, when regions including In_{X2}Zn_{Y2}O_{Z2} or InO_{X1} as a main component are distributed in an oxide semiconductor like a cloud, high field-effect mobility (μ) can be achieved.

In contrast, the insulating property of a region including GaO_{X3} or the like as a main component is higher than that of a region including In_{X2}Zn_{Y2}O_{Z2} or InO_{X1} as a main component. In other words, when regions including GaO_{X3} or the like as a main component are distributed in an oxide semiconductor, leakage current can be suppressed and favorable switching operation can be achieved.

Accordingly, when a CAC-OS is used for a semiconductor element, the insulating property derived from GaO_{X3} or the like and the conductivity derived from In_{X2}Zn_{Y2}O_{Z2} or InO_{X1} complement each other, whereby high on-state current (Iₒₙ) and high field-effect mobility (μ) can be achieved.

A semiconductor element including a CAC-OS has high reliability. Thus, the CAC-OS is suitably used in a variety of semiconductor devices typified by a display.

This embodiment can be combined with any of the other embodiments as appropriate.

### Embodiment 5

In this embodiment, electronic devices of one embodiment of the present invention will be described.

Examples of electronic devices include a television set, a desktop or laptop personal computer, a monitor of a computer or the like, a digital camera, a digital video camera, a digital photo frame, a mobile phone, a portable game machine, a portable information terminal, an audio reproducing device, and a large game machine such as a pachinko machine.

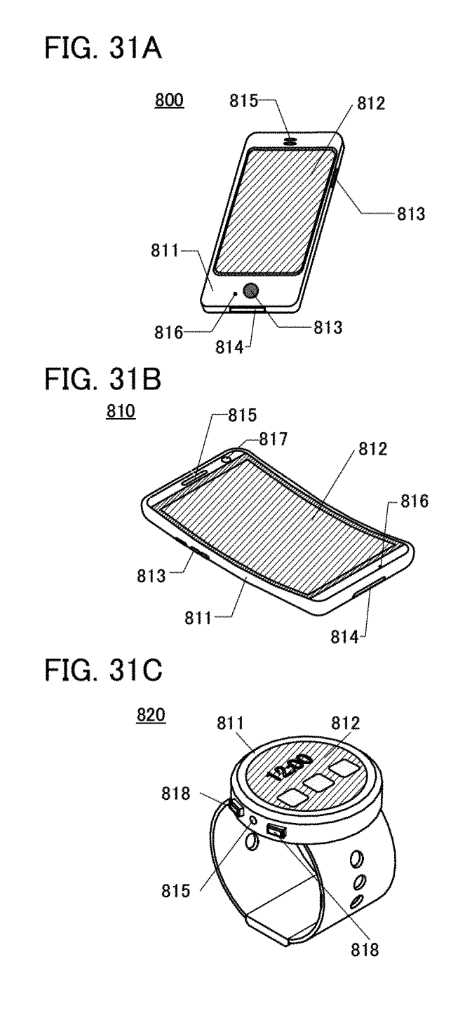

FIGS. 31A to 31C illustrate portable information terminals. Each of the portable information terminals in this embodiment functions as, for example, one or more of a telephone set, a notebook, and an information browsing system. Specifically, each of the portable information terminals in this embodiment can be used as a smartphone or a smart watch. Each of the portable information terminals in this embodiment is capable of executing a variety of applications such as mobile phone calls, e-mailing, text reading and editing, music replay, video replay, Internet communication, and a game, for example. Each of the portable information terminals illustrated in FIGS. 31A to 31C can have a variety of functions, for example, a function of displaying a variety of data (a still image, a moving image, a text image, and the like) on the display portion, a touch panel function, a function of displaying a calendar, date, time, and the like, a function of controlling a process with a variety of software (programs), a wireless communication function, a function of being connected to a variety of computer networks with a wireless communication function, a function of transmitting and receiving a variety of data with a wireless communication function, a function of reading a program or data stored in a memory medium and displaying the program or data on the display portion, and the like. Note that the functions of the portable information terminals illustrated in FIGS. 31A to 31C are not limited to the above, and the portable information terminals may have other functions.

Each of the portable information terminals illustrated in FIGS. 31A to 31C is capable of executing a variety of applications such as mobile phone calls, e-mailing, text reading and editing, music replay, Internet communication, and a computer game. Each of the portable information terminals illustrated in FIGS. 31A to 31C can employ near field communication that is a communication method based on an existing communication standard. In that case, for example, mutual communication between the portable information terminal 820 illustrated in FIG. 31C and a headset capable of wireless communication can be performed, and thus hands-free calling is possible.

A portable information terminal 800 illustrated in FIG. 31A includes a housing 811, a display portion 812, operation buttons 813, an external connection port 814, a speaker 815, a microphone 816, and the like. The display portion 812 of the portable information terminal 800 has a flat surface.

A portable information terminal 810 illustrated in FIG. 31B includes the housing 811, the display portion 812, the operation buttons 813, the external connection port 814, the speaker 815, the microphone 816, a camera 817, and the like. The display portion 812 of the portable information terminal 810 has a curved surface.

FIG. 31C illustrates a wrist-watch-type portable information terminal 820. The wrist-watch-type portable information terminal 820 includes the housing 811, the display portion 812, the speaker 815, operation keys 818 (including a power switch or an operation switch), and the like. The external shape of the display portion 812 of the wrist-watch-type portable information terminal 820 is circular. The display portion 812 has a flat surface.

The display device of one embodiment of the present invention can be used for the display portion 812. Thus, the display portion of the portable information terminal can have a high aperture ratio.

Each of the portable information terminals in this embodiment includes a touch sensor in the display portion 812. Operations such as making a call and inputting a letter can be performed by touch on the display portion 812 with a finger, a stylus, or the like.

With the operation button 813, the power can be turned on or off. In addition, types of images displayed on the display portion 812 can be switched; for example, switching images from a mail creation screen to a main menu screen is performed with the operation button 813.

When a detection device such as a gyroscope sensor or an acceleration sensor is provided inside each of the portable information terminals, the direction of display on the screen of the display portion 812 can be automatically changed by determining the orientation of the portable information terminal (whether the portable information terminal is placed horizontally or vertically). Furthermore, the direction of display on the screen can be changed by touch on the display portion 812, operation with the operation button 813, sound input using the microphone 816, or the like.

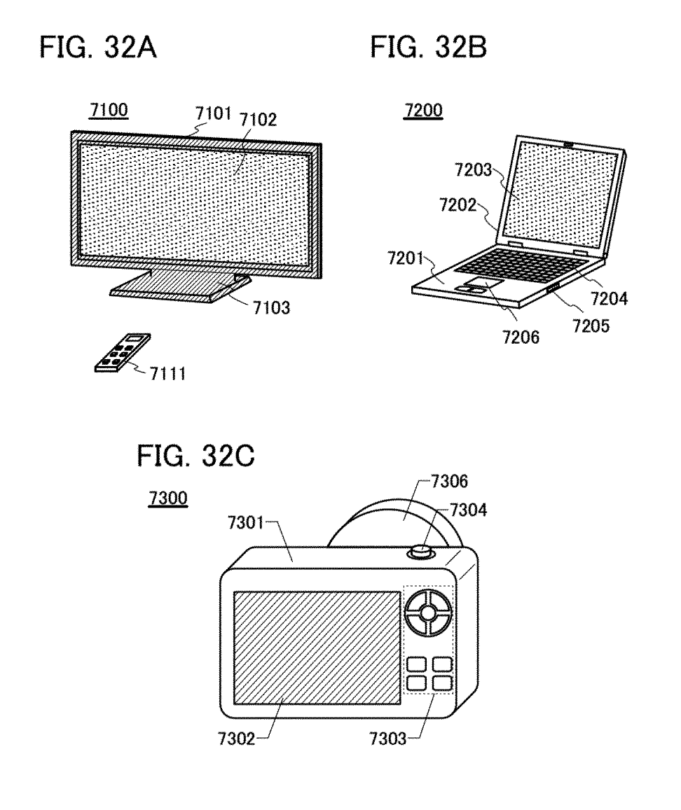

In a television set 7100 illustrated in FIG. 32A, a display portion 7102 is incorporated in a housing 7101. The display portion 7102 is capable of displaying images. The display device of one embodiment of the present invention can be used for the display portion 7102. Accordingly, a television set having a display portion with a high aperture ratio can be manufactured. In addition, here, the housing 7101 is supported by a stand 7103.

The television set 7100 can be operated with an operation switch provided in the housing 7101 or a separate remote controller 7111. With operation keys of the remote controller 7111, channels and volume can be controlled and images displayed on the display portion 7102 can be controlled. The remote controller 7111 may be provided with a display portion for displaying data output from the remote controller 7111.

Note that the television set 7100 is provided with a receiver, a modem, and the like. With the use of the receiver, general television broadcasts can be received. Moreover, when the television set is connected to a communication network with or without wires via the modem, one-way (from a sender to a receiver) or two-way (between a sender and a receiver or between receivers) information communication can be performed.

A computer 7200 illustrated in FIG. 32B includes a main body 7201, a housing 7202, a display portion 7203, a keyboard 7204, an external connecting port 7205, a pointing device 7206, and the like. Note that this computer is manufactured by using the display device of one embodiment of the present invention for the display portion 7203. Thus, a computer having a display portion with a high aperture ratio can be manufactured.

The camera 7300 illustrated in FIG. 32C includes a housing 7301, a display portion 7302, an operation button 7303, a shutter button 7304, and the like. Furthermore, an attachable lens 7306 is attached to the camera 7300.

The display device of one embodiment of the present invention can be used for the display portion 7302. Thus, a camera having a display portion with a high aperture ratio can be manufactured.

Although the lens 7306 of the camera 7300 here is detachable from the housing 7301 for replacement, the lens 7306 may be included in the housing 7301.

Still images or moving images can be taken with the camera 7300 by pushing the shutter button 7304. In addition, images can be taken by a touch on the display portion 7302 that serves as a touch panel.

Note that a stroboscope, a viewfinder, or the like can be additionally attached to the camera 7300. Alternatively, they may be incorporated in the housing 7301.

This embodiment can be combined with any of the other embodiments as appropriate.

### Example 1

Described in this example are the results of fabricating a liquid crystal display device that employs the pixel layout of the ultra-high-definition display exemplified in Embodiment 1.

<I_{d}-V_{g} Characteristics of Transistors>

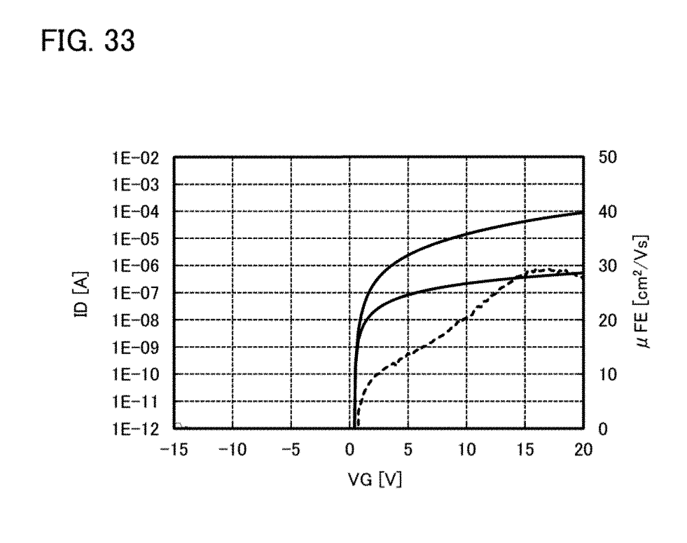

First, FIG. 33 shows the I_{d}-V_{g} characteristics of transistors that are used as pixel transistors in the liquid crystal display device fabricated in this example. FIG. 33 shows the results at V_{d}=0.1 V and V_{d}=20 V. The transistor is a TGSA transistor including a CAC-OS in its semiconductor layer. The transistor has a channel width of 3 μm and a channel length of 3 μm. Despite such a small channel size, the transistor exhibits a high on/off ratio, normally-off characteristics, and a small subthreshold swing (S value, or SS) as shown in FIG. 33. The transistor also exhibits a field-effect mobility μ_{FE} as high as 25 cm²/Vs or more.

### <Pixel Structure>

Next, a method for manufacturing a pixel in the liquid crystal display device fabricated in this example will be described with reference to FIG. 2.

A metal film was formed by a sputtering method as the gate 223, which is a bottom gate electrode (a back gate electrode). Then, a stack of a silicon nitride film and a silicon oxynitride film was formed as the insulating layer 211 over the gate 223. Next, a CAC-OS film was formed as the semiconductor layer 231 by a sputtering method. Subsequently, a silicon oxynitride film was formed as the insulating layer 213 (a gate insulating layer) with a PECVD apparatus. Then, a conductive film that transmits visible light was formed as the gate 221 (a top gate electrode). The gate 221 and the insulating layer 213 were sequentially etched with the top gate pattern used as a mask, whereby part of the semiconductor layer 231 (that is to be the low-resistance region 231b) was exposed. Next, a silicon nitride film and a silicon oxynitride film were stacked as the insulating layer 212 and the insulating layer 214, respectively, which were interlayer insulating films. Note that the resistance of part of the semiconductor layer 231 was reduced by employing a structure in which the part of the semiconductor layer 231 (that is to be the low-resistance region 231b) is in contact with the silicon nitride film. Then, an opening (a contact hole) was formed in the insulating layers 212 and 214. Subsequently, a metal film was formed as the conductive layer 222a serving as a signal line. After that, an acrylic resin was applied as the insulating layer 215 having a planarization function, and an opening (a contact hole) was formed. Then, the pixel electrode 111 was formed. Furthermore, a silicon nitride film was formed as the insulating layer 220 serving as an interlayer insulating film, and an opening (a contact hole) was formed. After that, the common electrode 112 was formed.

In the pixel in this example, the contact area between the transistor and the pixel electrode 111, the pixel electrode 111, and the common electrode 112 can transmit visible light. Note that a metal wire was used in the circuits other than the pixel circuits.

### <Specifications of Display Device and Display Results>

The display device fabricated in this example is a transmissive liquid crystal display device in an FFS mode, which has a pixel density of 1058 ppi, a display area diagonal of 4.16 inches, an effective pixel number of 3840 (H)×2160 (V), a pixel size of 8 82 m×24 82 m, and an aperture ratio of 63.60%. The layout of a subpixel in the display device fabricated in this example corresponds to the top views illustrated in FIGS. 4A and 4B.

The gate driver is incorporated. The source driver includes an analog switch and is fabricated by COG. The frame frequency is 60 Hz. A negative liquid crystal material is used.

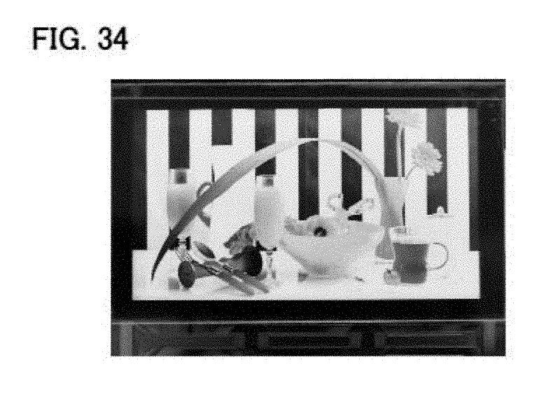

FIG. 34 shows the display device fabricated in this example that is in operation.

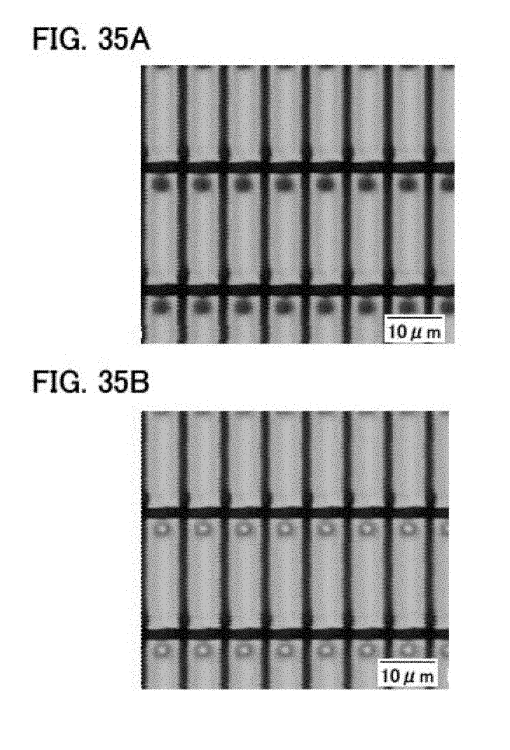

FIG. 35A shows an optical micrograph of pixels in the liquid crystal display device, to which the comparative pixel layout in FIGS. 5A and 5B is applied. FIG. 35B shows an optical micrograph of pixels in the liquid crystal display device fabricated in this example, to which the pixel layout in FIGS. 4A and 4B is applied. The comparison between the two types of pixels shows that in the comparative pixels, the scan line, the signal line, the wiring between elements, and the contact area are non-transmission regions (dark areas) whereas in the pixels fabricated in this example, the regions other than the scan line and the signal line can be regarded as transmission regions.

In general liquid crystal display devices, a decrease in the pattern is not allowed by the design rule of the metal wiring and the contact area, and thus, the aperture ratio tends to decrease with increasing definition. In this example, the material that transmits visible light is used in the contact area between the transistor and the pixel electrode, ensuring a high aperture ratio even in an ultra-high-definition display.

### <Aperture Ratio>

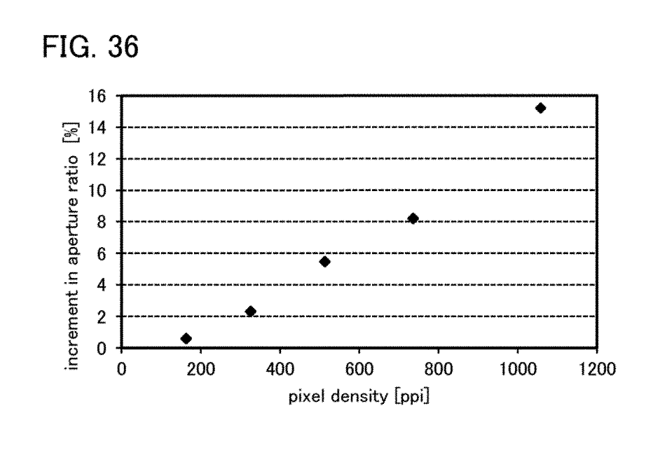

The structure in which the contact area between the transistor and the pixel electrode transmits visible light is applied to pixels including TGSA transistors formed with materials similar to those in this example, and an increment in the aperture ratio at each pixel density was estimated. Note that up to 1000 ppi, the 2 μm rule is assumed for the metal wiring design rule, and the 1.5 μm rule is assumed for 1000 ppi or more. As shown in FIG. 36, the structure in which the contact area between the transistor and the pixel electrode transmits visible light is more effective in higher aperture ratio and lower power consumption as the pixel density increases.

### REFERENCE NUMERALS

34: capacitor, 40: liquid crystal element, 45: light, 51: substrate, 56: conductive layer, 56a: conductive layer, 56b: conductive layer, 57: auxiliary wiring, 58: conductive layer, 60: pixel, 60a: subpixel, 60b: subpixel, 60c: subpixel, 61: substrate, 62: display portion, 63: connection portion, 64: driver circuit portion, 65: wiring, 66: non-display region, 68: display region, 72: FPC, 72a: FPC, 72b: FPC, 73: IC, 73a: IC, 73b: IC, 81: scan line, 82: signal line, 100A: display device, 100B: display device, 100C: display device, 100D: display device, 111: pixel electrode, 112: common electrode, 112a: common electrode, 112b: common electrode, 113: liquid crystal layer, 117: spacer, 121: overcoat, 122: insulating layer, 123: insulating layer, 124: electrode, 125: insulating layer, 126: conductive layer, 127: electrode, 128: electrode, 130: polarizer, 131: coloring layer, 132: light-blocking layer, 132a: light-blocking layer, 132b: light-blocking layer, 133a: alignment film, 133b: alignment film, 137: wiring, 138: wiring, 139: auxiliary wiring, 141: adhesive layer, 160: protection substrate, 161: backlight, 162: substrate, 163: adhesive layer, 164: adhesive layer, 165: polarizer, 166: polarizer, 167: adhesive layer, 168: adhesive layer, 169: adhesive layer, 170: insulating layer, 171: insulating layer, 201: transistor, 204: connection portion, 206: transistor, 211: insulating layer, 212: insulating layer, 213: insulating layer, 214: insulating layer, 215: insulating layer, 217: conductive layer, 218: conductive layer, 219: capacitor, 220: insulating layer, 221: gate, 222a: conductive layer, 222b: conductive layer, 222c: conductive layer, 223: gate, 227: conductive layer, 228: scan line, 229: signal line, 231: semiconductor layer, 231a: channel region, 231b: low-resistance region, 242: connector, 242b: connector, 243: connector, 251: conductive layer, 284: conductive layer, 285: conductive layer, 286: conductive layer, 350A: touch panel, 350B: touch panel, 350C: touch panel, 350D: touch panel, 350E: touch panel, 370: display device, 375: input device, 376: input device, 379: display device, 415: input device, 416: substrate, 449: IC, 450: FPC, 460: region, 461: conductive film, 462: conductive film, 463: conductive film, 464: nanowire, 471: electrode, 472: electrode, 473: electrode, 474: bridge electrode, 476: wiring, 477: wiring, 501: display element, 506: pixel circuit, 521: electrode, 522: electrode, 551: pulse voltage output circuit, 552: current sensing circuit, 553: capacitor, 800: portable information terminal, 810: portable information terminal, 811: housing, 812: display portion, 813: operation button, 814: external connection port, 815: speaker, 816: microphone, 817: camera, 818: operation key, 820: portable information terminal, 3501: wiring, 3502: wiring, 3510: wiring, 3511: wiring, 3515_1: block, 3515_2: block, 3516: block, 7100: television set, 7101: housing, 7102: display portion, 7103: stand, 7111: remote controller, 7200: computer, 7201: main body, 7202: housing, 7203: display portion, 7204: keyboard, 7205: external connecting port, 7206: pointing device, 7300: camera, 7301: housing, 7302: display portion, 7303: operation button, 7304: shutter button, 7306: lens

This application is based on Japanese Patent Application Serial No. 2016-233533 filed with Japan Patent Office on Nov. 30, 2016, the entire contents of which are hereby incorporated by reference.

1. A display device comprising:
a liquid crystal element;
a transistor;
a scan line; and
a signal line,
wherein the liquid crystal element comprises a pixel electrode, a liquid crystal layer, and a common electrode,
wherein the scan line and the signal line are each electrically connected to the transistor,
wherein the scan line and the signal line each include a metal layer,
wherein the transistor comprises a metal oxide layer, a gate, and a gate insulating layer,
wherein the metal oxide layer comprises a first region and a second region,
wherein the first region overlaps with the gate with the gate insulating layer therebetween,
wherein the second region comprises a first part connected to the pixel electrode,
wherein a resistivity of the second region is lower than a resistivity of the first region,
wherein the pixel electrode, the common electrode, and the first part are configured to transmit visible light, and
wherein the visible light passes through the first part and the liquid crystal element and is emitted to outside of the display device.

2. The display device according to claim 1, further comprising a touch sensor,
wherein the touch sensor is positioned closer to a display surface than the liquid crystal element and the transistor are.

3. The display device according to claim 2,
wherein the touch sensor comprises a pair of electrodes,
wherein one or both of the pair of electrodes comprise a second part that transmits visible light, and
wherein the visible light that has passed through the first part and the liquid crystal element passes through the second part and is emitted to outside of the display device.

4. The display device according to claim 1,
wherein the scan line comprises a part that overlaps with the first region.

5. The display device according to claim 1,
wherein the visible light is emitted to the outside of the display device after passing through the first part and the liquid crystal element in order.

6. The display device according to claim 1,
wherein the visible light is emitted to the outside of the display device after passing through the liquid crystal element and the first part in order.

7. The display device according to claim 1,
wherein the liquid crystal element is a liquid crystal element in a horizontal electric field mode.

8. The display device according to claim 1,
wherein a direction in which the scan line extends intersects with a direction in which the signal line extends, and
wherein a plurality of pixels that exhibit the same color are aligned in a direction that intersects with the direction in which the signal line extends.

9. A display module comprising:
the display device according to claim 1, and
a circuit board.

10. An electronic device comprising:
the display module according to claim 9; and
at least one of an antenna, a battery, a housing, a camera, a speaker, a microphone, and an operation button.

11. A display device comprising:
a first gate over a substrate;
a metal oxide layer over the first gate;
a gate insulating layer over the metal oxide layer;
a second gate over the gate insulating layer;
a pixel electrode electrically connected to a first part of the metal oxide layer;
a conductive layer electrically connected to a second part of the metal oxide layer;
a common electrode over the pixel electrode; and
a liquid crystal layer over the pixel electrode and the common electrode,
wherein the first gate and the conductive layer each include a metal layer,
wherein a channel region of the metal oxide layer overlaps with the first gate and the second gate,
wherein a resistivity of the first part is lower than a resistivity of the channel region,
wherein the pixel electrode, the common electrode, and the first part are configured to transmit visible light, and
wherein the visible light passes through the first part and the liquid crystal layer and is emitted to outside of the display device.

12. The display device according to claim 11, further comprising a touch sensor,
wherein the touch sensor is over the liquid crystal layer.

13. The display device according to claim 12,
wherein the touch sensor comprises a pair of electrodes,
wherein one or both of the pair of electrodes comprise a third part that transmits visible light, and
wherein the visible light that has passed through the first part and the liquid crystal layer passes through the third part and is emitted to outside of the display device.

14. The display device according to claim 11,
wherein the visible light is emitted to the outside of the display device after passing through the first part and the liquid crystal layer in order.

15. The display device according to claim 11,
wherein the visible light is emitted to the outside of the display device after passing through the liquid crystal layer and the first part in order.

16. A display module comprising:
the display device according to claim 11, and
a circuit board.

17. An electronic device comprising:
the display module according to claim 16; and
at least one of an antenna, a battery, a housing, a camera, a speaker, a microphone, and an operation button.
